(19) United States
(12) Patent Application Publication
(10) Pub. No.: US 2023/0361599 A1
(43) Pub. Date: Nov. 9, 2023

(54) WIRELESS ELECTROMAGNETIC ENERGY TRANSFER SYSTEM

(71) Applicant: Kamil Podhola, Liberec (CZ)

(72) Inventor: Kamil Podhola, Liberec (CZ)

(21) Appl. No.: 17/735,163

(22) Filed: May 3, 2022

(51) Int. Cl. H02J 50/12; H02J 50/30; H02J 50/40; H02J 50/50; H02J 50/80

(52) U.S. Cl. CPC H02J 50/12; H02J 50/30; H02J 50/40; H02J 50/50; H02J 50/80

(57) ABSTRACT

The invention relates to a wireless electromagnetic energy transfer system comprising primary and secondary magnetic elements spaced apart from each other to be able to transfer circular magnetic fluxes created by primary and secondary conductors disposed at about or in the primary and secondary magnetic elements. The system may comprise a repeating electromagnetic interface, may provide bidirectional energy flow, a combined light-energy transfer, wireless data transmissions, may be provided in a cloud/fog/edge computing system and in a static/dynamic power transfer system. Energy transfer may take place in direct contact with a liquid. The system elements may be shielded, insulated, thermally managed, heat resistant, flexible, movable, modular, enlarged, etc. The system may be coupled with engineering constructions, electric vehicles, offshore interfaces, offshore vessels, medical applications. The system elements may be comprised of defined magnetic materials and conductive paths. A method of providing an electromagnetic energy transfer interface is proposed.

This application claims the benefit and priority of International Application No. PCT/IB2021/054328, filed 19 May 2021 (19 May 2021) and is hereby incorporated by reference in its entirety.

### TECHNICAL FIELD

The invention relates to a wireless electromagnetic energy transfer system.

### BACKGROUND ART

There is a wide range of wireless energy transfer systems including radiative, nonradiative, resonant, nonresonant, acoustical, optical systems, etc. The wireless power transfer systems are used in electronic, transport, medical devices industries, etc. There is an inductive power transfer using coupling coils, a capacitive power transfer using coupling capacitors, an electrodynamic power transfer using transducers. There is a static and a dynamic charging of vehicles at least partially electrically driven.

WO 2015/048732 A1 (APPLE INC [US]) 2 Apr. 2015 (2015 Apr. 2) discloses an inductive charging interface with magnetic retention used for charging electronic devices and accessories.

The document discloses two magnetic elements, one element can be housed within a receptacle or receiving connector of housing of an electric device and the other element can be housed within a plug or transmission connector. A magnetic flux can be directed to flow in a circular path around and between the two elements, thereby inducing a current for charging the internal battery of a device. The apparatus works with primary and secondary coils producing the magnetic flux.

US 2018/137972 A1 (WIDMER HANS PETER [CH] ET AL) 17 May 2018 (2018 May 17) discloses systems, methods and apparatus including a magnetic flux device configured to transmit or receive magnetic flux to or from a space beyond magnetic flux device. The apparatus works with first and second coils specifically disposed around magnetically permeable layers.

JP 2019 030155 A (TOYOTA MOTOR CORP) 21 Feb. 2019 (2019 Feb. 21) discloses a coil unit to acquire high coupling coefficient while suppressing the generation of a leakage flux.

The above cited documents of the prior art fail to disclose a wireless electromagnetic energy transfer system which is independent of coils. And the documents fail to disclose a wireless electromagnetic energy transfer system which exploits the whole potential of an electromagnetic field, i.e. its electric field component and its magnetic field component. The documents fail to disclose aspects incorporated in the present invention which are related to electric fields components.

The documents further fail to disclose repeating function of electromagnetic energy transfer systems. The documents fail to disclose bidirectional energy flow in relation to the above mentioned concept of fully considered properties of electromagnetic field. In this relation the documents fail to disclose light transfer, system components' shielding. The documents fail to disclose parasitic elements concept. In the above cited electromagnetic relation the documents fail to disclose comprised insulation, thermal management system. The documents fail to disclose flexibility as a component property. The documents fail to disclose modularity, a condenser action, a provided dielectric layer, a shifted electromagnetic field, systems provided in arrays, provided travelling electromagnetic field. In the above described relation to the full concept of the electromagnetic field, the documents fail to disclose the electromagnetic energy transfer system coupled with an interface which can form working pairs, the above described electromagnetic energy transfer system enabling relative mutual movement of its components.

And finally the documents fail to disclose the wireless electromagnetic energy transfer system coupled with a vehicle or with an offshore vessel.

### DISCLOSURE OF INVENTION

The object of the present invention is to propose a wireless electromagnetic energy transfer system (ETS) with primary and secondary magnetic elements spaced and transferring circular magnetic fluxes wherein primary and secondary conductors are disposed in and/or at about the respective magnetic elements and wherein electric current flowing through the conductors on one side generates electric current on the other side via the circular magnetic fluxes.

A further object is to propose the ETS further comprising repeating components.

A further object is to propose the ETS providing bidirectional energy flow.

A further object is to propose the ETS providing wireless data transmission.

A further object is to propose the ETS wherein the energy transfer includes light.

A further object is to propose the ETS further comprising a shielding.

A further object is to propose the ETS further comprising a parasitic element.

A further object is to propose the ETS further comprising an insulation.

A further object is to propose the ETS further comprising a thermal management system.

A further object is to propose a flexible ETS.

A further object is to propose a modularly configured ETS.

A further object is to propose the ETS providing condenser action.

A further object is to propose the ETS comprising a dielectric layer.

A further object is to propose the ETS providing a shifted electromagnetic field.

A further object is to propose the ETS forming arrays.

A further object is to propose the ETS providing a travelling electromagnetic field.

A further object is to propose the ETS coupled with an interface.

A further object is to propose the ETS forming working pairs.

A further object is to propose the ETS enabling relative mutual movement.

A further object is to propose the ETS coupled with a vehicle or an offshore vessel.

In a first aspect, the invention discloses a wireless electromagnetic energy transfer system.

### BRIEF DESCRIPTION OF DRAWINGS

The invention will now be described by way of example. Only essential elements of the invention are schematically shown and not to scale nor in proportions to facilitate immediate understanding, emphasis being placed upon illustrating the principles of the invention.

FIG. 1 is a schematic oblique view of a wireless electromagnetic energy transfer system.

FIG. 2 is a schematic of the wireless electromagnetic energy transfer system.

FIG. 3 is a schematic of the wireless electromagnetic energy transfer system.

FIG. 4 is a schematic diagram of another embodiment of the wireless electromagnetic energy transfer system providing internal and external condenser actions.

FIG. 5 is a schematic diagram of another embodiment of the wireless electromagnetic energy transfer system in a hybrid energy transfer system.

FIG. 6 is a schematic diagram of another embodiment of the wireless electromagnetic energy transfer system.

FIG. 7 is a schematic diagram of another embodiment of the wireless electromagnetic energy transfer system.

FIG. 8a is a schematic of a method to provide a wireless electromagnetic energy transfer interface.

FIG. 8b is a schematic of another embodiment of the method to provide a wireless electromagnetic energy transfer interface.

FIG. 9a is a schematic side view of another embodiment of the wireless electromagnetic energy transfer system.

FIG. 9b is a schematic perspective view of another embodiment of the wireless electromagnetic energy transfer system.

FIG. 9c is a schematic perspective view of another embodiment of the wireless electromagnetic energy transfer system.

FIG. 10 is a schematic perspective view of another embodiment of the wireless electromagnetic energy transfer system.

FIG. 11a is a schematic plan view of another embodiment of the wireless electromagnetic energy transfer system.

FIG. 11b is a schematic perspective view of another embodiment of the wireless electromagnetic energy transfer system in a stacked configuration.

FIG. 12 is a schematic oblique view of another embodiment of the wireless electromagnetic energy transfer system which can be used as an electromagnetic sensor.

FIG. 13a is a schematic oblique view of another embodiment of the wireless electromagnetic energy transfer system which can be used as an electromagnetic sensor.

FIG. 13b is a schematic plan view of another embodiment of the wireless electromagnetic energy transfer system which can be used as an electromagnetic sensor or in an onshore/offshore static/dynamic power transfer system providing a travelling electromagnetic field.

FIG. 14a is a schematic plan view of another embodiment of the wireless electromagnetic energy transfer system used as an electromagnetic sensor.

FIG. 14b is a schematic perspective view of another embodiment of the wireless electromagnetic energy transfer system which can be used as an electromagnetic touch sensor.

FIG. 14c is a variant of a sensor shown in FIG. 14b.

FIG. 15 is a schematic oblique view of the wireless electromagnetic energy transfer system with primary electromagnetic interfaces couplable with an engineering construction and secondary (or repeating) electromagnetic interfaces couplable with an electric vehicle component which can be tires.

FIG. 16a is a schematic oblique plan view of another embodiment of the wireless electromagnetic energy transfer system provided in an onshore static/dynamic power transfer system providing a travelling electromagnetic field.

FIG. 16b is a schematic oblique plan view of another embodiment of the wireless electromagnetic energy transfer system provided in an onshore static/dynamic power transfer system which can be complementary to the embodiment shown in FIG. 16a.

FIG. 17a is a schematic view of the wireless electromagnetic energy transfer system coupled with a medical power source and a living body.

FIG. 17b is a schematic view of another embodiment of the wireless electromagnetic energy transfer system couplable with a medical power source and a living body.

FIG. 17c is a schematic view of the wireless electromagnetic energy transfer system coupled with a medical power source and couplable with a living body.

FIG. 18 is a schematic perspective view of the wireless electromagnetic energy transfer system provided in an offshore static power transfer system.

FIG. 19 is a schematic perspective view of the wireless electromagnetic energy transfer system provided in an offshore underwater static power transfer system.

FIG. 20 is a schematic plan view of the wireless electromagnetic energy transfer system provided in an offshore static/dynamic power transfer system.

FIG. 21 is a schematic sectional view of another embodiment of the wireless electromagnetic energy transfer system provided in an offshore static/dynamic power transfer system.

FIG. 22 is a schematic sectional view of another embodiment of the wireless electromagnetic energy transfer system provided in an offshore static/dynamic power transfer system.

FIG. 23 is a schematic sectional view of another embodiment of the wireless electromagnetic energy transfer system provided in an offshore static/dynamic power transfer system.

FIG. 24 is a schematic side view of another embodiment of the wireless electromagnetic energy transfer system provided in an offshore static/dynamic power transfer system including an underwater power transfer system.

FIG. 25a is a schematic oblique view of the wireless electromagnetic energy transfer system forming one or more electromagnetic loops.

FIG. 25b is a schematic oblique view of another example of the wireless electromagnetic energy transfer system.

FIG. 26 is a schematic oblique view of an example of shaping primary/secondary magnetic elements and primary/secondary conductors into curved planes.

FIG. 27a is a schematic exploded oblique plan view of another embodiment of the wireless electromagnetic energy transfer system.

FIG. 27b is a schematic perspective view of another embodiment of the wireless electromagnetic energy transfer system provided in an electronic (power) device.

FIG. 28a is a schematic oblique view of another embodiment of the wireless electromagnetic energy transfer system.

FIG. 28b is a schematic oblique view of another embodiment of the wireless electromagnetic energy transfer system provided in an electronic (power) device.

FIG. 29 is a block diagram of the wireless electromagnetic energy transfer system with primary and secondary conductors coupled with electrocomponents.

FIG. 30 is a block diagram of another embodiment of the wireless electromagnetic energy transfer system with primary and secondary conductors coupled with electrocomponents.

FIG. 31 is a schematic oblique view of the wireless electromagnetic energy transfer system with a shielding, an insulation and in a circuit with an energy source.

FIG. 32 is a schematic perspective view of the wireless electromagnetic energy transfer system with cylindrically shaped electromagnetic interface and a sensing ability.

FIG. 33a is a schematic oblique view of another embodiment of the wireless electromagnetic energy transfer system.

FIG. 33b is a schematic oblique view of another embodiment of the wireless electromagnetic energy transfer system.

FIG. 33c is a schematic oblique view of a variant of the wireless electromagnetic energy transfer system shown in FIG. 33b.

FIG. 34 is a schematic perspective view of the wireless electromagnetic energy transfer system between a grid, a hydrogen power unit providing fuel cells, an array of solar cells, a wind energy to electric energy converter, a rechargeable power source and a vehicle, a vessel, and a portable electric device.

FIG. 35 is a schematic plan view of another embodiment of the wireless electromagnetic energy transfer system.

FIG. 36 is a schematic oblique view of another embodiment of the wireless electromagnetic energy transfer system.

FIG. 37 is a schematic perspective view of another embodiment of the wireless electromagnetic energy transfer system provided in a subsea static power transfer system.

FIG. 38 is a schematic sectional view of another embodiment of the wireless electromagnetic energy transfer system provided in an offshore dynamic power transfer system.

FIG. 39 is a schematic oblique view of another embodiment of the wireless electromagnetic energy transfer system provided in an onshore/offshore static/dynamic power transfer system.

FIG. 40 is a schematic diagram of another embodiment of the wireless electromagnetic energy transfer system shown in a pulse width modulation topology with primary and secondary conductors coupled with electrocomponents.

FIG. 41 is a schematic diagram of another embodiment of the wireless electromagnetic energy transfer system shown in a power amplifier topology with primary and secondary conductors coupled with electrocomponents.

FIG. 42 is a schematic diagram of another embodiment of the wireless electromagnetic energy transfer system shown in a full-bridge inverter topology and a series L compensation.

FIG. 43 is a schematic diagram of another embodiment of the wireless electromagnetic energy transfer system shown in a full-bridge inverter topology and an LC compensation.

FIG. 44 is a schematic diagram of another embodiment of the wireless electromagnetic energy transfer system shown in a bidirectional full-bridge inverter topology and an LCL compensation.

FIG. 45 is a schematic diagram of another embodiment of the wireless electromagnetic energy transfer system shown in a full-bridge inverter topology and a CLLC compensation.

FIG. 46 is a schematic diagram of another embodiment of the wireless electromagnetic energy transfer system shown in a full-bridge inverter topology and a multiple LCLC compensation.

FIG. 47 is a schematic diagram of the wireless electromagnetic energy transfer system shown in a tuned circuit.

FIG. 48 is a schematic diagram of another embodiment of the wireless electromagnetic energy transfer system shown in a tuned circuit.

FIG. 49 is a schematic diagram of another embodiment of the wireless electromagnetic energy transfer system shown in a tuned circuit.

FIG. 50 is a schematic diagram of another embodiment of the wireless electromagnetic energy transfer system shown in a tuned circuit.

FIG. 51 is a schematic diagram of another embodiment of the wireless electromagnetic energy transfer system shown in a full-bridge inverter topology and a series L compensation.

FIG. 52 is a schematic diagram of another embodiment of the wireless electromagnetic energy transfer system shown in a full-bridge inverter topology and a series L compensation.

FIG. 53 is a schematic diagram of another embodiment of the wireless electromagnetic energy transfer system shown in a full-bridge inverter topology and a multiple LCLC compensation.

FIG. 54a is a schematic diagram of another embodiment of the wireless electromagnetic energy transfer system.

FIG. 54b is a schematic diagram of an equivalent circuit representation of the wireless electromagnetic energy transfer system embodiment shown in FIG. 54a.

FIG. 55a is a schematic diagram of another embodiment of the wireless electromagnetic energy transfer system.

FIG. 55b is a schematic diagram of an equivalent circuit representation of the wireless electromagnetic energy transfer system embodiment shown in FIG. 55a.

FIG. 56a is a schematic diagram of another embodiment of the wireless electromagnetic energy transfer system.

FIG. 56b is a schematic diagram of an equivalent circuit representation of the wireless electromagnetic energy transfer system embodiment shown in FIG. 56a.

FIG. 57 is a schematic diagram of another embodiment of the wireless electromagnetic energy transfer system forming an array.

FIG. 58 is a schematic diagram of another embodiment of the wireless electromagnetic energy transfer system forming a switchable array.

FIG. 59 is a schematic sectional view of another embodiment of the wireless electromagnetic energy transfer system provided in an onshore/offshore static/dynamic power transfer system.

FIG. 60 is a schematic oblique plan view of another embodiment of the wireless electromagnetic energy transfer system provided in an onshore/offshore static/dynamic power transfer system.

FIG. 61 is a schematic sectional view of another embodiment of the wireless electromagnetic energy transfer system provided in an onshore/offshore static/dynamic power transfer system.

FIG. 62 is a schematic oblique plan view of another embodiment of the wireless electromagnetic energy transfer system provided in an onshore/offshore static/dynamic power transfer system.

FIG. 63 is a schematic plan view of another embodiment of the wireless electromagnetic energy transfer system.

FIG. 64 is a schematic side view of another embodiment of the wireless electromagnetic energy transfer system.

FIG. 65 is a schematic plan view of another embodiment of the wireless electromagnetic energy transfer system provided in an onshore/offshore static/dynamic power transfer system.

FIG. 66 is a schematic side view of another embodiment of the wireless electromagnetic energy transfer system provided in an onshore/offshore static/dynamic power transfer system.

FIG. 67a is a schematic plan view of another embodiment of the wireless electromagnetic energy transfer system.

FIG. 67b is a schematic sectional view of the embodiment of the wireless electromagnetic energy transfer system shown in FIG. 67a.

FIG. 67c is a schematic sectional view perpendicular to the sectional view shown in FIG. 67b.

FIG. 68a is a schematic plan view of another embodiment of the wireless electromagnetic energy transfer system.

FIG. 68b is a schematic sectional view of the embodiment of the wireless electromagnetic energy transfer system shown in FIG. 68a.

FIG. 68c is a schematic sectional view perpendicular to the sectional view shown in FIG. 68b.

FIG. 69a is a schematic plan view of another embodiment of the wireless electromagnetic energy transfer system provided in an onshore/offshore static/dynamic power transfer system.

FIG. 69b is a schematic side view of the embodiment of the wireless electromagnetic energy transfer system shown in FIG. 69a shown with a secondary electromagnetic interface.

FIG. 69c is a schematic side view of a variant of the embodiment of the wireless electromagnetic energy transfer system shown in FIGS. 69a and 69b.

FIG. 70a is a schematic plan view of another embodiment of the wireless electromagnetic energy transfer system.

FIG. 70b is a schematic sectional view of the embodiment of the wireless electromagnetic energy transfer system shown in FIG. 70a.

FIG. 70c is a schematic sectional view perpendicular to the sectional view shown in FIG. 70b.

FIG. 71 is a schematic plan view of another embodiment of the wireless electromagnetic energy transfer system.

FIG. 72 is a schematic sectional view of another embodiment of the wireless electromagnetic energy transfer system.

FIG. 73 is a schematic side view of another embodiment of the wireless electromagnetic energy transfer system including a repeating electromagnetic interface and provided in a static/dynamic power transfer system.

FIG. 74 is a schematic side view of another embodiment of the wireless electromagnetic energy transfer system including a repeating electromagnetic interface and provided in an offshore static/dynamic power transfer system.

FIG. 75 is a schematic side view of another embodiment of the wireless electromagnetic energy transfer system provided in a static/dynamic power transfer system.

FIG. 76 is a schematic side view of another embodiment of the wireless electromagnetic energy transfer system provided in a static/dynamic power transfer system.

FIG. 77 is a schematic side view of another embodiment of the wireless electromagnetic energy transfer system.

FIG. 78 is a schematic side view of another embodiment of the wireless electromagnetic energy transfer system.

FIG. 79 is a schematic expanded view of another embodiment of the wireless electromagnetic energy transfer system.

FIG. 80 is a schematic oblique side view of another embodiment of the wireless electromagnetic energy transfer system.

FIG. 81 is a schematic oblique view of another embodiment of the wireless electromagnetic energy transfer system.

FIG. 82 is a schematic oblique view of another embodiment of the wireless electromagnetic energy transfer system.

FIG. 83 is a schematic oblique view of another embodiment of the wireless electromagnetic energy transfer system which can form an antenna array.

FIG. 84 is a schematic perspective view of another embodiment of the wireless electromagnetic energy transfer system.

FIG. 85 is a schematic plan view of another embodiment of the wireless electromagnetic energy transfer system.

FIG. 86 is a schematic plan view of another embodiment of the wireless electromagnetic energy transfer system.

FIG. 87 is a schematic plan view of another embodiment of the wireless electromagnetic energy transfer system.

FIG. 88 is a schematic plan view of another embodiment of the wireless electromagnetic energy transfer system.

FIG. 89 is a schematic plan view of another embodiment of the wireless electromagnetic energy transfer system.

FIG. 90 is a schematic plan view of another embodiment of the wireless electromagnetic energy transfer system.

FIG. 91 is a schematic oblique plan view of another embodiment of the wireless electromagnetic energy transfer system.

FIG. 92 is a schematic perspective view of another embodiment of the wireless electromagnetic energy transfer system.

FIG. 93 is a schematic oblique plan view of another embodiment of the wireless electromagnetic energy transfer system.

FIG. 94 is a schematic perspective view of another embodiment of the wireless electromagnetic energy transfer system.

FIG. 95 is a schematic oblique view of another embodiment of the wireless electromagnetic energy transfer system.

FIG. 96 is a schematic perspective view of another embodiment of the wireless electromagnetic energy transfer system.

FIG. 97 is a schematic plan view of another embodiment of the wireless electromagnetic energy transfer system.

FIG. 98a is a schematic plan view of another embodiment of the wireless electromagnetic energy transfer system.

FIG. 98b is a schematic side view of the embodiment of the wireless electromagnetic energy transfer system shown in FIG. 98a.

FIG. 98c is a schematic side view of a variant of the embodiment of the wireless electromagnetic energy transfer system shown in FIGS. 98a and 98b.

FIG. 99a is a schematic perspective view of another embodiment of the wireless electromagnetic energy transfer system.

FIG. 99b is a schematic oblique view of another embodiment of the wireless electromagnetic energy transfer system.

FIG. 100 is a schematic plan view of another embodiment of the wireless electromagnetic energy transfer system.

FIG. 101 is a schematic side view of another embodiment of the wireless electromagnetic energy transfer system.

FIG. 102 is a schematic side view of another embodiment of the wireless electromagnetic energy transfer system.

FIG. 103 is a schematic perspective view of another embodiment of the wireless electromagnetic energy transfer system.

FIG. 104 is a schematic perspective view of another embodiment of the wireless electromagnetic energy transfer system.

FIG. 105 is a schematic perspective view of another embodiment of the wireless electromagnetic energy transfer system.

FIG. 106a is a schematic perspective view of an example of shaping a primary/secondary (repeating) magnetic element.

FIG. 106b is a schematic perspective view of an example of shaping a primary/secondary (repeating) magnetic element.

FIG. 106c is a schematic plan view of an example of shaping primary/secondary (repeating) conductors.

FIG. 107 is a schematic perspective view of another embodiment of the wireless electromagnetic energy transfer system.

FIG. 108 is a schematic perspective view of another embodiment of the wireless electromagnetic energy transfer system.

FIG. 109 is a schematic perspective view of another embodiment of the wireless electromagnetic energy transfer system.

FIG. 110 is a schematic oblique view of another embodiment of the wireless electromagnetic energy transfer system.

FIG. 111 is a schematic perspective view of another embodiment of the wireless electromagnetic energy transfer system in a form of a coaxial electromagnetic cable.

FIG. 112a is a schematic perspective view of another embodiment of the wireless electromagnetic energy transfer system in a form of a parallel electromagnetic cable.

FIG. 112b is a schematic perspective view of another embodiment of the wireless electromagnetic energy transfer system in a form of an electromagnetic cable.

FIG. 112c is a schematic perspective view of a variant of the embodiment shown in FIG. 112b.

FIG. 113 is a schematic perspective view of another embodiment of the wireless electromagnetic energy transfer system.

FIG. 114 is a schematic perspective view of another embodiment of the wireless electromagnetic energy transfer system.

FIG. 115 is a schematic perspective view of another embodiment of the wireless electromagnetic energy transfer system.

FIG. 116 is a schematic perspective view of another embodiment of the wireless electromagnetic energy transfer system.

FIG. 117 is a schematic plan view of another embodiment of the wireless electromagnetic energy transfer system.

FIG. 118 is a schematic plan view of another embodiment of the wireless electromagnetic energy transfer system.

FIG. 119 is a schematic oblique plan view of another embodiment of the wireless electromagnetic energy transfer system provided in an onshore static/dynamic power transfer system.

FIG. 120 is a schematic plan view of another embodiment of the wireless electromagnetic energy transfer system provided in an onshore static/dynamic power transfer system.

FIG. 121 is a schematic oblique side view of another embodiment of the wireless electromagnetic energy transfer system provided in an onshore/offshore static/dynamic power transfer system.

FIG. 122 is a schematic oblique frontal view of another embodiment of the wireless electromagnetic energy transfer system.

FIG. 123 is a schematic sectional view of another embodiment of the wireless electromagnetic energy transfer system provided in an onshore/offshore static/dynamic power transfer system.

FIG. 124 is a schematic sectional view of another embodiment of the wireless electromagnetic energy transfer system provided in an onshore/offshore static/dynamic power transfer system.

FIG. 125a is a schematic perspective view of another embodiment of the wireless electromagnetic energy transfer system which can include light transfer.

FIG. 125b is a schematic perspective view of another embodiment of the wireless electromagnetic energy transfer system coupled with a defined interface.

FIG. 126 is a schematic perspective view of another embodiment of the wireless electromagnetic energy transfer system coupled with a defined interface and an alarm.

FIG. 127 is a schematic plan view of another embodiment of the wireless electromagnetic energy transfer system including transparent elements.

FIG. 128 is a schematic sectional side view of another embodiment of the wireless electromagnetic energy transfer system including transparent elements.

FIG. 129 is a schematic sectional side view of another embodiment of the wireless electromagnetic energy transfer system including transparent elements.

FIG. 130a is a schematic sectional side view of another embodiment of the wireless electromagnetic energy transfer system including transparent elements.

FIG. 130b is a schematic plan view of the embodiment shown in FIG. 130a.

FIG. 130c is another schematic plan view of the embodiment shown in FIGS. 130a and 130b.

FIG. 131 is a schematic perspective view of another embodiment of the wireless electromagnetic energy transfer panel including transparent elements.

FIG. 132 is a schematic perspective view of another embodiment of the wireless electromagnetic energy transfer panel including transparent or non-transparent elements and providing internal and external electromagnetic fields.

FIG. 133 is a schematic perspective view of another embodiment of the wireless electromagnetic energy transfer panel with in-plane electrodes and including transparent elements.

FIG. 134 is a schematic perspective view of another embodiment of the wireless electromagnetic energy transfer panel including combined electrodes system and transparent elements.

FIG. 135 is a schematic perspective view of another embodiment of the wireless electromagnetic energy transfer panel including transparent and non-transparent elements.

FIG. 136 is a schematic perspective view of another embodiment of the wireless electromagnetic energy transfer panel with in-plane electrodes and including transparent or non-transparent elements.

FIG. 137 is a schematic perspective view of another embodiment of the wireless electromagnetic energy transfer system with 3D modelled coupling sides and including transparent elements.

FIG. 138 is a schematic side view of another embodiment of the wireless electromagnetic energy transfer system including transparent elements provided in a combined light-energy device.

FIG. 139 is a schematic plan view of another embodiment of the wireless electromagnetic energy transfer system provided in a combined light-energy untethered device.

FIG. 140 is a schematic perspective view of another embodiment of the wireless electromagnetic energy transfer system provided in a combined light-energy devices/panels system.

FIG. 141 is a schematic of another embodiment of the wireless electromagnetic energy transfer system provided in a combined light-energy device.

FIG. 142 is a schematic perspective view of another embodiment of the wireless electromagnetic energy transfer system provided in an onshore static/dynamic power transfer system.

FIG. 143 is a schematic oblique plan view of another embodiment of the wireless electromagnetic energy transfer system providing a shifted electromagnetic field.

FIG. 144 is a schematic oblique plan view of another embodiment of the wireless electromagnetic energy transfer system providing a shifted electromagnetic field.

FIG. 145 is a schematic oblique plan view of another embodiment of the wireless electromagnetic energy transfer system providing a shifted electromagnetic field.

FIG. 146 is a schematic plan view of another embodiment of the wireless electromagnetic energy transfer system with an overlapping primary conductor providing a shifted electromagnetic field.

FIG. 147 is a schematic elevation view of another embodiment of the wireless electromagnetic energy transfer system provided in an onshore static/dynamic power transfer system.

FIG. 148 is a schematic elevation view of another embodiment of the wireless electromagnetic energy transfer system provided in an onshore static/dynamic power transfer system.

FIG. 149 is a block diagram of the wireless electromagnetic energy transfer system provided in an onshore/offshore static/dynamic power transfer system with primary and secondary conductors coupled with electrocomponents.

### BEST MODE FOR CARRYING OUT THE INVENTION

The following detailed description shows the best contemplated modes of exemplary embodiments. The description is made for the purpose of illustrating the general principles of the invention, and in such a detail that a skilled person in the art can recognise the advantages of the invention, and can be able to make and use the invention. The objects and advantages of this invention may be realized and obtained as pointed out in the appended claims. Additional advantages may be learned by practice of the invention. The detailed description is not intended to limit the principle of the presented invention, but only to show the possibilities of it and to explain the meaning and the sense of the terms used in the appended claims. The description and the detailed description are exemplary and explanatory only. Schematic cross sectional views are partly not cross-hatched for clarity. Symbols as used in figures have only symbolic meaning (e.g. others than shown types of switches and other electrocomponents in different circuits can be used, etc.). Shown circuits, block diagrams, etc. are simplified and explanatory only and can be altered, developed or provided in a different way with a same or similar or analogical functionality. Shown embodiments are only partly oriented (e.g. embodiments explaining onshore/offshore power transfer systems, etc.) and can be provided in different positions, orientations, etc.

The terms used in the claims and the specifications shall refer to their synonyms as well.

As used in the claims and the specification, the term “energy transfer” shall preferably not exclusively refer to transferring energy to do work, to store energy, to provide communication, shall refer to power transfer, data transmission, etc.

As used in the claims and the specification, the term “magnetic element” shall refer to any type, size, fabrication method. It can have any shape [e.g. pads, bars, plates, panels, slabs, blocks, striated blocks, sheets, segments, 3D or 2D modelled shapes, hollow volumes, cores/e.g. circular, circular striated, square, rectangular, T-core, U-core, E-core, Double U, etc] it can be formed from smaller pieces, particles of a magnetic material, which can be alternatively comprised in a material with different magnetic permeability or a nonmagnetic material, it can be a magnetically permeable substrate or a magnetically permeable film on a substrate, magnetically permeable printed circuit board [e.g. a glass-reinforced composite epoxy laminate material/such as FR-4/with relative magnetic permeability higher than 1/e.g. containing magnetic (nano) particles, powders, etc.]. The term shall refer to (highly) magnetic permeable material, magnetic material, material with the lower reluctance path, soft magnetic material, gyroresonant magnetic material, and the like.

As used in the claims and the specification, the term “conductor” as in conductor, primary conductor, secondary conductor shall also refer to the term primary/secondary electrode, primary/secondary electrode plate, and shall refer to any material, type, size, shape, cross-section, shall refer to electrodes with functional openings (e.g. providing tuning possibilities), and to mutually oriented [e.g. in pairs] electrodes, shall also refer to conductors with low proximity losses, nanostructures and which may be formed by any technique including crystal and structure growth techniques. The conductors may be of good conductor materials, high conductivity materials, etc. The conductors may be covered with a material with high electrical conductivity as radio frequency (RF) current with RF energy flows mostly around the surface of the conductor. The conductors may be wires, tressed wires, stranded wires, fibers, sheets, plates, bands, tubes, hollow (cavity) profiles, shaped profiles, rods, strips, microstrips, striplines, lines, ribbons, gels, inks, paints, traces [which can have a various cross section, aspect ratio and which can form stranded traces], printed circuit boards, nanostructures, etc. or may have any form of a conductive path. A cross-section of full profiles, hollow profiles, shaped profiles may have any form [e.g. circular, oval, squared, irregular, geometrical shapes, polygonal, etc.]. The conductors may be of copper wire, copper tubing, etc., may be optically transparent. The conductors may have coupling nodes, feed points [which can be represented by tabs, extensions, etc.], which may be positioned in any position [e.g. in a center of the length, at the ends, etc.], coupling ports which can be coupled with a port parameter measurement circuitry which can measure scattering, impedance, admittance, chain, cascade, transmission, parameters, etc. The port parameter measurement circuitry may be coupled with a processor in a control system e.g. to adjust a pulse width modulator, a power amplifier, an inverter, an adjustable impedance circuitry, etc. The conductors may be oriented substantially parallel or perpendicular to a coupling surface, or in any other direction. The conductors may form various paths [e.g. direct parallel, meandering, shifted loops, etc.]. The term may also refer to semiconductors, semiconductor layers and may refer to gallium arsenide, indium arsenide, indium phosphide, indium antimonide, graphene, silicon, germanium, combinations, and the like.

As used in the claims and the specification the term “at about” shall be interpreted with regard to the scope of the present invention which is the wireless electromagnetic energy transfer system.

For example a conductor can be disposed at a distance of a respective magnetic element so that the system can work, i.e. at such a distance where the energy transfer between the circular magnetic fluxes and the electric current flowing in the respective conductor can occur. This distance will depend on the parameters of a specific embodiment of the invention and cannot be exactly stated in this patent application, for this reason the term “at about” can be interpreted as “in the proximity of”.

As used in the claims and the specification the terms “primary”, “secondary”, “repeating” in connection with conductors, elements, interfaces, etc. may be contemplated as interchangeable.

In other words the embodiments of the invention may be configured in a way that a primary conductor becomes a secondary conductor, etc. So, for clarity purposes and not to encumber the description with repeating, even if an element may be described as “primary”—“secondary” or “repeating” can be contemplated. Primary elements may be in general coupled with an energy supply and secondary with an energy consumption.

As used in the claims and the specification, the term “circular magnetic flux” shall also refer to an elliptical path, etc. Circular magnetic fluxes and electric fields shown in drawings are shown in a schematic, simplified form and preferably in one phase [e.g. a decreasing phase] of a primary flux or field and are not shown in some figures where they are obvious [e.g. with reference to other similar or analogic figures]. The term “circular magnetic field” shall refer to a magnetic field characterised by one or more circular magnetic fluxes [analogically for circular electromagnetic field].

As used in the claims and the specification, the term “wirelessly transfer electromagnetic energy” shall refer to energy transfer associated with electric fields, magnetic fields, electromagnetic fields without use of physical electromagnetic conductors. Energy transfer may include power transfer and data transfer (communication).

As used in the claims and the specification, the term “primary electromagnetic interface” shall also refer to transmitting antenna, transmit antenna, shall also refer (as bidirectional and multidirectional energy transfer may be contemplated) to receiving antenna, receive antenna, resonant antenna, parasitic antenna, repeater antenna, transmit receive antenna, transceive antenna, resonant tank, parasitic resonant tank, electric antenna, magnetic antenna, electromagnetic antenna, electromagnetic coupler, electromagnetic coupling unit, etc., (similarly for secondary and repeating electromagnetic interfaces).

As used in the claims and the specification, the term “light” shall refer to polarized and non-polarized light, shall refer to TM, TE polarized light, light with the phase delay and with various polarizations, shall refer to linear polarized and circularly polarized light, etc.

As used in the claims and the specification, the terms “shielding”, “shielded” shall refer to shields that may shape, guide, shield, reflect, refract, diffract, block, change polarisation of electric and magnetic fields in a desired manner to enhance the coupling, to reduce energy losses, to direct the electromagnetic field to and/or away from a specific direction. The shielding may be a single construction or multilayered combination and may be comprised of a conductive, magnetically permeable material, an artificial magnetic conductor (structure), a conductive material such as aluminium, copper, silver, brass, etc. with a thin magnetically permeable material layer such as ferrites containing materials. The shielding may shield electrocomponents [e.g. control electronics] of the system which can be provided in a shielded enclosure, which can be insulated [e.g. thermally, waterproof, etc.]. The shielding may have various (sufficient) thickness [e.g. at least 1 tines the skin depth of fields/e.g. electric, magnetic fields/], it can be a metal gauze or mesh or other structures with slots or holes (which can be sufficiently small in comparison with a wavelength). The shielding materials may exclude circular magnetic fluxes from them [e.g. by induced circulating eddy-currents generating a second field equal and opposite to the imposed field thus cancelling it out at a surface of the shielding].

As used in the claims and the specification, the term “electrical insulation” shall also refer to dielectric layer, material, a spacer, etc.

As used in the claims and the specification, the term “liquids insulations”, “solids insulations” shall also refer to a dust, dirt, mud insulation, and the like As used in the claims and the specification, the term “thermal management system” shall refer to active and/or passive systems.

As used in the specification, the term “tempering systems using phase change materials” shall refer to systems using a pure phase change material (PCM) substance and to systems using methods for increasing the thermal conductivity (e.g. inserted fins, heat pipes; added fillers, foams, particles, nanostructures; metal/semimetal/nonmetal materials; carbon, graphite, graphene, composites), and to systems using dispersed/decentralised/microcapsule packaging.

As used in the claims and the specification, the term “tempering systems using heat pipes” shall also refer to systems using heat sinks, heat spreaders, vapor chambers, condensers, evaporators, etc., shall refer to compound cooling, natural convection cooling, and shall refer to systems using thermal conductance materials in any shape and form (e.g. tubes, foams, fibers, etc.) to transport, spread, dissipate, etc. heat/cold.

As used in the claims and the specification, the term “module” shall refer to a module wherein said module is modularly scalable and/or exchangeable and/or couplable with at least one element of said electromagnetic energy transfer system.

As used in the claims and the specification, the term “enlarging element” shall refer to an enlargement which may be provided as an enlarging shape, an added material [which may be attached, coupled, etc.] or a structure [e.g. a metallic plate which may be provided with a dielectric layer, etc.] which may be of same or different material from a material of a primary/secondary/repeating conductor or magnetic element, an enlarging element may provide condenser action, may provide circular magnetic flux, may anchor a primary/secondary conductor in a primary/secondary magnetic element, may shield, etc.

As used in the claims and the specification, the term “conductor provide condenser action” shall refer to capacitive action provided by the primary/secondary/repeating conductor and/or to capacitive action provided by one or more capacitive plates coupled with the primary/secondary/repeating conductor and shall refer to internal condenser action (self capacitance) and external condenser action (mutual capacitance).

As used in the claims and the specification, the term “dielectric layer” shall also refer to dielectric materials, dielectric coatings, etc., and shall also refer to an air-gap. The dielectric layer may be provided to the primary/secondary conductor and/or to one or more capacitive plates coupled with the primary/secondary conductor. The dielectric layer may be magnetic or non-magnetic. The dielectric layer may be a multilayer combining different materials, thicknesses, properties, etc.

As used in the claims and the specification the term “array” shall refer to any functional array such as driven, broadside, endfire, collinear, turnstile, superturnstile, planar, conformal, parasitic, switched beam, phased [e.g. the invention can be used in a phased array transmitter or receiver], etc. Arrays can have various configurations and geometries for ensuring an optimum performance for the (smart) antenna systems.

As used in the claims and the specification the term “planar” shall refer to planes (surfaces), curved planes, 2D or 3D modelled planes, free modelled planes, quadric surfaces, surfaces of revolution, sections of planes, combinations, etc.

As used in the claims and the specification, the term “oscillator” shall also refer to oscillators wherein frequency, amplitude, phase, waveform, duty cycle, etc. may be controllable, variable, etc. by digital and/or analog circuitry and shall further refer to crystals, ceramic oscillators, ring oscillators, central processing unit internal oscillators, relaxation oscillators, other waveform generating circuits, etc., class D, E, F, Doherty amplifiers may be used as oscillators, switching devices with filters, etc.

As used in the claims and the specification the term “compensation” shall also refer to a tuning network, a tuning circuit, a matching circuit, an adjustable impedance network, a tank circuit, and the like [wherein with a filter may refer to a resonant transformer or L-section]. The primary/secondary electromagnetic interfaces (antennas) may be impedance-matched to power sources, loads, transmission lines, etc.

As used in the claims and the specification the term “processor” shall also refer to a general purpose processor, a Digital Signal Processor (DSP), an Application Specific Integrated Circuit (ASIC), an Intergrated Circuit (IC), a Field Programmable Gate Array (FPGA) or other programmable logic devices, discrete gates or transistor logic, discrete hardware components, microprocessors, electronic processors in a computing device, pre-programmed integrated circuits, combinations, etc. The processor may be coupled and communicate wiredly/wirelessly [e.g. can use near field communication, wireless personal/local area networks, telephone technologies, etc.]. The processor may monitor the power, current, voltage. etc. at any point of the system circuitry, may use feedback algorithms circuits, analog and digital signal processing techniques to control the system, etc. The processor may execute programs [which may be stored on a computer readable storage medium] based on standard programming techniques and may use any storage medium. The processor and the storage medium may reside as discrete components in an user terminal.

As used in the claims and the specification, the term “capacitor” shall preferably not exclusively refer to supercapacitors, ultracapacitors, double-layer capacitors (e.g. with activated carbons, carbon aerogels, carbon nanotubes, nanoporous carbon, graphene, carbid-derived carbon), pseudocapacitors (e.g. with polymers, metal oxides), hybrid capacitors (e.g. with asymmetric electrodes, lithium-ion capacitors, with composite electrodes), electrolytic capacitors (e.g. aluminium electrolytic capacitors), ceramic capacitors, mica capacitors, film capacitors, chip shape, lead shape capacitors, multilevel circuit board processed capacitors, etc.

As used in the claims and the specification the terms “resonator”, “capacitor”, “coil”, “diode” shall also refer (as controllable electrocomponents) to variable, tunable resonators, capacitors, coils, diodes, and shall further refer to switched banks of these circuit components, arrays, array banks, etc. The diodes may be Schottky diodes, reverse-biased PN diodes, Si diodes, GaN diodes, SiC diodes, discrete diodes, chip integrated diodes. PIN diodes, PIN photodiodes, etc.

The term “coil” shall refer to loop and the like as well and shall refer to coils with various numbers of turns and shapes from various materials including solid copper on a PCB [e.g. for frequencies above 2 MHz], Litz wire [e.g. for frequencies under 2 MHz], braided wire, stranded mains cable, etc. The adjustability may be automatical, manual, electrical, piezo-electrical, electronical, mechanical, thermal, etc. Inductances may be transformer coupled circuits, switching, ferro-magnetic tuning, mu-tuning, etc. adjustable.

As used in the claims and the specification, the term “rectifier” shall also refer to a full bridge rectifier, a half bridge rectifier, to a rectifier composed of discrete diodes, chip integrated diodes, a (high) voltage step-up, step-down rectifiers passive diode rectifier, a quad diode full wave full bridge rectifier, a synchronous rectifier, etc.

As used in the claims and the specification, the term “inverter” shall also refer to a half bridge inverter, a power conversion unit, a DC-AC inverter, a low frequency to high frequency inverter, an inverter rectifier, etc.

As used in the claims and the specification, the term “converter” shall refer to AC-DC, DC-DC.

DC-AC, AC-AC. DC-DC/AC, analog to digital converters, digital to analog converters, boost, buck, buck-boost, sepic converters, constant frequency power converters, power conversion units, auxiliary converters, variable voltage converters, etc.

As used in the claims and the specification, the term “transformer” shall refer to any transformer type, construction, functionality [e.g. isolation transformers], etc.

As used in the claims and the specification, the terms “transmitter”, “receiver” shall also refer to ultra-high frequency (UHF) band or higher [e.g. 866 MHz, 900-930 MHz, 1.575 GHz and 1.610 GHz, 2.45 GHz, etc.], high frequency (HF) [e.g. 13.56 MHz], low frequency (LF) [e.g. 135 kHz], etc. transmitters, receivers.

As used in the claims and the specification, the term “controller” shall also refer to control electronics, control circuits and shall refer to a controller which can activate the system [e.g. can activate primary/secondary conductors to create circular magnetic fluxes, a 3D space time varying magnetic field, provided condenser action, etc.] to wirelessly transfer electromagnetic energy [e.g. in a bidirectional energy flow], to adjust system parameters (resistances, capacitances, inductances, frequencies, voltages, currents, etc.), shall refer to a plurality, arrays of controllers, to controllers including one or more processors, etc., and shall refer to programmable or non-programmable logic devices as well, microcontrollers, etc.

As used in the claims and the specification, the term “varactor” shall also refer to varactor arrays which can be connected in series and in parallel.

As used in the claims and the specification, the terms “electromagnetic waveguide”, “electromagnetic septum antenna” shall refer to a waveguide (a septum antenna) with at least an inner surface provided with a highly electromagnetically permeable material or with a magnetic material with a (relative) permeability higher than the material of the waveguide (the septum antenna).

As used in the claims and the specification, the term “switch” shall refer to any type of a switching mechanism and shall refer to switching circuits, banks, arrays, etc., shall refer to field effect transistors (FETs), metal-oxide semiconductor field effect transistors (MOSFETs), power MOSFETs, insulated-gate bipolar transistors (IGBTs), PIN diodes switches, micro-electro-mechanical-systems (MEMS) switches, relays, mechanical switches, switches containing electronic circuits, proximity switches, process switches, thyristor-based switches, switched-mode power supplies, etc.

As used in the claims and the specification, the term “network” shall refer to physical and/or logical networks [e.g. intranet, the Internet, personal area networks, local area networks, wide area networks, etc.].

As used in the claims and the specification the term “sensor” shall also refer to optical, acoustical, electromagnetic sensors, magnetic sensors, voltage sensors, current sensors, inductive sensors, capacitive sensors, temperature sensors, pressure sensors, etc.

As used in the claims and the specification, the term “alarm” shall refer to security components and networks containing active and passive security components which can include a power source, a buzzer, a speaker, optical, acoustical, vibration sensors, cameras, controllers, antennas, window foils, mechanical security systems (e.g. electromagnetically operable barriers, doors, windows, etc.). An alarm network can detect fire, smoke, movement, vibrations, noise, body heat, etc. and can comprise various electrocomponents (e.g. thermistors, timers, switches, transistors, integrated circuits, etc.). Alarm network sensors which can be provided according to the present invention can be coupled with physical components (e.g. constructions), electromagnetic fields, etc.

As used in the claims and the specification, the term “rechargeable power source” shall preferably not exclusively refer to power sources including rechargeable batteries [e.g. strings, packs, modules, cells], capacitors [e.g. strings, packs, modules, cells], batteries with integrated storage capacitors, hybrid sources, marine power sources [e.g. buoyant/nonbuoyant], swappable power sources, energy storage elements [e.g. hydrocarbon fuel storage, mechanical (e.g. compressed air, compressed gas, flywheel, etc.), electromagnetic (e.g. using superconductors, etc.), electrochemical (e.g. flow battery, ultrabattery, etc.), thermal (e.g. phase change material, cryogenic energy storage, liquid nitrogen engine, etc.), chemical (e.g. biofuel storage, power to gas storage, power to liquid, hydrogen storage, hydrogen peroxide, etc.)]. The rechargeable power source can include a wireless power receiver including the primary/secondary electromagnetic interface [e.g. in a container of a marine power source, an AA rechargeable battery can include a wireless power receiver, etc.]. The term shall refer to the electromagnetic energy storage element in according to the present invention.

As used in the claims and the specification, the term “rechargeable battery” shall preferably not exclusively refer to lithium-ion, lithium-ion polymer, lithium-air, lithium-sulphur, lithium-metal, nickel-metal hydride, nickel-iron, nickel-cadmium, lead-acid, valve regulated lead-acid, absorbed glass mat, gel [e.g. for high pressure, high temperature implementations], solid state, organic radical batteries. Shall also refer to AA, AAA, D, 9V, laptop, cell phone, button batteries, etc. Rechargeable batteries may include fuel cells, piezoelectric elements, springs. A variety of arrangements of multiple rechargeable batteries may be used. Rechargeable batteries may be trickle, float charged, charged at fast, slow rates.

As used in the claims and the specification, the term “source management system” shall also refer to rechargeable power source management systems, battery charge systems, battery charge control units, battery energy control modules, and the like.

As used in the claims and the specification, the term “communication interface” shall also refer to RS 485, Ethernet Port, USB, Bluetooth, NIC (Network Interface Controller), CAN (Controller Area Network), DVI (Digital Visual Interface), optic modem, acoustic modem, reader/router, etc., and shall refer to user interface [e.g. a light, a noise, a vibration, a screen, a display/e.g. a liquid crystal display, a cathode ray tube, a plasma, a projector display/, a keyboard, a touch screen, a stylo, a pen, a mouse, an audio device/microphone/, etc.]. The communication interface can be provided according to the present invention.

As used in the claims and the specification, the term “input device”, “output device” shall also refer to input/output circuitry which can include active components (converters, amplifiers, signal generation chips, etc.) and passive components.

As used in the claims and the specification, the term “energy source” shall refer to any type of electric energy source, shall refer to energy providing power and/or data, shall refer to alternating current (AC) sources, direct current (DC) sources, modulated and nonmodulated signal sources (which can provide data transmission, communication, etc.), shall refer to onshore energy sources, offshore energy sources, or combinations thereof.

As used in the claims and the specification, the term “hybrid source” shall refer to any type of electric energy source combined with other energy source (e.g. thermal, radiant, chemical, nuclear, motion, sound, elastic, gravitational energy).

As used in the claims and the specification, the term “power source” shall also refer to AC, DC power sources, dual or multiple excitation power sources, power sources with a phase difference, AC/DC power outlets, etc., shall refer to shared power sources, multiplexed power sources (frequency, spatially, orientation, etc.), power sources in tuned off, idle, sleep modes, power sources monitoring, billing, controlling energy transfer, etc.

As used in the claims and the specification, the term “load” shall also refer to power sink and shall refer to any type of load, for example a resistive load such as a light bulb, or a mobile or stationary electronic device (e.g. GPS navigations, house-hold robots, etc.), a rechargeable power source, a transport means (e.g. vehicles, vessels, drones, etc.), medical devices (e.g. implanted devices, autonomous devices, etc.), military applications (e.g. heated, illuminated clothing, built-in vehicles equipments, etc.), an AC or DC load/power drain, etc.

The invention can provide bidirectional energy flow which can include multidirectional energy (power and/or data) flow. Energy sources and loads can function in a dual, triple, multiple modes. Loads can be energy sources for other loads (e.g. in case of repeating systems).

As used in the claims and the specification, the term “light source” shall refer to any type of a light source producing light useable in the invention, and shall refer to backlight sources, reflective light sources, ambient light sources (e.g. sunlight), etc.

As used in the claims and the specification, the term “liquid crystal device” shall refer to any device including liquid crystals, shall refer to display and non-display devices, to liquid crystal panels and liquid crystal displays, flexible and non-flexible devices, shall refer to active and passive devices [e.g. providing external and/or internal electromagnetic fields], shall refer to combined light-energy systems.

As used in the claims and the specification, the term “permanent magnet” shall refer to flexible, non-flexible magnets, rare earth alloys magnets (e.g. neodymium iron boron, samarium cobalt, etc.), alnico, ferrite magnets, etc., shall refer to aluminium, silver, platinum, nickel type magnets, or any other type of permanent magnet.

As used in the claims and the specification, the term “magnetic material” shall refer to any type, structure, it shall refer to magnetic fibers, sheets, fabrics, textiles, pieces, particles, nanoparticles, powders, shall refer to hard and soft magnetic materials, etc.

As used in the claims and the specification, the term “liquid” shall also refer to a coupling liquid (i.e. liquid wherein an energy transfer may at least partially take place).

As used in the claims and the specification, the term “water” shall also refer to rain, vapor, condensed vapor, slurries, mud, ice, salt solutions, mixtures with solid particles, gaseous particles, etc.

As used in the claims and the specification, the term “working pairs” shall refer to at least two electromagnetic interface (element) structure (also four-element, six-element, multielement structures can be contemplated); at least two elements (primary/secondary/repeating conductors and/or magnetic elements) can form one or more respective working pairs which can be provided in one or more respective interfaces; the working pairs can form groups (of two or more elements) which can include various combinations of elements (e.g. 1+1, 2+2, 1+2, M+N, etc.); and shall also refer to dual pole, dipole, multipole, etc. electromagnetic interfaces (antennas), and shall refer to adjustable pole pitch structures. The term shall refer to one or more working groups of a definite or indefinite number of members.

As used in the claims and the specification, the term “charging station” shall also refer to charger, charging unit, converter, and the like.

As used in the claims and the specification, the term “offshore vessel” shall refer to “water vessel”, “maritime vessel”, “electric ship”, “hybrid boat”, and the like, and shall refer to manned and unmanned vessels, shall refer to overwater and underwater vessels, amphibious vessels, models and toys, shall preferably not exclusively refer to any type of the offshore vessel arranged to transport directly or indirectly (e.g. to tow another transporting vessel) one or more electric vehicles, arranged to charge the electric vehicles when onboard, to offshore vessels at least partially electrically driven, to offshore vessels using electric energy to power auxiliary systems, offshore vessels including electric energy powered technologies (e.g. hydrogen production units, etc.).

As used in the claims and the specification, the term “electric vehicle” shall preferably not exclusively refer to an onshore (rechargeable) vehicle at least partially electrically driven, shall refer to manned and unmanned vehicles, and shall refer to any type of the electric vehicle (including fully electric and hybrid electric) including an electric motor and/or coupled/couplable with a vehicle including an electric motor to directly or indirectly propel the vehicle [e.g. to tow the vehicle], shall refer to amphibious vehicles, electric planes, electric helicopters, hybrid planes and helicopters, and shall refer to models and toys as well, shall also refer to the electric vehicles arranged to use charging/discharging power for other purposes (auxiliary, mobile technology [e.g. cooling systems, etc]), shall refer to convoys and combinations including at least one electric vehicle, shall refer to vehicles including or coupled (couplable) with smart chargers, bidirectional chargers, Level 1, 2, 3, 4 chargers, (fast) AC chargers, (fast) DC chargers, proprietary [e.g. Tesla] chargers, wireless inductive, capacitive, magnetodynamic chargers, combined chargers, etc.

As used in the claims and the specification, the term “ferrites” shall refer to any kind, shape [e.g. bars, strips, sheet, layer, 3D shapes, etc.], composition, etc. of ferrites, shall refer to rigid and flexible ferrites, [e.g. at frequencies at about 6 MHz the ferrites can be Nickel-Zinc ferrites, rigidly-formed NL-12S ferrites, and/or flexible FJ3, at lower frequencies (e.g. under 2 MHz) Manganese-Zinc ferrites, etc.]. The term shall preferably refer to soft ferrites, and shall refer to transparent ferrites as well.

As used in the claims and the specification, the term “magnetic metals” shall preferably not exclusively refer to iron, soft iron, ferrite iron, carbonyl iron, hydrogen reduced iron, nickel, cobalt, solid metals, powdered metals, laminated metals, amorphous metal, alloys, nickel alloys, mu-metal, permalloy, supermalloy, molypermaloy, high-flux Ni—Fe, Sendust, KoolMU, steel, electrical steel, ferritic stainless steel, martensinic stainless steel, silicon steel, special alloys, nanostructures, nanocrystalline, etc. and shall refer to “magnetic permeable materials”.

As used in the claims and the specification, the term “transparent” as in transparent magnetic material shall also refer to transparent magnetic (oxide) layer. The term transparent shall also refer to translucent and vice versa.

As used in the claims and the specification, the terms “magnetic gel” shall preferably not exclusively refer to a gel containing magnetic particles, structures of any size (including nanoparticles) or to any gel having (high) magnetic permeability and providing a path for circular magnetic fluxes.

Gels and magnetic gels in according to the present invention which can be used for the thermal therapy may consist of water/glycerol or other antifreeze solutions, thickening agents (e.g. linear polymers), polyacrylamide gels, polyvinyl alcohol/polyurethane blends, aqueous polyvinyl alcohol solutions, cross-linked water absorbing polymers, etc.

As used in the claims and the specification, the terms “photomagnetic material” and “polymers containing magnetic materials” shall also refer to photopolymers.

As used in the claims and the specification, the term “binder” shall refer to any type of binder [inorganic or organic/resin/] capable to bind a magnetic material and shall also refer to binder solutions including (nano-) magnetic powders.

As used in the claims and the specification, the term “ink” shall also refer to inks including (nano-) magnetic powders.

As used in the claims and the specification, the term “molding” may use molds formed by CNC (computer numerical control) routing, milling, grooving, etc., by injection, casting, etc. Molded can be a produced set of the conductors to be coupled with a magnetic element [which can be molded as well] and similarly other proposed methods [casting, melting, pouring, thermoforming, etc.]. The set of conductors can remain in the mold or can be removed [similarly for the magnetic elements] or can be removed after coupling.

As used in the claims and the specification, the term “printed circuit board fabrications techniques” (PCB techniques) shall refer to techniques on any PCB material such as FR-4 (epoxy E-glass), multi-functional epoxy, high performance epoxy, bismalaimide triazine/epoxy, polyimide. Cyanate Ester, polytetraflouroethylene (Teflon), FR-2, FR-3, CEM-1, CEM-2, Rogers, Resolute, and the like. The conductor traces may be formed on printed circuit board materials with lower loss tangents. The conducting traces may be composed of copper, silver, gold, aluminum, nickel and the like, and may be composed of paints, inks, or other cured materials. The circuit board may be flexible and it may be a flex-circuit. The conducting traces may be formed by chemical deposition, etching, lithography, photolithography, spray deposition, cutting, and the like. The conducting traces may be applied to form the desired patterns and may be formed using crystal and structure growth techniques.

The conducting traces may be deposed on magnetic substrates (magnetic elements) using claimed fabrication techniques. Producing a set of one or more conductors and coupling the produced set with one or more magnetic elements can be provided in a joined processus (e.g. etching on a magnetic substrate, a photolithography on a magnetic substrate, etc.).

Similarly the coupling methods [molding, casting, melting, etc.] can be used for adding one or more shieldings.

The produced electromagnetic energy transfer interface (and its elements during fabrication phases) can be further covered, painted, attached, treated, etc.

As used in the claims and the specification, “A/B” shall refer to A and/or B As used in the claims and the specification, the singular forms are intended to include the plural forms as well and vice versa.

The term “to couple” and derivatives shall refer to a direct or indirect connection via another device and/or connection, such a connection can be mechanical, hydraulical, electrical, electronical, electromagnetical, pneumatical, communication, functional, etc. [e.g. a secondary electromagnetic interface can be couplable/coupled with a living body via a medical insulation, a primary/secondary/repeating electromagnetic interface can be coupled with an electrocomponent via a primary/secondary/repeating conductor, and with a magnetocomponent via a primary/secondary/repeating magnetic element, etc.]. The connection can be temporary, permanent, detachably attachable, scalable, slotable. The connection can be wired or wireless [e.g. the primary/secondary conductors can be designed to be couplable/coupled with an energy source, a load, etc. wiredly or wirelessly.]. The components [e.g. electrocomponents] can be indirectly coupled, transformer-coupled, inductively coupled, coupled via other electrocomponents, etc. Any additional systems may be coupled to the elements, components, etc. and to the system of the invention. Circuit components may be soldered, welded, glued, use various connection techniques, etc., and may be integrated on a chip. xxx

The terms “to comprise”, “to include”, “to contain”, “to provide” and derivatives specify the presence of an element, but do not preclude the presence or addition of one or more other elements or groups and combinations thereof.

The term “consisting of” characterises a Markush group which is by nature closed. Single members of the group are alternatively useable for the purpose of the invention. Therefore, a singular if used in the Markush group would indicate only one member of the group to be used.

For that reason are the countable members listed in the plural. That means together with qualifying language after the group “or combinations thereof” that only one member of the Markush group can be chosen or any combination of the listed members in any numbers. In other words, although elements in the Markush groups may be described in the plural, the singular is contemplated as well. Furthermore, the phrase “at least one” preceding the Markush groups is to be interpreted that the group does not exclude one or more additional elements preceded by the phrase.

The invention will be described in reference to the accompanying drawings.

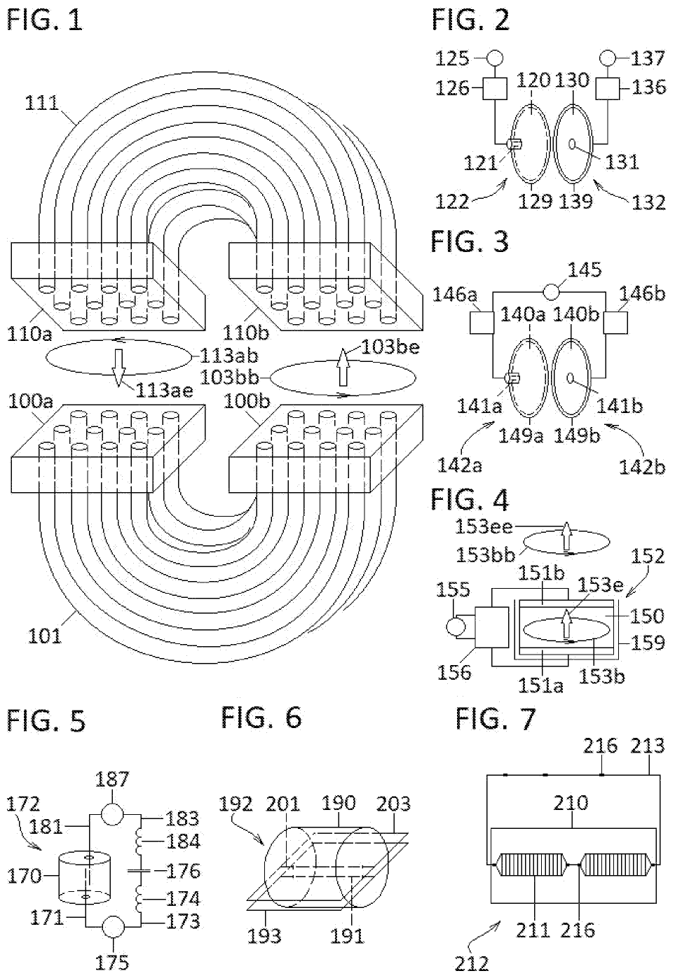

FIG. 1 is a schematic oblique view of a wireless electromagnetic energy transfer system.

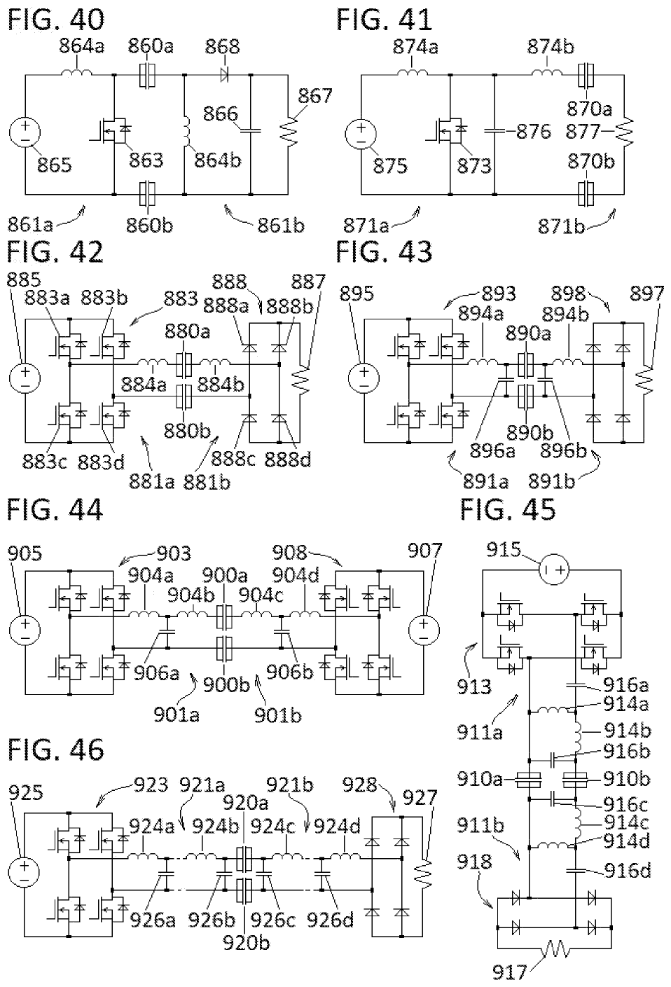

The system can comprise a pair of primary magnetic elements (100a, 100b) and a pair of secondary magnetic elements (110a, 110b) spaced apart from each other to transfer one or more circular magnetic fluxes (103bb, 113ab) which can be associated with electric fields (103be, 113ae) (shown in a simplified way). Primary conductors (101) can be partially disposed at about and in the primary magnetic elements (100a, 100b) to create the circular magnetic fluxes (103bb, 113ab) to wirelessly transfer electromagnetic energy from the primary conductors (101) to secondary conductors (111) at least partially disposed at about and in the secondary magnetic elements (110a, 110b) and vice versa. [The ends of the primary conductors (101) can be alternately charged positive and negative provided the ends can be connected through an alternating energy source (not shown) or can be charged in high amplitudes and discharged in low amplitudes (e.g. provided the ends can be connected through a power amplifier as shown in FIG. 41) or the amplitude can be represented by variable-width pulses (e.g. provided the ends can be connected through a pulse width modulation converter as shown in FIG. 40).] The primary and secondary conductors (101, 111) can provide mutual condenser action.

FIG. 2 is a schematic of the wireless electromagnetic energy transfer system. A primary magnetic element (120) [which can have a planar coupling side and a conical sidewall] and a primary conductor (121) [which can have a planar frontal coupling side] can form a primary electromagnetic interface (122) which can be coupled with a transmitter (126) to be couplable with an energy source (125). The primary magnetic element (120) and the primary conductor (121) can be shielded from the back side with a shielding (129). A secondary magnetic element (130) [which can have a planar coupling side and a conical sidewall] and a secondary conductor (131) [which can have a planar frontal coupling side] can form a secondary electromagnetic interface (132) which can be coupled with a receiver (136) to be couplable with a load (137). The secondary magnetic element (130) and the secondary conductor (131) can be shielded from the back side with a shielding (139). [The system can be configured to provide bidirectional energy flow.]

FIG. 3 is a schematic of the wireless electromagnetic energy transfer system. Primary/secondary magnetic elements (140a, 140b) and primary/secondary conductors (141a, 141b) can form primary/secondary electromagnetic interfaces (142a, 142b) which can be shielded with shieldings (149a, 149b) and which can be coupled with electrocomponents (146a, 146b) and with an energy source (145).

FIG. 4 is a schematic diagram of another embodiment of the wireless electromagnetic energy transfer system. A primary/secondary magnetic element (150) [which can provide a dielectric layer and which can be able to transfer substantially one or more internal circular magnetic fluxes (153b) associated with an internal electric field (153e)] and primary/secondary conductors (151a, 151b) [wherein electric current flowing through one of said primary and secondary conductors can create said one or more internal circular magnetic fluxes (153b) to generate electric current in another one of said primary and secondary conductors (151a, 151b)] can form a primary/secondary electromagnetic interface (152) which can be partially shielded with a shielding (159) and which can be coupled with an electrocomponent (156) [which can be an integrated circuit (chip) oscillator, etc.] and an energy source (155). The primary/secondary plate electrodes (151a, 151b) can provide external circular magnetic fluxes (153bb) which can be associated with an external electric field (153ee). The pair of the primary/secondary conductors (151a, 151b) can provide internal and external condenser actions [e.g. in a form of self-capacitance and mutual capacitance with another primary/secondary (repeating) electromagnetic interface (not shown)].

FIG. 5 is a schematic diagram of another embodiment of the wireless electromagnetic energy transfer system. A primary/secondary electromagnetic interface (172) and a capacitive coupling interface (176) [which can include a coupling capacitor] can be coupled with a primary circuit (173) which can include an energy source (175) [which can include other electrocomponents/e.g. compensation circuits, switching circuits, sensing circuits, etc./] and with a secondary circuit (183) which can include a load (187) [which can include other electrocomponents/e.g. compensation circuits, sensing circuits, rechargeable power sources, etc./]. The primary/secondary electromagnetic interface (172) can be composed of a primary/secondary magnetic element (170), a primary conductor (171) and a secondary conductor (181) which can be at least partially mutually movable [e.g. vertically on the page] which can influence the electromagnetic energy transfer which can be sensed, etc. The primary and secondary circuits (173, 183) can include inductively coupled inductors (174, 184) in a hybrid electromagnetic-capacitive-inductive energy transfer system. The primary/secondary electromagnetic interface (172) can be provided with an insulation [e.g. an electrical and waterproof insulation] and the electromagnetical energy transfer can take place in a direct contact with a liquid.

FIG. 6 is a schematic diagram of another embodiment of the wireless electromagnetic energy transfer system. A primary/secondary magnetic element (190), a primary conductor (191) which can be disposed at least partially at about and in the primary/secondary magnetic element (190) and which can be coupled with a primary circuit (193) which can include primary electrocomponents (not shown) and a secondary conductor (201) which can be disposed at least partially at about and in the primary/secondary magnetic element (190) and which can be coupled with a secondary circuit (203) which can include secondary electrocomponents (not shown) can form a primary/secondary electromagnetic interface (192). An electric current flowing through one of the primary and secondary conductors (191, 201) can create one or more circular magnetic fluxes in the primary/secondary magnetic element (190) to generate electric current in another one of the primary and secondary conductors (191, 201). At least one of the primary conductors (191) and the secondary conductors (201) can be interrupted (not shown) to have first and second respective ends in the primary/secondary magnetic element (190) wherein the first and second respective ends can be spaced apart from each other to be able to transfer at least partially one or more circular magnetic fluxes.

FIG. 7 is a schematic diagram of another embodiment of the wireless electromagnetic energy transfer system. A primary magnetic element (210) [which can have any shape/e.g. flat/] and a primary conductor (211) [which can be coupled with nodes (216) and which can have enlarging elements/e.g. a ladder structure/and which can be disposed at least partially at about and in the primary magnetic element (210)] can form a primary electromagnetic interface (212) which can be coupled with a primary circuit (213) which can include the nodes (216) [which can couple other electrocomponents which can be inserted into the primary circuit (213)]. A secondary (repeating) electromagnetic interface can be provided analogically.

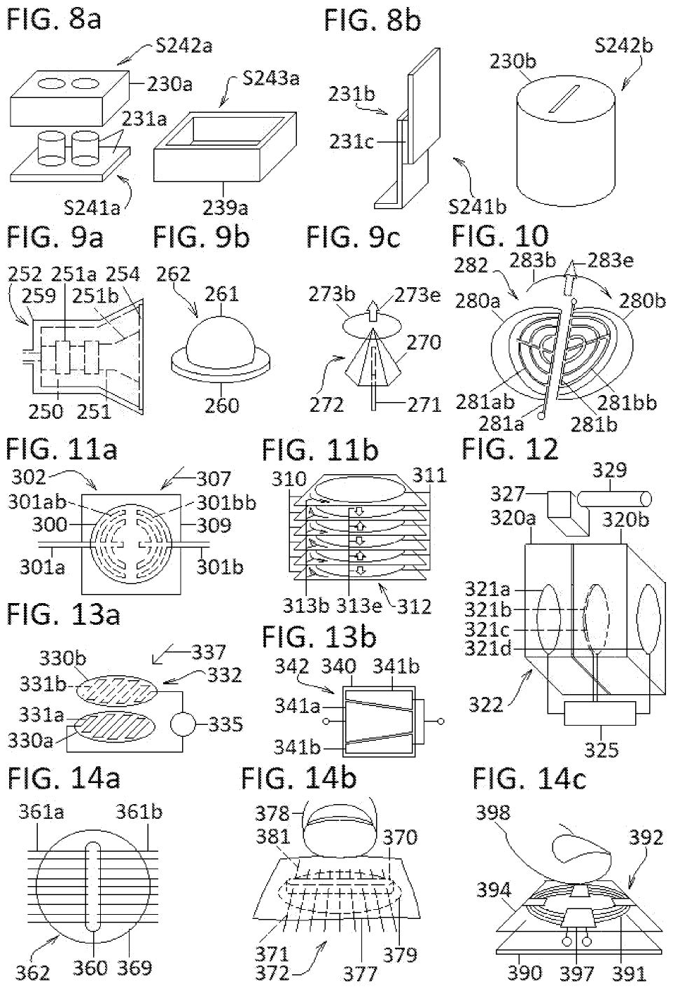

FIG. 8a is a schematic of a method to provide a wireless electromagnetic energy transfer interface which can comprise the steps of producing a set of one or more conductors (231a) to be disposed at least partially at about and in one or more magnetic elements (230a) to create at least partially or at least substantially one or more circular magnetic fluxes (S241a); and a step of coupling said set of one or more conductors (231a) with said one or more magnetic elements (230a) (S242a) wherein at least one of the steps (S241a, S242a) can use at least partially or at least substantially a technique, wherein at least one said technique can be selected from the group consisting of molding, casting, melting, pouring, thermoforming, sintering, compression forming, bending, vacuum techniques, cut-in-place techniques, machining, inserting, injecting, sealing, suffusion, spraying, mechanical connection, chemical bonding, thermal bonding, chemical deposition, lithography, photolithography, etching, laminating, printing, printed circuit board fabrications techniques, or combinations thereof. The method can further comprise a step of adding one or more shieldings (239a) to said one or more magnetic elements (230a) and/or to said one or more conductors (231a) to at least partially or at least substantially shield said one or more circular magnetic fluxes (S243a).

FIG. 8b is a schematic of another embodiment of the method to provide a wireless electromagnetic energy transfer interface which can comprise the steps of producing a set of one or more conductors (231b) to be disposed at least partially at about and in one or more magnetic elements (230b) to create at least partially or at least substantially one or more circular magnetic fluxes (S241b) wherein the conductors (231b) can provide condenser action [e.g. the conductors (231b) can be provided with a dielectric layer (231c)] and wherein the step (S241b) can use a technique [e.g. molding, casting, bending, cut-in-place, etc.]; and a step of coupling the conductors (231b) with the magnetic element (230b) using at least partially or at least substantially a technique [e.g. sintering, inserting, sealing, etc.] (S242b). The method can further comprise a step of adding one or more shieldings (not shown).

FIG. 9a is a schematic side view of another embodiment of the wireless electromagnetic energy transfer system. A primary magnetic element (250) and a primary conductor (251) [which can have enlarging cylindric elements (251a) and a conic element (251b)] can form a primary electromagnetic interface (252) which can be shielded with a shielding (259) and insulated with an insulation (254).

FIG. 9b is a schematic perspective view of another embodiment of the wireless electromagnetic energy transfer system. A primary magnetic element (260) [which can have 3D modelled coupling sides and an enlarging ring shape element and which can provide a lower reluctance path for circular magnetic fluxes] and a primary conductor (261) [which can be a hollow profile and which can have 3D modelled/e.g. constant radius dome shaped/coupling sides and have an enlarging (hemi) spherical surface (section) area element and which can provide external and internal electric fields] can form a primary electromagnetic interface (262). A secondary electromagnetic interface can be provided analogically and can couple from external or internal coupling sides from any position with regard to the primary magnetic element (260) [e.g. upper, lower, lateral, etc.]. The electromagnetic energy transfer can be sensed and either of the primary and secondary electromagnetic interfaces can be coupled with respective electrocomponents (not shown) [e.g. transmitters, receivers, sensing circuits, input or output terminals, conductors (leads, pins) etc.]. Either element (260, 261) can be transparent [similarly the respective secondary elements].

FIG. 9c is a schematic perspective view of another embodiment of the wireless electromagnetic energy transfer system. A primary magnetic element (270) [which can be pyramidally or conically shaped and which can provide a path for circular magnetic flux (273b) associated with an electric field (273e)] and a primary conductor (271) [which can be round shaped] can form a primary electromagnetic interface (272). [The shown embodiment can be provided in a (sensing) array which can include a shielding (not shown).]

FIG. 10 is a schematic perspective view of another embodiment of the wireless electromagnetic energy transfer system. Primary magnetic elements (280a, 280b) [which can make an angle and which can provide a return path for circular magnetic flux (283b) associated with an electric field (283e)] and primary conductors (281a, 281b) [which can be concentric shaped and which can have semicircular enlarging elements (281ab, 281bb)] can form a primary electromagnetic interface (282).

FIG. 11a is a schematic plan view of another embodiment of the wireless electromagnetic energy transfer system. A primary electromagnetic interface (302) can be formed of a primary magnetic element (300) [which can be provided in one or more pieces and which can have a flat shape and which can provide a path for circular magnetic fluxes (not shown)] and primary conductors (301a, 301b) [which can be provided at about and in the primary magnetic element (300) and spaced apart from each other so that the primary magnetic element(s) be able to transfer the circular magnetic fluxes and which can have branched enlarging elements (301ab, 301bb)]. The primary electromagnetic interface (302) can be shielded with a shielding (309) and can be magnetically coupled with a magnetocomponent (307) [which can be an external magnetic field, etc.] which can magnetically influence the provided circular magnetic fluxes created in the primary magnetic element (300) which can change parameters in the primary conductors (301a, 301b) which can be sensed with electrocomponents (not shown) [e.g. a sensing circuit]. Similarly for a system with secondary (repeating) elements. The shown embodiment can be used as an electromagnetic sensor, switch, wireless node, etc.

FIG. 11b is a schematic perspective view of another embodiment of the wireless electromagnetic energy transfer system. Primary/secondary magnetic elements (310) [which can have a form of layers] which can provide a path for internal circular magnetic fluxes (313b) which can be associated with internal electric fields (313e) between primary/secondary conductors (311) [which can be layers with various coupling nodes] which can form a layered primary/secondary electromagnetic interface (312) [which can further provide external electromagnetic fields (not shown)]. Different layers [which can be mutually insulated, provided with a dielectric, etc.] can function as primary/secondary/repeating elements which can be couplable in one or more primary/secondary/repeating circuits including electrocomponents [e.g. energy sources, loads, sensing circuits, compensations, etc.]. Each circuit can provide a different signal into the wireless node (312). Various working pairs (groups) can be provided. [The embodiment can provide a wireless node in one or more circuits, an electromagnetic storage element or an electromagnetic self-resonant (tunable) antenna wherein electric energy stored in primary/secondary conductor layers (311) can cycle energy with magnetic energy stored in primary/secondary magnetic element layers (310). Elements' parameters can be changeable (tunable) to achieve a balanced distribution between electric and magnetic components. Components can be shielded, insulated, transparent, translucent, can spring.]

FIG. 12 is a schematic oblique view of another embodiment of the wireless electromagnetic energy transfer system which can be used as an electromagnetic sensor (322). Primary/secondary magnetic elements (320a, 320b) and primary/secondary conductors (321a, 321b, 321c, 321d) [which can have enlarging elements/e.g. can form plates/] can form the electromagnetic sensor (322) which can be electrically coupled with a metering device (325) and magnetically coupled with a magnetocomponent (327) [which can be a high field strength permanent magnet, or a magnetic field assembly including hard and soft magnetic materials, etc.] to be sensed which can be attached to a carrier (329) [which can rotate/e.g. a shaft/or which can move in a left-right direction on the page within a defined stroke/e.g. a vehicle suspension/, etc., wherein the movement can affect the shape of provided circular magnetic fluxes and can be sensed].

FIG. 13a is a schematic oblique view of another embodiment of the wireless electromagnetic energy transfer system which can be used as an electromagnetic sensor (332) [and/or for wireless energy transfer] which can be formed of primary/secondary magnetic elements (330a, 330b) [which can be plates or layers of a magnetic material] and primary/secondary conductors (331a, 331b) [which can have enlarging elements/e.g. can form a meandering path/] which can be electrically coupled with a metering device (335) [or another electrocomponent]. The primary/secondary magnetic elements (330a, 330b) can be magnetically coupled with a magnetocomponent (337) [which can be an (electro) magnetic field, etc.] to be sensed. [The shown embodiment can be alternatively provided in primary and secondary circuits wherein the meandering path can have first and second coupling nodes which can be provided on opposite sides of a magnetic element, etc.]

FIG. 13b is a schematic plan view of another embodiment of the wireless electromagnetic energy transfer system which can be used as an electromagnetic sensor (342) [and/or in an onshore/offshore static/dynamic power transfer system providing a travelling electromagnetic field] which can be formed of a primary magnetic element (340) [which can be a slab of a magnetic material providing a lower reluctance path for circular magnetic fluxes (not shown)] and primary conductors (341a, 341b) [which can have trapezoidal enlarging elements and various coupling nodes] which can be electrically couplable with an electrocomponent (not shown) [which can be a metering device, a power source, an oscillator, a transmitter, etc.]. [The primary electromagnetic interface (342) can be coupled with a magnetocomponent (not shown) and can form a path/e.g. vertically on the page/which can be provided in the onshore/offshore static/dynamic power transfer system (e.g. similarly as shown in FIG. 16a) and a secondary electromagnetic interface can be provided analogically (e.g. similarly as shown in FIG. 16b).]

FIG. 14a is a schematic plan view of another embodiment of the wireless electromagnetic energy transfer system. A primary electromagnetic interface (362) [shown from a coupling side] can be formed of a primary magnetic element (360) [which can be provided in one piece as shown or in more elements] and primary conductors (361a, 361b) [which can be alternatively provided as a meandering path repeatedly passing through the primary magnetic element (360) and interrupted therein, or in other patterns] and can be shielded with a shielding (369) and coupled with electrocomponents (not shown) [e.g. current sensors which can be provided in circuits including processing units, etc.]. A secondary electromagnetic interface (not shown) can be provided similarly. An internal energy transfer using circular magnetic fluxes can be provided between primary conductors (361a and 361b) through the primary magnetic element (360). An external energy transfer can be provided between (among) primary and the secondary (repeating) electromagnetic interfaces through the primary magnetic element (360) and respective secondary (repeating) magnetic elements (not shown). The shown embodiment can be used for power transfer, signal transfer (in communication, sensing circuits, etc.) [e.g. each of primary (pairs of) conductors (361a, 361b) can be provided in a different (sensing) circuit, electrocomponents (e.g. a current sensors) can sense currents in different primary conductors (361a, 361b) and can provide an information to a processor which can convert measured values to position coordinates]. The primary electromagnetic interface (362) (and/or the secondary (repeating) electromagnetic interface) can be coupled with a magnetocomponent [which can be a layer from magnetic material as shown in FIGS. 14b, 14c or a (static or dynamic) magnetic field which can influence the circular magnetic fluxes created in the primary magnetic element (360) which can change parameters in the primary conductors (361a, 361b) which can be sensed/similarly for a system with the secondary (repeating) elements/. The shown embodiment can be used as a position sensor, orientation sensor, angular rotation sensor, an electromagnetic field sensor, electromagnetic (multi) switch, etc., the sensors can be provided in a sense array which can form a matrix. The sensors can support multi-touch and operate as all-points-addressable (APA) mutual sense array, can be ranged in patterns (e.g. rows and columns, etc.), can be provided with layers (e.g. insulation, etc.), the respective magnetic elements can be divided into subsections, etc. The shown elements can have different shapes, various dimensions, etc., can be used in sensing pads, screens, buttons, etc.]. All elements of the shown embodiment can be flexible and transparent (translucid), can be posed in front of an electro-optical device/e.g. a panel, a screen/, can form arrays, matrices, and can have different forms and shapes.

FIG. 14b is a schematic perspective view of another embodiment of the wireless electromagnetic energy transfer system used as an electromagnetic touch sensor (372) which can be formed of a primary/secondary magnetic element (370) [which can be provided in one piece as shown or in more elements spaced apart from each other to be able to transfer circular magnetic fluxes and which can have slots to receive an interrupting magnetocomponent, etc.] and primary conductors (371) and secondary conductors (381) which can be disposed under a magnetocomponent (377) [which can be a magnetic layer which can be of a hard (and/or soft) magnetic material and which can be touched with a touch object/e.g. a stylus tip, a finger (378), etc./. Touching can disturb circular magnetic fluxes created in the primary/secondary magnetic element (370) and thus wireless energy transfer provided according to the principle of the invention which can be sensed in one or more primary circuits (not shown) or primary and secondary circuits, etc. The magnetic layer (377) can spring to prevent accidental/inaccurate sensing/switching or a flexible spacer can be used, etc.]. The primary and secondary conductors (371, 381) can be electrically couplable with electrocomponents (not shown) [e.g. (integrated) circuits, oscillators, voltage and current sensors, processing units which can be provided with position and force data and which can include memory and which can be programmed to sense multi-touch i.e. interruptions or parameter changes of a possible plurality of primary/secondary conductors (371, 381) circuits].

The sensor (372) can be shielded with a shielding (379) [which can support the sensing function]. [All elements of the shown embodiment can be flexible and transparent (translucid), can be posed in front of an electro-optical device/e.g. a panel, a screen/, can form arrays, matrices, and can have different forms and shapes/e.g. to provide a touch sensor slider which can slide from one to the other side of the page/.]

FIG. 14c is a variant of a sensor shown in FIG. 14b. An electromagnetic touch sensor (392) which can be formed of a primary/secondary magnetic element (390) [which can be provided in one piece as shown or in more elements] and primary/secondary conductors (391) which can be interrupted at about or in the primary/secondary magnetic element (390) (similarly as shown in FIG. 14a) and disposed under a magnetocomponent (397) [which can be a magnetic layer] which can be provided on a substrate (394) [which can be transparent, flexible, etc. which can be touched with a touch object/e.g. a stylus tip, a finger (398), etc./and which can function as an insulation/e.g. dust, electric, waterproof, etc/]. The touch sensor (392) can be couplable with an electrocomponent (not shown) [e.g. a sensing circuit].

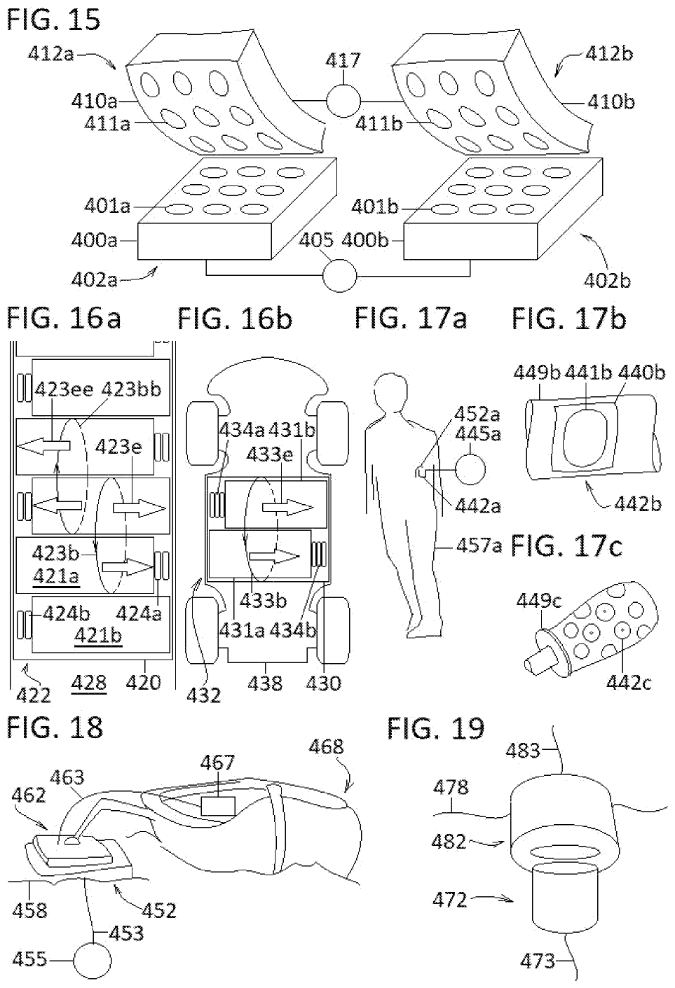

FIG. 15 is a schematic oblique view of the wireless electromagnetic energy transfer system. Primary magnetic elements (400a, 400b) and primary conductors (401a, 401b) can form primary electromagnetic interfaces (402a, 402b) forming working pairs which can be couplable with an engineering construction (not shown). Secondary (or repeating) magnetic elements (410a, 410b) and secondary (or repeating) conductors (411a, 411b) can form secondary (or repeating) electromagnetic interfaces (412a, 412b) forming working pairs which can be flexible and couplable with an electric vehicle component [e.g. tires, wheels, body/chassis] (not shown) can have various shapes [e.g. together with primary components can be prolongated in a direction of a movement of the electric vehicle, etc.]. The primary conductors (401a, 401b) disposed in the primary magnetic elements (400a, 400b) can be coupled with an electrocomponent (405) [which can be a transmitter, etc.]. Secondary (repeating) conductors (411a, 411b) disposed in the secondary magnetic elements (410a, 410b) can be coupled with an electrocomponent (417) [which can be a receiver (transceiver), etc.].

FIG. 16a is a schematic oblique plan view of another embodiment of the wireless electromagnetic energy transfer system provided in an onshore static/dynamic power transfer system. A primary magnetic element (420) and primary conductors (421a, 421b) [which can form a momentary working pair and which can provide circular magnetic fluxes (423b, 423bb) associated with electric fields (423e, 423ee) (shown in consequent phases following a possible movement of an electric vehicle in dynamic charging)] which can be coupled with compensation inductors (424a, 424b) can form a primary electromagnetic interface (422) which can provide a travelling electromagnetic field and which can be coupled with a defined power source (not shown) [e.g. a static/dynamic charging station which can include a controller with a switching bank to follow in constantly changing temporary working pairs the movement of a vehicle to be charged (e.g. as shown in FIG. 16b) and coupled with sensing circuits including sensors, targets, etc.] and with an engineering construction (428) [e.g. an open ground lane/a road/, a naval construction/a charging vessel's deck/, etc.] wherein various portions [e.g. width, length portions of a traffic lane] can be provided for the electromagnetic energy transfer.

FIG. 16b is a schematic oblique plan view of another embodiment of the wireless electromagnetic energy transfer system provided in an onshore static/dynamic power transfer system. A secondary magnetic element (430) and secondary conductors (431a, 431b) [which can form a working pair and which can provide circular magnetic fluxes (433b) associated with electric fields (433e)] which can be coupled with compensation inductors (434a, 434b) can form a secondary electromagnetic interface (432) which can be coupled with an electrocomponent (not shown) [e.g. a source management system] and an electric vehicle component [e.g. a lower part of a body/chassis (438)].

FIG. 17a is a schematic view of the wireless electromagnetic energy transfer system with a primary electromagnetic interface (442a) coupled with a medical power source (445a) [which can be an external source] and a secondary electromagnetic interface (452a) coupled with a living body (457a) [which can be a human or animal body and which can contain e.g. a cardiostimulator implantation, a mechanical circulatory assist device which can contain a pump implantation, a rechargeable power source implantation, hearing aids, etc.]. The primary and secondary electromagnetic interfaces (442a, 452a) can be shielded and insulated (not shown) [e.g. with a magnetic, medical insulation, etc.]. [Medical devices transferring power through human tissue can use high frequencies of hundreds of MHz with low power transfer and series L compensations, a primary electromagnetic interface can be intergrated in medical applications to a piece of clothes, furniture, may be strapped on a patient's body, a wheelchair, etc.]

FIG. 17b is a schematic view of another embodiment of the wireless electromagnetic energy transfer system with primary/secondary conductors (only upper 441b shown) [which can have any shape/e.g. squared/and which can be flexible and which can form a working pair in a stacked monopolar configuration or an adjacent bipolar configuration wherein the conductors can form at least one working pair of in-plane adjacent primary conductors/e.g. as shown in FIG. 17c/] and a primary/secondary magnetic element (440b) [which can be flexible and which can be divided into subsections, e.g. layers and/or in-plane subsections and which can be provided from a back side of the primary/secondary conductors (441b shown) and/or can be provided in a form of a magnetic gel, magnetic phase change gel which can be provided in a container/e.g. a sealed pouch/which can be couplable with or contain the primary/secondary conductors; the magnetic gels can be provided also from frontal coupling side of the primary/secondary conductors (441b shown) and/or lateral sides] which can form a primary/secondary electromagnetic interface (442b) which can be coupled or couplable with a medical power source (not shown) [which can be an internal and/or external source] and a sheath (449b) [which can provide electromagnetic shielding, insulation/e.g. thermal/and which can provide thermal therapy [e.g. contain, be coupled, cover, etc. thermal gel packets/e.g. glycol and water based gels, magnetic gels, magnetic phase change gels, etc./, or provide other kind of thermal management/which can be passive (ice) or active (e.g. using tempering systems)]. The sheath can be elastic, pliable, stretchable, etc. and provide compress to a tissue part (e.g. human skin) where to be applied. A provided circular magnetic flux density can be defined (e.g. from about 100 gauss to about 5000 gauss or other). The shown embodiment can be combined with flexible, non-flexible magnets, sheaths (or other substrates), attachment mechanisms (hook-and-loop materials, buckles, etc.), fabric coverings (e.g. exterior fabric which can be made of Neoprene, Tricot and interior temperature conductive fabric), etc. The shown exemplary embodiment can be used for human and animal treatment. The primary/secondary electromagnetic interface (442b) can be further coupled with a magnetocomponent [e.g. a permanent magnet, a magnetic field, etc.].

FIG. 17c is a schematic view of the wireless electromagnetic energy transfer system with primary electromagnetic interfaces (442c) which can form working pairs (poles) and which can be provided as a therapeutic aid (449c) [e.g. a handlebar grip, tool handle, palm exercise aid, etc.] which can be coupled with a medical power source (not shown) [which can be an internal or external source which can be wirelessly chargeable, etc.] and couplable with a living body (not shown) [which can be a human palm for magnetic therapy].

FIG. 18 is a schematic perspective view of the wireless electromagnetic energy transfer system provided in an offshore static power transfer system. Primary magnetic elements and primary conductors can form a buoyant primary electromagnetic interface (452) [which can include a watertight insulation] which can be coupled with a conductor (453) [which can be a submarine cable] with an offshore power source (455) [e.g. an offshore charging station]. Secondary magnetic elements and secondary conductors can form a secondary electromagnetic interface (462) [which can include a waterproof insulation] which can be coupled with a conductor (463) [which can be a marine cable] with a source management system (467) [which can be coupled with a rechargeable power source] coupled with an offshore vessel (468) [which can be an electric ship]. The wireless electromagnetic energy transfer can take place in a direct contact with fresh water (458) [or sea water]. The system can be configured to provide bidirectional energy flow and wireless data transmission and to further comprise a repeating power transfer interface (not shown).

FIG. 19 is a schematic perspective view of the wireless electromagnetic energy transfer system provided in an offshore underwater static power transfer system. A primary magnetic element [which can have a planar frontal coupling side and a lateral coupling side] and a primary conductor can form a primary electromagnetic interface (472) [which can include a watertight insulation] which can be coupled with a marine cable (473) with an offshore power source (not shown). A secondary magnetic element [which can have a planar frontal coupling side and a lateral coupling side] and a secondary conductor can form a secondary electromagnetic interface (482) [which can include a watertight insulation] which can be coupled with a marine cable (483) with an offshore vessel (not shown) [which can be a vessel including an offshore hydrogen production unit]. The wireless electromagnetic energy transfer can take place in a direct contact with fresh water (478) [or sea water]. The primary electromagnetic interface (472) and the secondary electromagnetic interface (482) can be configured to enable a relative mutual movement which can be rotational and/or axial.

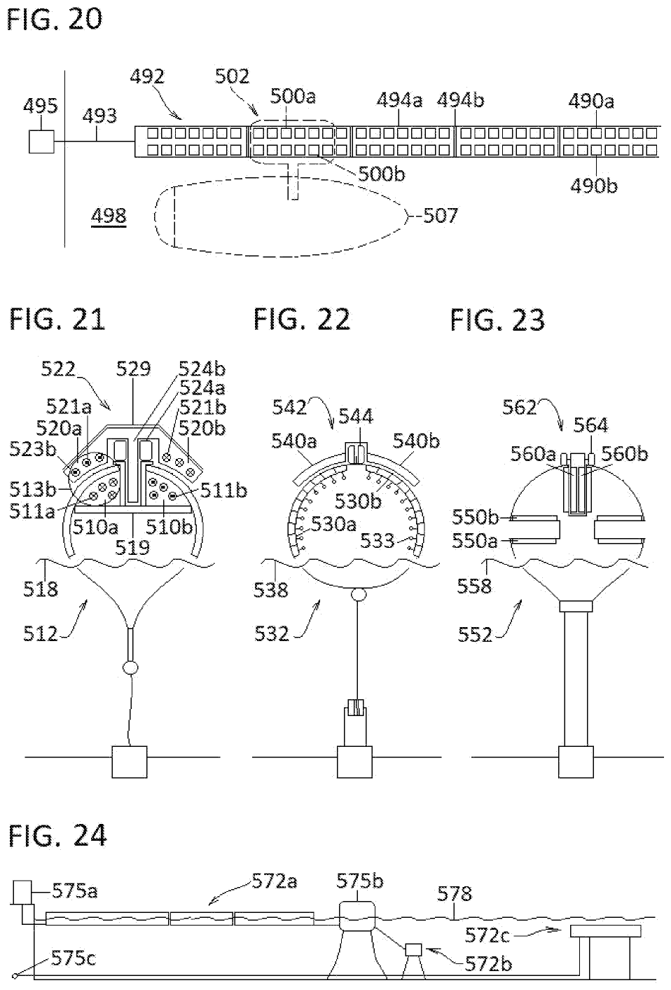

FIG. 20 is a schematic plan view of the wireless electromagnetic energy transfer system provided in an offshore static/dynamic power transfer system. Primary magnetic elements (490a, 490b) [which can form working pairs/e.g. of the upper and lower row on the page/] and primary conductors (not shown) can form a primary electromagnetic interface (492) [which can be a buoyant offshore power transfer interface provided at about water level (498)] which can include power transfer sections (494a) and connections (494b) [which can be any type of permanent or detachable mechanical, hydraulical, electromagnetical, power, electrical, electronical, nonflexible or flexible connections which can follow wave movements]. The primary electromagnetic interface (492) can be coupled with a marine cable (493) with a defined power source (495) [which can be an onshore smart power grid, etc.]. Secondary magnetic elements (500a, 500b) [which can form analogical working pairs] and secondary conductors can form a secondary electromagnetic interface (502) (shown in phantom broken lines) [which can be buoyant, level adjustable, mobile and provided at about water level (498)] which can be coupled with an offshore vessel (507) (shown in phantom) [which can include a rechargeable power source, an electric motor, etc.].

FIG. 21 is a schematic sectional view of another embodiment of the wireless electromagnetic energy transfer system provided in an offshore static/dynamic power transfer system. Primary magnetic elements (510a, 510b) [which can form primary transversally working pairs and which can have a planar/e.g. cylindrical/frontal coupling side and which can provide a path for primary circular magnetic fluxes (513b) (only one shown) which can be associated with a primary electric field/which can be directed out of the page or into the page/travelling along wires (511a, 511b)] and primary conductors (511a, 511b) [which can have any pattern and which can be 180° out of phase/e.g. can form (horizontal and/or vertical) closed loops//e.g. in various power transfer sections//or can be provided in a circuit similar as shown in FIG. 121/] can form a primary electromagnetic interface (512) [which can be an anchored buoyant offshore power transfer interface provided at about water level (518)] which can be shielded with a shielding (519) [any type, shape, direction of a convenient shielding can be provided] and which can be coupled with a defined power source (not shown) [which can be an onshore power grid, etc.]. Secondary magnetic elements (520a, 520b) [which can form secondary transversally working pairs and which can have a planar/e.g. cylindrical/frontal coupling side and which can provide a path for a secondary circular magnetic flux (523b)] and secondary conductors (521a, 521b) [which can be similarly 180° out of phase and provided in an analogical setting and circuitry] can form a secondary electromagnetic interface (522) [which can be nonbuoyant, mobile, e.g. comprise a propelling unit which can be coupled with wheels (524a) and a guiding mean in a slot (524b), etc.] which can be shielded with a shielding (529) and which can be (wiredly or wirelessly) couplable with an offshore vessel (not shown). [Primary/secondary/repeating conductors can be of any number, type, cross section, shapes, etc. and primary/secondary/repeating magnetic elements can be provided as backing plates, can conveniently surround the primary/secondary/repeating conductors and guide, shield, etc., the provided primary and secondary electromagnetic fields (not shown).]

FIG. 22 is a schematic sectional view of another embodiment of the wireless electromagnetic energy transfer system provided in an offshore static/dynamic power transfer system. Primary magnetic elements (530a, 530b) [which can form transversally working pairs (groups) and which can be divided into individually switchable subsections] and primary conductors (not shown) can form a primary electromagnetic interface (532) [which can be an anchored buoyant level adjustable offshore power transfer interface provided at about water level (538) and/or under water level] which can be coupled with power lines (533) [which can be coupled with data lines which can form matrices having intersections and including a switching network to switch the individually switchable power transfer subsections] with a defined power source (not shown) [which can be an offshore charging station, etc.]. Secondary magnetic elements (540a, 540b) [which can form transversally working pairs] and secondary conductors (not shown) can form a secondary electromagnetic interface (542) [which can be nonbuoyant, mobile/e.g. coupled with guiding wheels (544), etc./and which can be of a different size in according to considered performance to couple with a different number of the switchable subsections] which can be couplable with an offshore vessel (not shown).

FIG. 23 is a schematic sectional view of another embodiment of the wireless electromagnetic energy transfer system provided in an offshore static/dynamic power transfer system. Primary magnetic elements (550a, 550b) [which can form transversally working pairs which can be horizontal, vertical or of any other direction] and primary conductors (not shown) can form primary electromagnetic interface (552) [which can be a nonbuoyant supported offshore power transfer interface provided at about water level (558)] which can be coupled with a defined power source (not shown). Secondary magnetic elements (560a, 560b) [which can form transversally working pairs] and secondary conductors (not shown) can form a secondary electromagnetic interface (562) [which can be nonbuoyant, mobile/e.g. coupled with wheels (564), etc./] which can be couplable with an offshore vessel (not shown).

FIG. 24 is a schematic side view of another embodiment of the wireless electromagnetic energy transfer system provided in an offshore static/dynamic power transfer system including an underwater power transfer system. Primary magnetic elements and primary conductors can form a primary electromagnetic interface (572a) [which can be a buoyant offshore power transfer interface provided at about water level (578) providing static/dynamic power transfer] which can be coupled with a defined power source (575a) [which can be an onshore electric energy generator, etc.] and with a defined power source (575b) [which can be an offshore array of solar cells/a solar cell module, a solar cell system/, etc.], with a primary electromagnetic interface (572b) [which can be an anchored buoyant offshore power transfer interface provided under water level (578) providing static power transfer] which can be coupled with the offshore power source (575b) and with a primary electromagnetic interface (572c) [which can be a nonbuoyant supported offshore power transfer interface provided under water level (578) providing static/dynamic power transfer] which can be coupled with a defined power source (575c) [which can be an onshore smart grid, etc.]. Secondary (repeating) magnetic elements and secondary conductors can form secondary electromagnetic interfaces which can be coupled with offshore vessels (not shown).

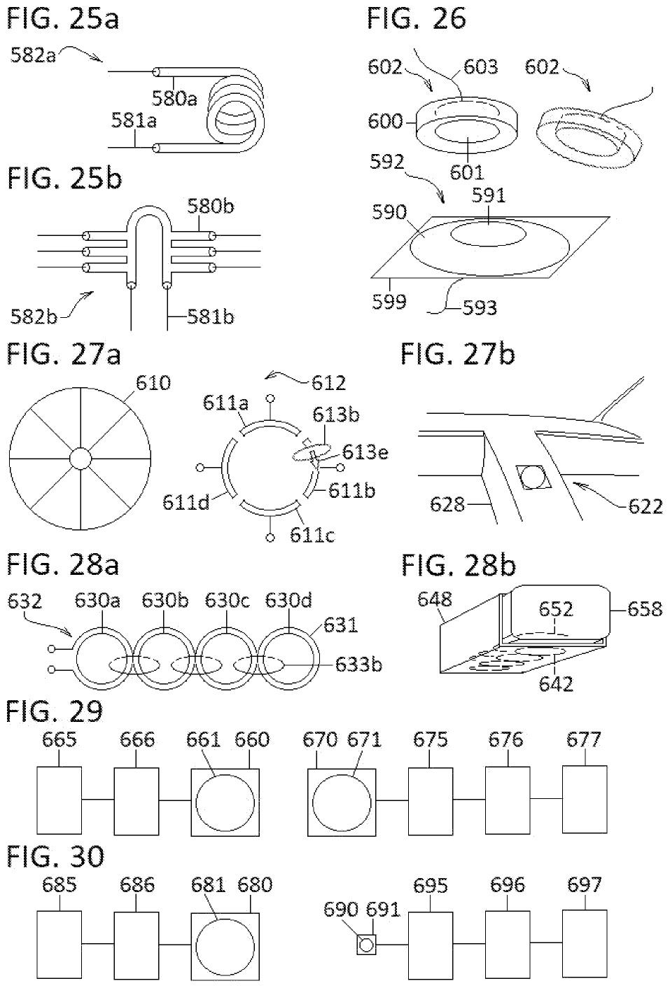

FIG. 25a is a schematic oblique view of the wireless electromagnetic energy transfer system. A primary magnetic element (580a) [which can provide (at least partially) a low reluctance path for circular magnetic fluxes and which can be flexible, transparent, fabricated of a magnetic polymer/e.g. containing magnetic particles/, ferrites, a magnetic rubber/e.g. including a rubber, a thermosetting resin and a magnetic powder/, etc.] and a primary conductor (581a) can form a primary electromagnetic interface (582a) [which can include another magnetic element (not shown) e.g. a ferrite, magnetic metal core element/e.g. circular, circular striated, square, rectangular, T-core, U-core, E-core, Double U, striated blocks, etc./] which can be couplable with an electrocomponent (not shown) [e.g. a power source, a signal source, etc.]. A secondary (repeating) electromagnetic interface (electromagnetic coil with one or more turns) can be provided analogically. [The electromagnetic coils provided in the proposed electromagnetic energy transfer system can be provided in various shapes, can form long coils with a number of close or spaced turns, flat coils with a number of close or spaced turns, etc. The electromagnetic coils can be provided with an insulation/e.g. electrical/.] The proposed electromagnetic coils can be used in improved solenoids, lifting electromagnet devices, wireless power transfer devices, etc.

FIG. 25b is a schematic oblique view of the wireless electromagnetic energy transfer system. A primary magnetic element (580b) and a primary conductor (581b) can form a primary electromagnetic interface (582b) [which can be provided in different shapes, forms, variants, circuits, circuit components, etc.] which can be couplable with electrocomponents (not shown). A secondary (repeating) electromagnetic interface can be provided analogically.

FIG. 26 is a schematic oblique view of an example of shaping primary/secondary magnetic elements and primary/secondary conductors into curved planes. A primary magnetic element (590) [which can have a convex frontal coupling side] and a primary conductor (591) [which can have a convex and planar frontal coupling side] can form a primary electromagnetic interface (592) which can be shielded from a back side with a shielding (599) [which can be a metallic plate] and which can be coupled with a power cable (593) to be couplable with an energy source (not shown). A secondary magnetic element (600) [which can have a concave frontal coupling side] and a secondary conductor (601) [which can have a concave and planar frontal coupling side] can form a secondary electromagnetic interface (602) [which can be laterally and angularly misaligned] which can be coupled with a power cable (603) to be couplable with a load (not shown).

FIG. 27a is a schematic exploded oblique plan view of another embodiment of the wireless electromagnetic energy transfer system. A primary magnetic element (610) [which can be a one-piece structure or a multipiece structure including mutually (magnetically) insulated subsections] and primary conductors (611a, 611b, 611c, 611d) [which can be of (curved) plates with (central) coupling nodes and providing circular magnetic fluxes (613b) associated with an electric field (613e) (only in one section shown) and wherein the ranges of lengths can be determined based on calculating a quarter wavelength of the desired resonance frequency] can form [e.g. by superposing] a primary electromagnetic interface (612) which can be shielded with a shielding (not shown). The primary conductors (611a, 611b, 611c, 611d) can be coupled with an electrocomponent (not shown) [e.g. a radio frequency energy source providing (first and second) excitation signals/which can be the same, 90°, 180° out of phase/, a phasing line, a switching bank configured to individually switch the primary conductors (611a, 611b, 611c, 611d) in various working (groups) pairs, etc.]. A secondary electromagnetic interface (not shown) can be provided in a similar way and coupled with convenient electrocomponents [e.g. a receiver, transceiver, etc.].

FIG. 27b is a schematic perspective view of another embodiment of the wireless electromagnetic energy transfer system. A primary electromagnetic interface (622) (which can be similar as shown in FIG. 27a) can be provided in an electronic (power) device [e.g. a charging pad, an electronic portable device, an electric vehicle dash-board (628), etc.]. A secondary/repeating electromagnetic interface provided in another electronic (power) device [e.g. a consumers electronics] can be provided analogically. The primary and secondary (repeating) devices can support an angular, lateral misalignment (offset) in the system providing the electromagnetic field including circular magnetic fluxes (not shown). The primary and secondary (repeating) electromagnetic interfaces coupling sides can be preferably parallel but the system can support other positions up to perpendicular ones for an effective electromagnetic energy transfer.

FIG. 28a is a schematic oblique view of another embodiment of the wireless electromagnetic energy transfer system. Primary/secondary/repeating magnetic elements (630a, 630b, 630c, 630d) [which can be provided in different numbers, shapes and constellations] and a primary/secondary/repeating conductor (631) [which can be cross wound/in same or various numbers of turns/around the primary/secondary/repeating magnetic elements (630a, 630b, 630c, 630d)] can form a primary/secondary/repeating electromagnetic interface (632) [which can provide circular magnetic fluxes (633b) and which can be shielded with a shielding (not shown) and which can be couplable with an electrocomponent (not shown).

FIG. 28b is a schematic oblique view of another embodiment of the wireless electromagnetic energy transfer system. A primary electromagnetic interface (642) (which can be similar as shown in FIG. 28a) can be provided in an electronic (power) device (648) [e.g. a wireless electromagnetic (charging) power transfer socket, a communication interface, etc.]. A secondary/repeating electromagnetic interface (652) can be analogically provided in another electronic (power) device (658) [which can form a compatible plug].

FIG. 29 is a block diagram of the wireless electromagnetic energy transfer system with primary and secondary conductors coupled with electrocomponents. A primary conductor (661) disposed in a primary magnetic element (660) can be coupled with an energy source (665) which can be coupled with an inverter (666). A secondary conductor (671) disposed in a secondary magnetic element (670) can be coupled with a load (677) which can be coupled with a filter (676) which can be coupled with a rectifier (675). [The primary and secondary circuits can further include other electrocomponents such as power factor corrections, DC-DC converters, voltage regulations, clocks, etc., which can be switchable, controllable, etc.]

FIG. 30 is a block diagram of another embodiment of the wireless electromagnetic energy transfer system with primary and secondary conductors coupled with electrocomponents. A primary conductor (681) disposed in a primary magnetic element (680) can be coupled with an energy source (685) [which can be an input power driven oscillator configured to generate an adjustable desired frequency and coupled with a controllable power amplifier] which can be coupled with a compensation (686) [which can include a filter to filter out unwanted frequencies and matching circuit which can include a capacitor and an inductor in various topologies including topologies for combined power transfer systems (e.g. electromagnetic with inductive, or electromagnetic with capacitive, etc.]. A secondary conductor (691) disposed in a secondary magnetic element (690) can be coupled with a load (697) [which can be a DC rechargeable power source] which can be coupled with a rectifier (696) [which can include a switching circuit] which can be coupled with a compensation (695) [which can include a capacitor and an inductor in various topologies, including the combined topologies, e.g. electromagnetic with magnetodynamic, etc.].

FIG. 31 is a schematic oblique view of the wireless electromagnetic energy transfer system. Primary magnetic elements (700a, 700b) [which can form a primary working pair which can be spaced apart by an air gap and which can have planar frontal coupling sides] and primary conductors (701a, 701b) [which can have planar frontal coupling sides] can form a primary electromagnetic interface (702). The primary conductors (701a, 701b) can be coupled with an energy source (705). The primary magnetic elements (700a, 700b) and the primary conductors (701a, 701b) can be shielded from back and lateral sides by a shielding (709) [which can be a shaped/e.g. casted, folded, machined, etc./metallic plate/e.g. aluminium plate/]. A secondary electromagnetic interface with secondary elements and coupled with a load can be provided similarly. The primary electromagnetic interface (702) can be provided in a charging pad and the secondary electromagnetic interface can be provided in an electronic device. [The shown embodiment can also represent a printed circuit board (PCB) energy transfer interface.]

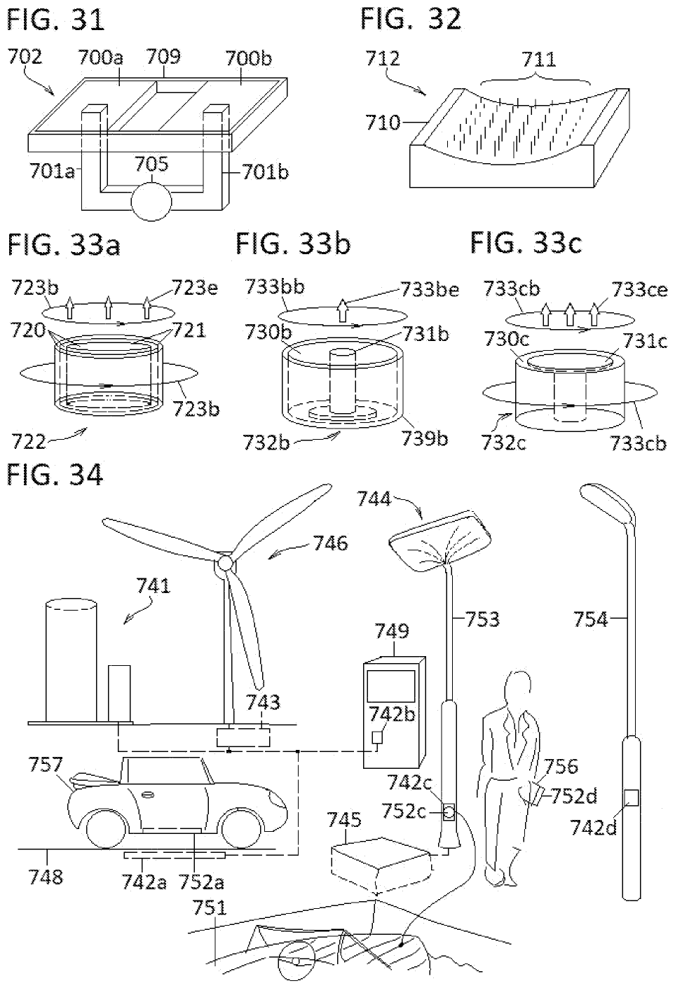

FIG. 32 is a schematic perspective view of the wireless electromagnetic energy transfer system. A primary magnetic element (710) [which can have a planar coupling side/e.g. of a cylindrical surface/] and primary conductors (711) [which can be disposed in and to a different extent at least partially about the primary magnetic element's (710) coupling side] can form a primary electromagnetic interface (712) which can be couplable with an electrocomponent (not shown) [e.g. a metering device, sensing circuits, voltage and current sensors, etc.]. A secondary electromagnetic interface with secondary elements and couplable with another electrocomponent [e.g. a circuit to be sensed] can be provided analogically. [The primary/secondary electromagnetic interfaces can be coupled with magnetocomponents/e.g. an electromagnetic field which can be provided by another electromagnetic interface or in any other way and which can be sensed/strength, direction, position, etc./.] Various variants of the shown embodiment can be contemplated.

FIG. 33a is a schematic oblique view of another embodiment of the wireless electromagnetic system. A primary/secondary (repeating) magnetic element (720) [which can have planar frontal and/or lateral coupling sides and which can be composed of one or more coaxial cylinders (as shown) or parallel layers or otherwise subdivided into mutually insulated, separated, etc. subsections, layers, etc. or other concentric electrode types, shapes and forms can be used that can distribute the voltage homogenously across the active area and which can be provided with a central hollow space (not shown) to provide a socket] and a primary/secondary (repeating) conductor (721) [which can have planar frontal and/or lateral coupling sides and which can be composed of interconnected coaxial cylinders or other types, shapes, etc.] can form a primary/secondary (repeating) electromagnetic interface (722) [whose dimensions can be expressed in terms of wavelengths/e.g. one wavelength, multiple wavelengths, fractions, etc.] which can produce an electromagnetic field with electric field lines (723e) and circular magnetic flux lines (723b) (shown in a simplified way).

FIG. 33b is a schematic oblique view of another embodiment of the wireless electromagnetic system. A primary/secondary (repeating) magnetic element (730b) [which can have a planar frontal coupling side] and a primary/secondary (repeating) conductor (731b) [which can have a planar frontal coupling side and which can be composed of a T conductive rod] can form a primary/secondary (repeating) electromagnetic interface (732b) which can be shielded from the back and lateral sides with a shielding (739b) and which can produce an electromagnetic field with electric field lines (733be) and circular magnetic flux lines (733bb).

FIG. 33c is a schematic oblique view of a variant of the wireless electromagnetic energy transfer system shown in FIG. 33b. A primary/secondary (repeating) magnetic element (730c) [which can have a planar frontal coupling side] and a primary/secondary (repeating) conductor (731c) [which can have a planar frontal coupling side and which can be composed of a T conductive rod with a capacitive enlargement] can form a primary/secondary (repeating) electromagnetic interface (732c) which can produce an electromagnetic field with electric field lines (733ce) and circular magnetic flux lines (733cb).

FIG. 34 is a schematic perspective view of the wireless electromagnetic energy transfer system with primary conductors (not shown) coupled with electrocomponents which can be a hydrogen power unit providing fuel cells (741), a wind energy to electric energy converter (746), a rechargeable power source (743) [which can provide power storage for the wind energy converter (746) and which can include rechargeable batteries], an array of solar cells (744) [which can be a solar panel], a rechargeable power source (745) [which can be an electric vehicle or offshore vessel swappable battery and/or which can provide power storage for the solar system and which can include a hybrid source including rechargeable batteries and capacitors and/or electromagnetic storage elements in according to the present invention (e.g. as shown in FIG. 11b)].

The primary conductors and primary magnetic elements (not shown) can form primary electromagnetic interfaces (742a) [which can be an electric vehicle charging interface and which can be coupled with an engineering construction (748)/e.g. an open ground lane, e.g. a parking place/], (742b) [which can be an electric vehicle charging interface and which can be provided at a vending machine box (749)], (742c) [which can be a wireless shore connection for maritime vessels (751) and which can be provided in a column (753) supporting the solar panel (744)], (742d) [which can be a wireless charging interface for portable electronic devices and which can be provided at a lamp post (754) coupled with a grid (not shown)]. Secondary conductors (not shown) and secondary magnetic elements (not shown) can form secondary electromagnetic interfaces (752a) [which can be a power transfer interface of an electric vehicle (757) which can be coupled with an electrocomponent/e.g. a source management system, a rechargeable power source/e.g. a high voltage battery/, an electric motor (not shown), etc./], (752c) [which can be a power transfer interface of the maritime vessel (751) which can be coupled with an input device, a source management system, a rechargeable power source/e.g. a high voltage and/or a start/accessories battery/(not shown)], (752d) [which can be a power transfer interface of a portable electronic device (756)/e.g. of a smartphone/]. [The primary electromagnetic interfaces can be provided at urban furniture/e.g. the lamp posts (754), street benches, bus stops, telephone boxes, etc., at dedicated constructions/e.g. charging stands, vending machine boxes (749)/, engineering constructions/building walls, pillars, piers, quays, platforms, etc./].

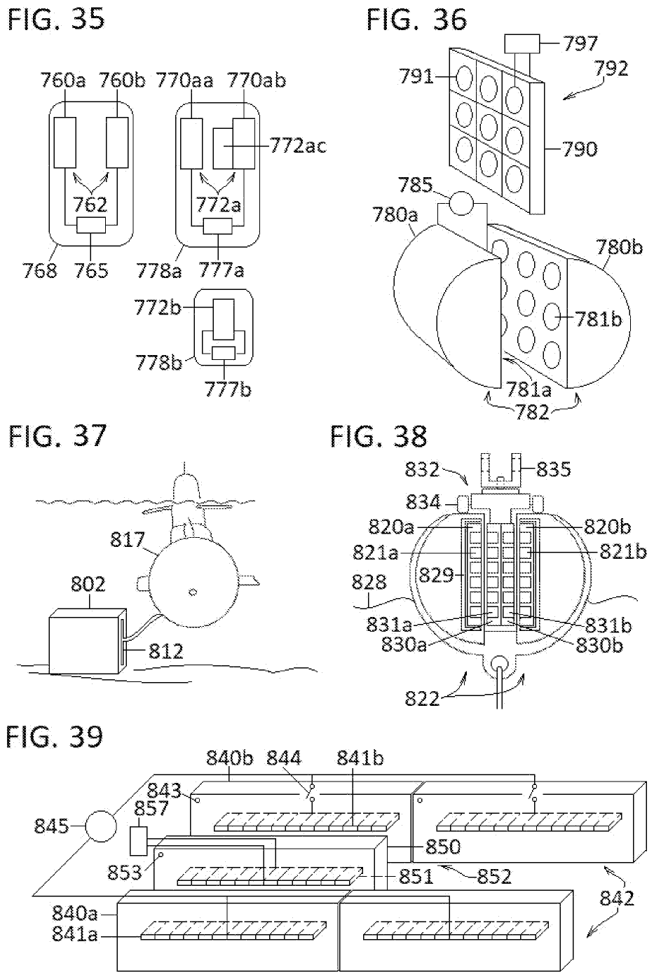

FIG. 35 is a schematic plan view of another embodiment of the wireless electromagnetic energy transfer system. Primary magnetic elements (760a, 760b) [which can form a primary working pair] and primary conductors (not shown) can form a primary electromagnetic interface (762) which can be coupled with an energy source (765) [which can have a defined frequency]. The primary electromagnetic interface (762) can be shielded, insulated (not shown) and provided in a primary device (768) [which can be a transmitter box, a charging pad, etc.]. Secondary magnetic elements (770aa, 770ab) [which can form a secondary working pair] and secondary conductors (not shown) can form a secondary electromagnetic interface (772a) which can be coupled with an electrocomponent (777a) [which can be an input device of a load (778a) which can be a portable electronics device, etc.]. The secondary electromagnetic interface (772a) can be shielded, insulated (not shown) and provided in the secondary device (778a) [which can serve as a transceiver] which can further include a repeating electromagnetic interface (772ac) which can comprise a (parasitic) repeating magnetic element and a (parasitic) repeating conductor (not shown) [which can provide condenser action and which can be coupled with an inductor (not shown) to form a resonant tank (antenna) which can extend the energy transfer/e.g. from proximity to vicinity/]. The repeating electromagnetic interface (772ac) can transfer electromagnetic energy to another load (778b) [which can be a rechargeable battery pack, a portable electronics, etc.] which can include another secondary electromagnetic interface (772b) [which can include a secondary magnetic element and secondary conductors (not shown)] which can be coupled with an electrocomponent (777b) [which can be a battery management system, an input device, etc.].

FIG. 36 is a schematic oblique view of another embodiment of the wireless electromagnetic energy transfer system. Primary magnetic elements (780a, 780b) [which can have planar frontal coupling sides and which can form a primary working pair] and primary conductors (781a, 781b) [which can have planar frontal coupling sides] can form a primary electromagnetic interface (782) which can be shielded and insulated (not shown) and which can be coupled with an energy source (785). The primary magnetic elements (780a, 780b) and the primary conductors (781a, 781b) can be shielded and insulated (not shown). A secondary magnetic element (790) [which can have two planar frontal coupling sides] and secondary conductors (791) can form a secondary electromagnetic interface (792) which can be coupled with a load (797) [which can be an electric vehicle, an electric vessel, an electric/electronic apparatus, etc.]. The secondary magnetic element (790) and the secondary conductors (791) can be shielded and insulated [e.g. the secondary magnetic element can be divided into mutually shielded and/or insulated/magnetically, electrically, stress, etc./subsections wherein each subsection can contain a number of secondary conductors (791) which can have various parameters/e.g. can be dedicated to power transfer and/or data transmission/, etc. Similarly the primary magnetic elements (780a, 780b) can be divided into subsections (not shown)]. The primary electromagnetic interface (782) and the secondary (repeating) electromagnetic interface (792) can be configured [e.g. have planar coupling sides, be dimensionally compatible, etc.] to enable relative mutual movement [e.g. to introduce the secondary electromagnetic interface (792) into the primary electromagnetic interface (782)].

FIG. 37 is a schematic perspective view of another embodiment of the wireless electromagnetic energy transfer system provided in a subsea static power transfer system. Primary magnetic elements and primary conductors [both can have planar frontal coupling sides] can form a primary electromagnetic interface (802) (e.g. similarly as shown in FIG. 36) which can be couplable with an offshore power source (not shown) [which can be a rechargeable power source/e.g. which can contain rechargeable batteries, capacitors, combinations, etc./, an offshore charging station, a thermal energy to electric energy converter, etc./]. The primary magnetic elements and the primary conductors can be shielded and insulated (not shown) [e.g. with an electric, watertight, stress insulation, etc.]. A secondary magnetic element [which can have two planar frontal coupling sides (poles)] and a secondary conductor can form a secondary electromagnetic interface (812) (e.g. similarly as shown in FIG. 36) which can be coupled with an offshore vessel (817) [which can be a submarine, a remotely operated vessel, a drone, etc.]. The secondary magnetic element and the secondary conductor can be shielded and insulated (not shown) [e.g. with an electric, watertight, stress insulation, etc.]. The primary and secondary electromagnetic interfaces (802 and 812) can enable relative mutual movement [e.g. sliding movement]. The secondary electromagnetic interface (812) can be provided as a repeating electromagnetic interface wirelessly coupled with the offshore vessel (817) which can include another secondary electromagnetic interface (not shown).

FIG. 38 is a schematic sectional view of another embodiment of the wireless electromagnetic energy transfer system provided in an offshore dynamic power transfer system. Primary magnetic elements (820a, 820b) [which can form primary working pairs (groups)] and primary conductors (821a, 821b) [both can have planar frontal coupling sides (poles)] can form a primary electromagnetic interface (822) (e.g. similarly as shown in FIG. 39) which can be couplable with an onshore/offshore power source (not shown). The primary magnetic elements (820a, 820b) and the primary conductors (821a, 821b) can be shielded with a shielding (829) and insulated (not shown) [e.g. with an electric, watertight, stress insulation, etc.]. Secondary magnetic elements (830a, 830b) [which can form secondary working pairs (groups)] and secondary conductors (831a, 831b) [both can have planar frontal coupling sides (poles)] can form a secondary electromagnetic interface (832) (e.g. similarly as shown in FIG. 39) which can be coupled with an offshore vessel (not shown). The secondary magnetic elements (830a, 830b) and the secondary conductors (831a, 831b) can be shielded and insulated [e.g. each secondary magnetic element (830a, 830b) can be divided into mutually shielded and/or insulated/magnetically, electrically, stress, etc./subsections, each subsection can contain a defined number of secondary conductors (831a, 831b) which can have various parameters, etc.; similarly each primary magnetic element (820a, 820b) can be divided into subsections (not shown), the subsections can be individually switchable, controllable, dedicated, etc.]. The primary electromagnetic interface (822) can be a buoyant anchored (or a nonbuoyant supported) offshore power transfer interface provided at about water level (828) (and/or under, above water level, level adjustable, etc.). The secondary electromagnetic interface (832) can be mobile [e.g. can be coupled with any type of a rolling (sliding, etc.) device (834) containing any type of a coupling mechanism (835) to be coupled with the offshore vessel]. The primary and secondary electromagnetic interfaces (822 and 832) can be configured to be mutually movable [e.g. to enable rolling, sliding, etc. and thus to enable the dynamic power transfer].

FIG. 39 is a schematic oblique view of another embodiment of the wireless electromagnetic energy transfer system provided in an onshore/offshore static/dynamic power transfer system. Primary magnetic elements (840a, 840b) [which can form primary working pairs] and primary conductors (841a, 841b) [both can have planar frontal coupling sides] can form a primary electromagnetic interface (842) which can be coupled with a defined power source (845) [which can be an onshore/offshore power source]. The primary conductors (841b) can be coupled with electrocomponents (843) [which can be sensors/e.g. sensing a position of a secondary electromagnetic interface (852)/], (844) [which can be a switch switching a primary circuit, the primary conductors (841b), etc.]. A secondary magnetic element (850) [which can have two planar frontal coupling sides] and secondary conductors (851) can form the secondary electromagnetic interface (852) which can be coupled with an electric vehicle/offshore vessel (857). The secondary conductors (851) can be coupled with an electrocomponent (853) [which can be a target/e.g. optical, electromagnetic, etc./]. The elements of the primary electromagnetic interface (842) and of the secondary electromagnetic interface (852) can be shielded and/or insulated (not shown). The primary electromagnetic interface (842) can be coupled with an engineering construction (not shown), an offshore power transfer interface (not shown), etc. The secondary electromagnetic interface (852) can be coupled with an electric vehicle component (not shown), an offshore vessel (not shown), etc.

FIG. 40 is a schematic diagram of another embodiment of the wireless electromagnetic energy transfer system shown in a pulse width modulation (PWM) topology with primary and secondary conductors coupled with electrocomponents. Primary and secondary electromagnetic interfaces forming electromagnetic couplers (860a, 860b) [which can be formed by one or more primary conductors and one or more primary magnetic elements] can be coupled with a primary circuit (861a) which can include a direct current (DC) power source (865), an inductor (864a) and a switch (863) [which can be a Field Effect Transistor (FET) (with a shunt diode) with adequate voltage and current ratings driven by a control circuit (not shown) and which can be monitored by sensors for sensing voltage and current (not shown), etc.]. A secondary circuit (861b) can include an inductor (864b) a diode (868), a capacitor (866) and a load (867) [other PWM topologies can be advantageously used for short distance applications].

FIG. 41 is a schematic diagram of another embodiment of the wireless electromagnetic energy transfer system shown in a power amplifier topology with primary and secondary conductors coupled with electrocomponents. Electromagnetic couplers (870a, 870b) can be coupled with a primary circuit (871a) which can include a DC power source (875), an inductor (874a), a switch (873) [a switching frequency can be increased to a very high value which can reduce a size of passive components], a capacitor (876) and an inductor (874b). A secondary circuit (871b) can include a load (877) [other high frequency power amplified topologies can be used for increased energy transfer distance].

FIG. 42 is a schematic diagram of another embodiment of the wireless electromagnetic energy transfer system shown in a full-bridge inverter topology and a series L compensation with primary and secondary conductors coupled with electrocomponents. Electromagnetic couplers (880a, 880b) can be coupled with a primary circuit (881a) which can include four metal oxide semiconductor field effect transistor (MOSFET) switches (883a, 883b, 883c, 883d) forming an inverter (883) [which can be upgraded to a three-phase inverter], a DC power source (885) [which can be coupled via a power factor correction converter with an alternative current source (not shown)] and an inductor (884a) [which can be replaced with an active circuit]. A secondary circuit (881b) can include an inductor (884b) [which can be replaced with an active circuit and replaced at the primary side], four diodes (888a, 888b, 888c, 888d) forming a rectifier (888) and a load (887). [The inductors (884a, 884b) can have large enough inductances in long distance and high power energy transfer applications.] The primary circuit (881a) can include any other type of an inverter and electrocomponents [e.g. a controller, a converter, an oscillator, a driver, an amplifier, a filter, a matching circuitry, other switch circuits, sets and types, etc.]. The secondary circuit (881b) can include any other type of a rectifier [e.g. a passive double diode full wave rectifier, etc.] and electrocomponents [e.g. a matching circuitry; a choke, a block capacitor; a comparator, a switch, a diode, a double diode, etc.].

FIG. 43 is a schematic diagram of another embodiment of the wireless electromagnetic energy transfer system shown in a full-bridge inverter topology and an LC compensation with primary and secondary conductors coupled with electrocomponents. Electromagnetic couplers (890a, 890b) can be coupled with a primary circuit (891a) which can include an inverter (893) a DC power source (895), an inductor (894a) and a capacitor (896a). A secondary circuit (891b) can include a capacitor (896b), an inductor (894b), a rectifier (898) and a load (897). [Inductances of the inductors (894a, 894b) can be decreased for power application, capacitances of the capacitors (896a, 896b) can be relatively large in power applications. The system can provide relatively high tolerance to misalignment. The system power can be reversely proportional to a coupling coefficient.]

FIG. 44 is a schematic diagram of another embodiment of the wireless electromagnetic energy transfer system shown in a bidirectional full-bridge inverter topology and an LCL compensation with primary and secondary conductors coupled with electrocomponents. Electromagnetic couplers (900a, 900b) can be coupled with a primary circuit (901a) which can include an inverter rectifier (903) a DC power source/power sink (905), an inductor (904a), a capacitor (906a) and an inductor (904b). A secondary circuit (901b) can include an inductor (904c), a capacitor (906b), an inductor (904d), an inverter rectifier (908) and a DC power sink/power source (907). [Inductances of the inductors (904b, 904c) can partially compensate the electromagnetic couplers (900a, 900b) with the LC compensations (904a and 906a) and (904d and 906d). The system power can be reversely proportional to a coupling coefficient.]

FIG. 45 is a schematic diagram of another embodiment of the wireless electromagnetic energy transfer system shown in a full-bridge inverter topology and a CLLC compensation with primary and secondary conductors coupled with electrocomponents. Electromagnetic couplers (910a, 910b) can be coupled with a primary circuit (911a) which can include an inverter (913) a DC power source (915), a capacitor (916a), inductors (914a, 914b) and a capacitor (916b). A secondary circuit (911b) can include a capacitor (916c), inductors (914c, 914d), a capacitor (916d), a rectifier (918) and a load (917). [The inductances (914a, 914d) can help reduce the inductances (914b, 914c).]

FIG. 46 is a schematic diagram of another embodiment of the wireless electromagnetic energy transfer system shown in a full-bridge inverter topology and a multiple LCLC compensation [which can be symmetrical or asymmetrical and wherein number of LC cells can be varied in according to the system requirements] with primary and secondary conductors coupled with electrocomponents. Electromagnetic couplers (920a, 920b) can be coupled with a primary circuit (921a) which can include an inverter (923) a DC power source (925), an inductor (924a), a capacitor (926a), an inductor (924b) and a capacitor (926b). A secondary circuit (921b) can include a capacitor (926c), an inductor (924c), a capacitor (926d), an inductor (924d), a rectifier (928) and a load (927). The inductors (924b) and (924c) can be inductively coupled in a combined energy transfer system (inductive, electromagnetic). [The inductors (924a and 924b) and (924c and 924d) can be used to increase voltage for sufficient power transfer and can resonate in multiple resonances with the capacitors (926a and 926b) and (926c and 926d) and with the electromagnetic couplers (920a, 920b). The capacitors (926b, 926c) can reduce inductors (924b, 924c). The system power can be proportional to a coupling coefficient and can be regulated through circuit parameter design (e.g. through the capacitors (926a, 926d).]

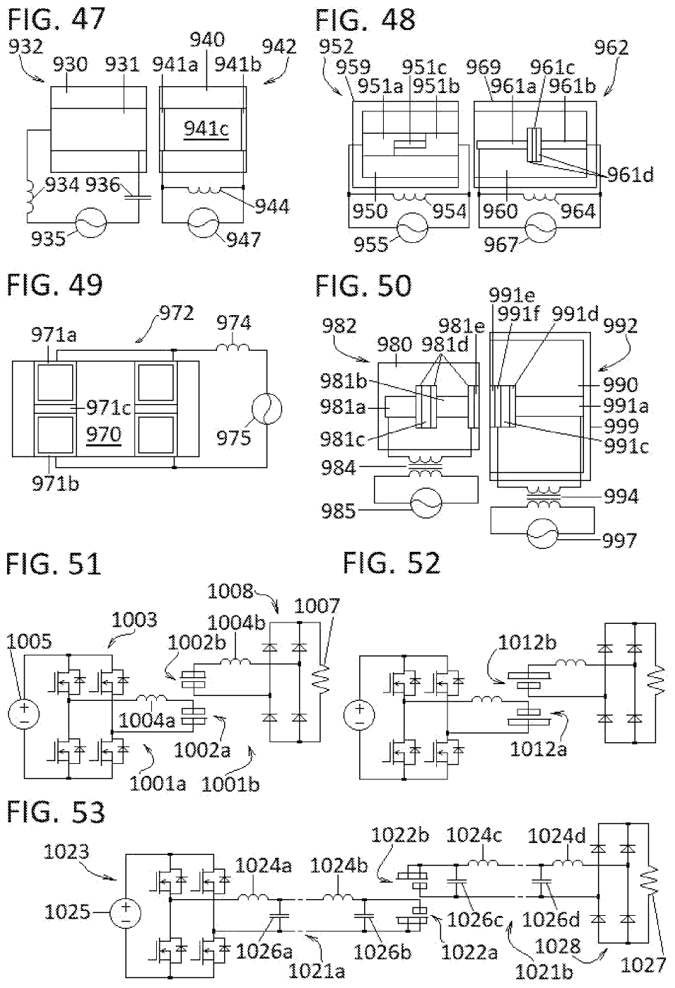

FIG. 47 is a schematic diagram of the wireless electromagnetic energy transfer system. A primary magnetic element (930) [which can have a planar frontal coupling side] and a primary conductor (931) [which can include one or more (parallel) conductors (or networks) having various shapes, parameters, etc. and being disposed in various patterns, etc.] can form a primary electromagnetic interface (932) which can be coupled with a capacitor (936) and an inductor (934) [which can be inductively coupled with a parasitic element/e.g. a parasitic resonant tank (not shown)/] which can form a primary series tuned circuit which can be coupled with an energy source (935) [which can be an AC source]. A secondary magnetic element (940) [which can have a planar frontal coupling side] and secondary conductors (941a, 941b) [which can have a form of two capacitive plates and which can be provided with a magnetic or non-magnetic dielectric layer (941c)] can form a secondary electromagnetic interface (942) which can be coupled with a shunt inductor (944) [which can be inductively coupled with a parasitic element/e.g. a parasitic relay primary/secondary electromagnetic interface (not shown)/] which can form a secondary parallel tuned circuit which can be coupled with a load (947) [which can include a power conversion unit with a rectifier]. The primary electromagnetic interface (932) and the secondary electromagnetic interface (942) can be spaced from each other to wirelessly transfer electromagnetic energy and the system can provide bidirectional energy flow. [An electric field between the secondary conductor plates (941a, 941b) can be substantially perpendicular to a circular magnetic field created in the secondary magnetic element (940)/which can be hollow cylinder shaped around the dielectric layer (941c) which can be cylinder shaped/. The shown lay-out can be similarly applied to the primary side. Condenser action between the secondary conductors (941a, 941b) can increase self-capacitance.].

FIG. 48 is a schematic diagram of another embodiment of the wireless electromagnetic energy transfer system. A primary magnetic element (950) and primary conductors (951a, 951b) which can be provided with a dielectric layer (951c) can form a primary electromagnetic interface (952) which can be coupled with an inductor (954) which can form with the primary conductors (951a, 951b) providing condenser action a primary tuned circuit which can be coupled with an energy source (955) [which can be an AC source]. A secondary magnetic element (960) and secondary conductors (961a, 961b) [which can be provided with capacitive coupling enlargements (961d) which can be provided with a dielectric layer (961c)] can form a secondary electromagnetic interface (962) which can be coupled with an inductor (964) which can form with the secondary conductors (961a, 961b) providing condenser action a secondary tuned circuit which can be coupled with a load (967). The primary electromagnetic interface (952) can be provided with a shielding (959) and the secondary electromagnetic interface (962) can be provided with a shielding (969).

FIG. 49 is a schematic diagram of another embodiment of the wireless electromagnetic energy transfer system. A primary/secondary (repeating) magnetic element (970) and primary/secondary (repeating) conductors (971a, 971b) [e.g. which can be air core, cavity conductors, etc.] which can be provided with a dielectric layer (971c) can form a primary/secondary (repeating) electromagnetic interface (972) which can be coupled with an inductor (974) which can form with the primary/secondary (repeating) conductors (971a, 971b) providing condenser action a primary/secondary (repeating) tuned circuit which can be coupled with an energy source (975) [or a load]. The primary/secondary (repeating) electromagnetic interface (972) can be provided with a shielding (not shown).

FIG. 50 is a schematic diagram of another embodiment of the wireless electromagnetic energy transfer system. A primary magnetic element (980) and primary conductors (981a, 981b) [which can be provided with capacitive coupling enlargements (981d) which can be provided with dielectric layers (981c, 981e)] can form a primary electromagnetic interface (982) which can form a tuned circuit coupled with a primary transformer (984) [which can be a step-up transformer] which can be coupled with an energy source (985). A secondary magnetic element (990) and a secondary conductor (991a) [which can be provided with a capacitive coupling enlargement (991d) and a capacitively coupled capacitive plate (991f) which can be provided with dielectric layers (991c, 991e)] can form a secondary electromagnetic interface (992) which can form a tuned circuit coupled with a secondary transformer (994) [which can be a step-down transformer] which can be coupled with a load (997). The secondary electromagnetic interface can be provided with a shielding (999). [The system can be configured bidirectionally.]

FIG. 51 is a schematic diagram of another embodiment of the wireless electromagnetic energy transfer system shown in a full-bridge inverter topology and a series L compensation with primary and secondary conductors coupled with electrocomponents. A primary electromagnetic interfaces working pair (1002a) [which can provide condenser action] can be coupled with a primary circuit (1001a) which can include an inverter (1003) a DC power source (1005) and an inductor (1004a). A secondary electromagnetic interfaces working pair (1002b) [which can provide condenser action] can be coupled with a secondary circuit (1001b) which can include an inductor (1004b), a rectifier (1008) and a load (1007). The primary electromagnetic interfaces working pair (1002a) can be spaced apart from the secondary electromagnetic interfaces working pair (1002b) to wirelessly transfer electromagnetic energy.

FIG. 52 is a schematic diagram of another embodiment of the wireless electromagnetic energy transfer system shown in a full-bridge inverter topology and a series L compensation corresponding to the system shown in FIG. 51. A primary electromagnetic interfaces working pair (1012a) [which can provide condenser action] can be coupled to wirelessly transfer electromagnetic energy with a secondary electromagnetic interfaces working pair (1012b) [which can provide condenser action]. The primary and the secondary electromagnetic interfaces working pairs (1012a and 1012b) can be asymmetrically sized and can be provided in a four-plate stacked configuration [or the primary and the secondary alectromagnetic interfaces can be provided in asymmetrically sized primary and secondary one-piece configurations].

FIG. 53 is a schematic diagram of another embodiment of the wireless electromagnetic energy transfer system shown in a full-bridge inverter topology and a multiple LCLC compensation [which can be symmetrical or asymmetrical] with primary and secondary conductors coupled with electrocomponents. A primary electromagnetic interfaces working pair (1022a) [which can provide condenser action] can be coupled with a primary circuit (1021a) which can include an inverter (1023) a DC power source (1025), inductors (1024a, 1024b) and capacitors (1026a, 1026b). A secondary electromagnetic interfaces working pair (1022b) [which can provide condenser action] can be coupled with a secondary circuit (1021b) which can include inductors (1024c, 1024d), capacitors (1026c, 1026d), a rectifier (1028) and a load (1027). The primary and secondary electromagnetic interface pairs (1022a, 1022b) can be asymmetrically sized, provided in a four-plate stacked configuration or an asymmetrical one-piece configuration similarly as in FIG. 52.

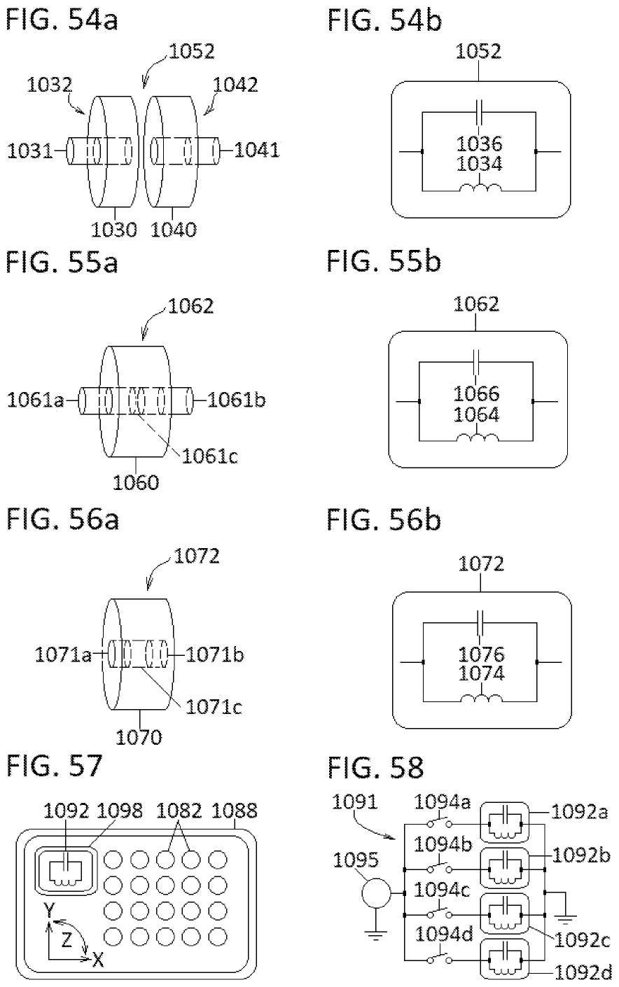

FIG. 54a is a schematic diagram of another embodiment of the wireless electromagnetic energy transfer system. A primary magnetic element (1030) and a primary conductor (1031) can form a primary electromagnetic interface (1032). A secondary magnetic element (1040) and a secondary conductor (1041) can form a secondary electromagnetic interface (1042). The primary and secondary electromagnetic interfaces can form a wireless electromagnetic coupler (1052).

FIG. 54b is a schematic diagram of an equivalent circuit representation of the wireless electromagnetic energy transfer system embodiment shown in FIG. 54a. A primary and secondary magnetic elements [which can store magnetic energy] which can be represented by an inductance (1034) and a primary/secondary conductor [which can store electric energy] which can be represented by a capacitance (1036) can form a parallel tuned circuit [which can further provide a resistance (not shown)] provided in the electromagnetic coupler (1052) [which can be coupled with inductors, capacitors, circuits, networks, compensations and other electrocomponents. More electromagnetic couplers can be coupled to form arrays of electromagnetic couplers which can share primary/secondary inductors, primary/secondary magnetic elements and which can be coupled in series, in parallel, or combinations, etc.].

FIG. 55a is a schematic diagram of another embodiment of the wireless electromagnetic energy transfer system. A primary/secondary magnetic element (1060) and primary/secondary conductors (1061a, 1061b) which can be provided with a dielectric layer (1061c) [which can provide condenser action] can form a primary/secondary electromagnetic interface (1062).

FIG. 55b is a schematic diagram of an equivalent circuit representation of the wireless electromagnetic energy transfer system embodiment shown in FIG. 55a. A primary/secondary magnetic element which can be represented by an inductance (1064) and primary/secondary conductors which can be represented by a capacitance (1066) can form the primary/secondary electromagnetic interface (1062) [which can be coupled with electrocomponents, can form series, parallel arrays, etc.].

FIG. 56a is a schematic diagram of another embodiment of the wireless electromagnetic energy transfer system. A primary/secondary magnetic element (1070) and primary/secondary conductors (1071a, 1071b) [which can form capacitive plates] which can be provided with a dielectric layer (1071c) [which can provide condenser action] can form a primary/secondary electromagnetic interface (1072).

FIG. 56b is a schematic diagram of an equivalent circuit representation of the wireless electromagnetic energy transfer system embodiment shown in FIG. 56a. A primary/secondary magnetic element which can be represented by an inductance (1074) and primary/secondary conductors which can be represented by a capacitance (1076) can form the primary/secondary electromagnetic interface (1072) [which can be coupled with electrocomponents, can form series, parallel arrays, etc.].

FIG. 57 is a schematic diagram of another embodiment of the wireless electromagnetic energy transfer system. Primary electromagnetic interfaces (1082) can form an array [which can be provided at a primary spatially defined construction (1088) which can be a charging pad, an engineering construction/e.g. an open ground lane//e.g. a road//, covered ground lane//e.g. a skating rink/, a sensor, a digitizer in a form of a tablet, etc.]. A secondary electromagnetic interface (1092) [which can be provided at a secondary spatially defined construction (1098), which can be a vehicle//e.g. which can be coupled with secondary conductors (not shown)//, an electrically driven ice resurfacer, an autonomous electronics device//e.g. a mobile phone, etc.//, a pen of a plotter, an untethered stylus, a stylus using conductive/magnetic ink, etc.] can have translational freedom along the X and Y axes and rotational freedom about the Z axis [the secondary electromagnetic interface can have remaining three degrees of freedom within a defined coupling factor]. Other pairs of the primary and secondary spatially defined constructions providing the primary/secondary electromagnetic interfaces can be formed: an aircraft on a tarmac, a helicopter dropping a secondary electromagnetic interface above an airfield (similarly a drone), a submarine above a sea floor with a submarine primary electromagnetic interface array, similarly for models and toys, etc.

FIG. 58 is a schematic diagram of another embodiment of the wireless electromagnetic energy transfer system. Primary electromagnetic interfaces (1092a, 1092b, 1092c, 1092d) can form an array [shown a simple parallel pattern, various patterns (parallel, series, including electrocomponents//e.g. circuits, compensations, etc.//) can be used] which can be coupled through a bank of switches (1094a, 1094b, 1094c, 1094d) [various switching devices can be used, e.g. transistor switches/e.g. MOSFETs/, power switches, relays, etc.] with an energy source (1095) [which can be an AC input port, an oscillator with an amplifier providing a desired frequency, an inverter coupled with an AC/DC power source and with a compensation circuit, etc.]. A primary circuit (1091) can include various electrocomponents [e.g. sensors in sensing circuits coupled with a processor which can sense a position of a device/which can be an electric vehicle, an untethered device, an electronic pen, etc./containing a secondary electromagnetic interface (not shown) which can be coupled with an electrocomponent/e.g. a rechargeable power source, a source management system, etc./]. The shown embodiment can switch for a defined period only some of the primary electromagnetic interfaces (1092a, 1092b, 1092c, 1092d), etc. Similarly, various switchable circuits can be designed for primary electromagnetic interfaces forming pairs (pole pairs, pole groups) in various functional and shape constellations (not shown) and switchable energy transfer circuits comprising primary and secondary circuits, energy sources, loads coupled with output ports, electrocomponents, etc.

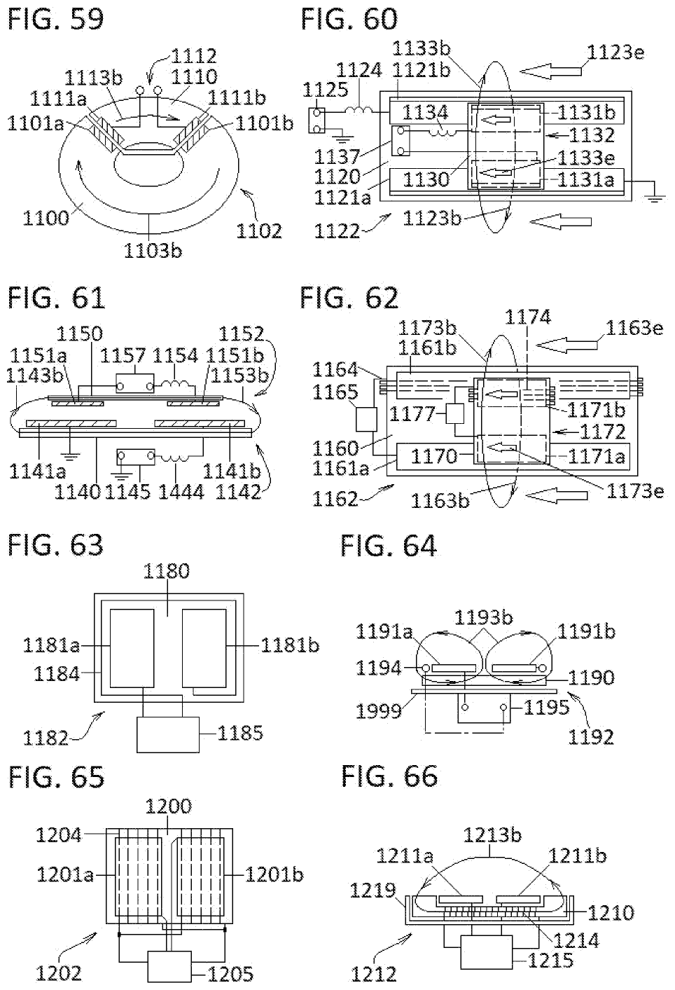

FIG. 59 is a schematic sectional view of another embodiment of the wireless electromagnetic energy transfer system. A primary magnetic element (1100) [which can have two planar frontal coupling sides and which can provide a path for a primary circular magnetic flux (1103b)] and primary conductors (1101a, 1101b) [which can have planar frontal coupling sides and which can form a primary working pair] can form a primary electromagnetic interface (1102) which can be couplable with a defined power source (not shown) and which can be shielded, insulated (not shown), which can be buoyant which can include power transfer sections and connections and which can be provided in an onshore/offshore static/dynamic power transfer system (e.g. similarly as shown in FIG. 20), etc. A secondary magnetic element (1110) [which can have two planar frontal coupling sides and which can provide a path for a secondary circular magnetic flux (1113b)] and secondary conductors (1111a, 1111b) [which can have planar frontal coupling sides and which can form a secondary working pair] can form a secondary electromagnetic interface (1112) which can be coupled with a vehicle [which can be an electric vehicle or an offshore vessel] (not shown) and which can be shielded, insulated, which can be buoyant, mobile, etc., and which can be provided in the onshore/offshore static/dynamic power transfer system (e.g. similarly as shown in FIG. 20), etc. The primary electromagnetic interface (1102) and the secondary electromagnetic interface (1112) can be configured [e.g. have planar coupling sides, be dimensionally compatible, etc.] to enable relative mutual movement [e.g. to introduce the secondary electromagnetic interface (1112) into the primary electromagnetic interface (1102)].

The primary and secondary conductors (1101a and 1111a; 1101b and 1111b) can provide condenser action.

FIG. 60 is a schematic oblique plan view of another embodiment of the wireless electromagnetic energy transfer system (which can be similar as shown in FIG. 59). A primary magnetic element (1120) [which can have two planar frontal coupling sides and which can provide a path for a primary circular magnetic flux (1123)] and primary conductors (1121a, 1121b) [which can have planar frontal coupling sides and which can form a primary working pair] can form a primary electromagnetic interface (1122) which can be coupled with an electrocomponent [e.g. an impedance matching circuit (1124)], a defined power source (1125) and which can be shielded, insulated and which can be buoyant, which can include power transfer sections and connections (not shown) and which can be provided in an onshore/offshore static/dynamic power transfer system (e.g. similarly as shown in FIG. 20), etc. A secondary magnetic element (1130) [which can have two planar frontal coupling sides and which can provide a path for a secondary circular magnetic flux (1133b)] and secondary conductors (1131a, 1131b) [which can have planar frontal coupling sides and which can form a secondary working pair] can form a secondary electromagnetic interface (1132) which can be coupled with an electrocomponent [e.g. an impedance matching circuit (1134)], a vehicle (1137) [which can be an electric vehicle or an offshore vessel] and which can be shielded, insulated, which can be buoyant, mobile, etc., and which can be provided in the onshore/offshore static/dynamic power transfer system (e.g. similarly as shown in FIG. 20), etc. The primary electromagnetic interface (1122) and the secondary electromagnetic interface (1132) can be configured [e.g. have planar coupling sides, be dimensionally compatible, etc.] to enable relative mutual movement [e.g. to introduce the secondary electromagnetic interface (1132) into the primary electromagnetic interface (1122) and to move in a longitudinal direction, etc.]. The primary circular magnetic flux (1123b) can be associated with a primary electric field (1123e). The secondary circular magnetic flux (1133b) can be associated with a secondary electric field (1133e). The primary and secondary conductors (1121a and 1131a; 1121b and 1131b) can provide condenser action. Alternatively the primary (and secondary) magnetic elements (1120) can be provided in other forms and shapes, e.g. sections, bars, etc. and can be shielded with a shielding (not shown).

FIG. 61 is a schematic sectional view of another embodiment of the wireless electromagnetic energy transfer system. A primary magnetic element (1140) [which can have a planar frontal coupling side and which can provide a return path for a primary circular magnetic flux (1143b)] and primary conductors (1141a, 1141b) [which can have planar frontal coupling sides and which can form a primary working pair] can form a primary electromagnetic interface (1142) which can be coupled with an electrocomponent [e.g. an impedance matching circuit (1144)], a defined power source (1145) and which can be shielded, insulated (not shown) and which can be provided in an onshore/offshore static/dynamic power transfer system [e.g. can be coupled with engineering constructions/e.g. open ground lanes, naval constructions//e.g. offshore vessels' decks, bulkheads, overheads, any part of a hull, of a superstructure//, etc.]. A secondary magnetic element (1150) [which can have a planar frontal coupling side and which can provide a path for a secondary circular magnetic flux (1153b)] and secondary conductors (1151a, 1151b) [which can have planar frontal coupling sides and which can form a secondary working pair] can form a secondary electromagnetic interface (1152) which can be coupled with a vehicle (1157) [e.g. an electric vehicle or an offshore vessel and/or with an electrocomponent/e.g. an impedance matching circuit (1154)/and/or an electric vehicle component/e.g. tires, body/chassis/] and which can be shielded, insulated (not shown) and which can be provided in the onshore/offshore static/dynamic power transfer system, etc. The primary electromagnetic interface (1142) and the secondary electromagnetic interface (1152) can be configured [e.g. have planar coupling sides, be dimensionally compatible, etc.] to enable relative mutual movement [e.g. the secondary electromagnetic interface (1152) can be provided on a bottom side of the body/chassis with a sufficient ground clearance, etc.]. The primary and secondary conductors (1141a and 1151a; 1141b and 1151b) can provide condenser action. Condenser action can be considered between the primary magnetic element (1140) and the primary conductors (1141a, 1141b) and between the secondary magnetic element (1150) and the secondary conductors (1151a, 1151b) [or a backing shielding(s) (not shown)] then a six-plate (eight-plate, multiplate) coupling structure providing an increased self-capacitance and electric shielding resulting in electric field emission reduction can be obtained providing supplementary shielding to the electromagnetic fields.

FIG. 62 is a schematic oblique plan view of another embodiment of the wireless electromagnetic energy transfer system (which can be similar as shown in FIG. 61). A primary magnetic element (1160) [which can have a planar frontal coupling side and which can provide a return path for a primary circular magnetic flux (1163b)] and primary conductors (1161a, 1161b) [which can have planar frontal coupling sides and which can form a primary working pair] can form a primary electromagnetic interface (1162) which can be coupled with a primary coupling inductor (1164) [which can have various shapes, forms, positions/e.g. central, etc./cover various portions and proportions of the primary magnetic elements (1160) which can have various endings/e.g. bent in a direction of the flux (1163b), enlarged, etc./, and which can be composed of a plurality of coils in series, parallel, etc.], a defined power source (1165) and which can be shielded, insulated [e.g. can comprise an electric, waterproof, stress insulation, etc.] and which can be provided in an onshore/offshore static/dynamic power transfer system [e.g. can be coupled with engineering constructions], etc.

A secondary magnetic element (1170) [which can have a planar frontal coupling side and which can provide a path for a secondary circular magnetic flux (1173b)] and secondary conductors (1171a, 1171b) [which can have planar frontal coupling sides and which can form a secondary working pair] can form a secondary electromagnetic interface (1172) which can be coupled with a secondary coupling inductor (1174), a vehicle (1177) [which can be an electric vehicle or an offshore vessel and/or with an electrocomponent/e.g. an impedance matching circuit (not shown)/and/or an electric vehicle component (e.g. tires, body/chassis)] and which can be shielded, insulated [e.g. can comprise an electric, waterproof, stress insulation, etc.] and which can be provided in the onshore/offshore static/dynamic power transfer system, etc. The primary electromagnetic interface (1162) and the secondary electromagnetic interface (1172) can be configured [e.g. have planar coupling sides, be dimensionally compatible, etc.] to enable relative mutual movement [e.g. the secondary electromagnetic interface (1172) can be provided on a bottom side of the body/chassis with a sufficient ground clearance, at tires, etc.]. The primary circular magnetic flux (1163b) can be associated with a primary electric field (1163e). The secondary circular magnetic flux (1173b) can be associated with a secondary electric field (1173e). The primary and secondary conductors (1161a and 1171a; 1161b and 1171b) can provide condenser action, can be coupled in various nodes (e.g. on a same side as shown in FIG. 63), provide various circular fluxes and electric fields patterns, etc. Alternatively the primary (and secondary) magnetic elements (1160) can be provided in other forms and shapes, e.g. sections, bars, etc. and can be backed with a shielding (not shown) [which can provide auxiliary condenser action as explained in FIG. 61 in a six-plate structure].

FIG. 63 is a schematic plan view of another embodiment of the wireless electromagnetic energy transfer system. A primary magnetic element (1180) [which can have a planar frontal coupling side] and primary conductors (1181a, 1181b) [which can have planar frontal coupling sides and which can form a primary working pair] can form a primary electromagnetic interface (1182) which can be coupled with a primary coupling inductor (1184), an energy source (1185) and which can be shielded, insulated [e.g. can comprise an electric insulation, etc.] and which can be provided in an enclosure [e.g. a charging pad] (not shown), etc. A secondary magnetic element, a working pair of secondary conductors coupled with a load and a secondary coupling inductor (not shown) can be provided in a similar way and can be compatible with the primary elements to be able to wirelessly transfer energy in the system of the present invention. The pair of the primary conductors (1181a, 1181b) and the pair of the secondary conductors (not shown) can provide condenser action.

FIG. 64 is a schematic side view of another embodiment of the wireless electromagnetic energy transfer system (which can be similar as shown in FIG. 63). A primary magnetic element (1190) [which can have a planar frontal coupling side and which can provide return paths for primary circular magnetic fluxes (1193b)] and primary conductors (1191a, 1191b) [which can have planar frontal coupling sides and which can form a primary working pair] can form a primary electromagnetic interface (1192) which can be coupled with a primary coupling inductor (1194) (shown schematically, similarly as shown in FIG. 63), an energy source (1195) and which can be shielded with a shielding (1199). A secondary magnetic element, a pair of secondary conductors, a coupling inductor (not shown) can be provided in a similar way.

FIG. 65 is a schematic plan view of another embodiment of the wireless electromagnetic energy transfer system. A primary magnetic element (1200) [which can have a planar frontal coupling side] and primary conductors (1201a, 1201b) [which can have planar frontal coupling sides and which can form a primary working pair] can form a primary electromagnetic interface (1202) which can be coupled with a primary coupling inductor (1204) [which can include parallelly wound coils], a defined power source (1205) and which can be provided in a static/dynamic power transfer system. A secondary magnetic element, a pair of secondary conductors coupled with a vehicle and a secondary coupling inductor (not shown) can be provided in a similar way and can be compatible with the primary elements to be able to wirelessly transfer energy in the system of the present invention. The pair of the primary conductors (1201a, 1201b) and the pair of the secondary conductors (not shown) can provide condenser action.

FIG. 66 is a schematic side view of another embodiment of the wireless electromagnetic energy transfer system (which can be similar as shown in FIG. 65). A primary magnetic element (1210) [which can have at least partially planar frontal coupling side and which can provide a return path for a primary circular magnetic flux (1213b)] and primary conductors (1211a, 1211 b) [which can have planar frontal coupling sides and which can form a primary working pair] can form a primary electromagnetic interface (1212) which can be coupled with a primary coupling inductor (1214) [which can include a plurality of coils coupled in parallel similarly as shown in FIG. 65 or in series, wherein a winding can be further provided at vertical portions of the primary magnetic element (not shown)], a defined power source (1215) [which can include electrocomponents/e.g. a power factor correction, a voltage regulation, a controller, an inverter, an impedance matching circuitry, etc./] and which can be shielded with a shielding (1219) [another shielding (not shown) can be provided between the coupling inductor's (1214) windings and the primary conductors (1211a, 1211b), etc.] and which can be provided in a static/dynamic power transfer system [e.g. can form switchable power transfer sections on a road for dynamic power transfer to electric vehicles, etc.]. A secondary magnetic element, a pair of secondary conductors, a coupling inductor (not shown) can be provided in a similar way. A secondary electromagnetic interface can be coupled with a vehicle [e.g. with the electric vehicle which can include electrocomponents/e.g. a compensation, a rectifier, a filter, a source management system, etc./].

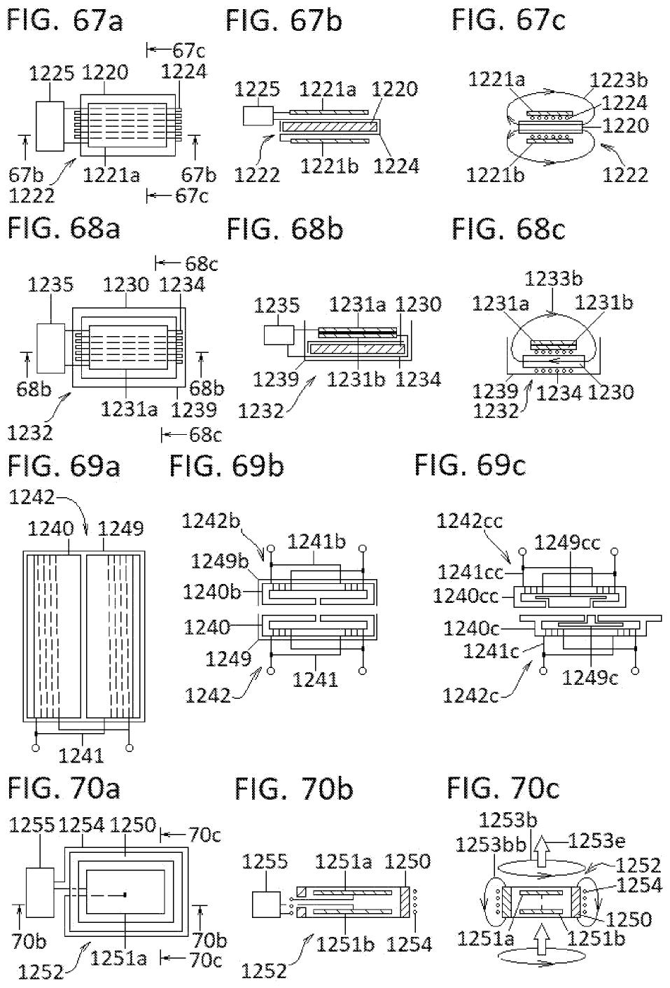

FIG. 67a is a schematic plan view of another embodiment of the wireless electromagnetic energy transfer system. A primary magnetic element (1220) [which can have two planar coupling sides] and primary conductors (1221a) (a bottom primary conductor not shown) [which can have planar frontal coupling sides and which can form a primary working pair and which can be of aluminium, etc.] can form a primary electromagnetic interface (1222) [which can also serve as a repeater power transfer interface, a bidirectional power transfer interface, etc., and which can be shielded with a shielding (not shown)] which can be coupled with a primary coupling inductor (1224) and an energy source (1225). A secondary magnetic element, a pair of secondary conductors coupled with a load and a secondary coupling inductor (not shown) can be provided in a similar way [or the primary/secondary power transfer interface can be provided in a slot-socket formation (similarly as shown in FIG. 37)]. The pair of the primary conductors (only 1221a shown) and the pair of the secondary conductors (not shown) can provide condenser action.

FIG. 67b is a schematic sectional view of the embodiment of the wireless electromagnetic energy transfer system shown in FIG. 67a. The primary magnetic element (1220) and the primary conductors (1221a, 1121b) can form the primary electromagnetic interface (1222). The primary conductor (1221b) can be coupled with the primary coupling inductor (1224) and the energy source (1225).

FIG. 67c is a schematic sectional view perpendicular to the sectional view shown in FIG. 67b. The primary magnetic element (1220) [which can provide a return path for primary circular magnetic fluxes (1223b)] and the primary conductors (1221a, 1121b) can form the primary electromagnetic interface (1222) which can be coupled with the primary coupling inductor (1224).

FIG. 68a is a schematic plan view of another embodiment of the wireless electromagnetic energy transfer system. A primary magnetic element (1230) and primary conductors (1231a) (a bottom primary conductor not shown) can form a primary electromagnetic interface (1232) which can be shielded with a shielding (1239) and which can be coupled with a primary coupling inductor (1234) and an energy source (1235). A secondary magnetic element, a pair of secondary conductors coupled with a load and a secondary coupling inductor (not shown) can be provided in a similar way. The pair of the primary conductors (only 1231a shown) and the pair of the secondary conductors (not shown) can provide condenser action.

FIG. 68b is a schematic sectional view of the embodiment of the wireless electromagnetic energy transfer system shown in FIG. 68a. The primary magnetic element (1230) and the primary conductors (1231a, 1231b) [which can have different sizes] can form the primary electromagnetic interface (1232) which can be shielded with the shielding (1239). The primary conductor (1231b) can be coupled with the primary coupling inductor (1234) and the energy source (1235).

FIG. 68c is a schematic sectional view perpendicular to the sectional view shown in FIG. 68b. The primary magnetic element (1230) [which can provide a return path for a primary circular magnetic flux (1233b)] and the primary conductors (1231a, 1231b) can form the primary electromagnetic interface (1232) which can be shielded with the shielding (1239) and which can be coupled with the primary coupling inductor (1234).

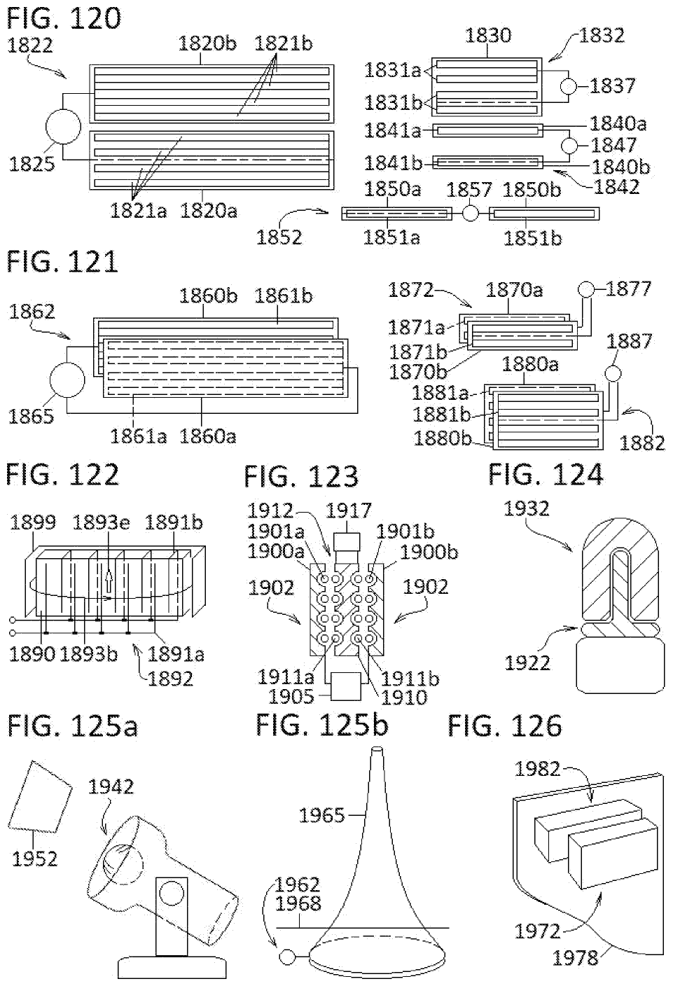

FIG. 69a is a schematic plan view of another embodiment of the wireless electromagnetic energy transfer system. A primary magnetic element (1240) [which can be U shaped to provide a return path for primary circular magnetic fluxes] and a primary conductor (1241) [which can be composed of parallelly wound coils/or other winding patterns/which can be wound on a horizontal portion (as shown) and on a vertical portion (not shown) of the primary magnetic element (1240)] can form a primary electromagnetic interface (1242) which can be shielded with a shielding (1249) and which can be couplable with a defined power source (not shown). A secondary magnetic element, a pair of secondary conductors forming a secondary (repeating) electromagnetic interface coupled with a vehicle [e.g. an electric vehicle or an offshore electric vessel] can be provided in a similar way. [Primary/secondary/repeating electromagnetic interfaces can be provided to wirelessly transfer power similarly as shown in FIGS. 120, 121.]

FIG. 69b is a schematic side view of the embodiment of the wireless electromagnetic energy transfer system shown in FIG. 69a. The primary magnetic element (1240) and the primary conductor (1241) can form the primary electromagnetic interface (1242) with the shielding (1249). The secondary (repeating) magnetic element (1240b) and the secondary (repeating) conductor (1241b) can form the secondary (repeating) electromagnetic interface (1242b) which can be shielded with a shielding (1249b) and which can be couplable with a vehicle (not shown) [e.g. an electric vehicle/which can be an electric train, tramway, etc.].

FIG. 69c is a schematic side view of a variant of the embodiment of the wireless electromagnetic energy transfer system shown in FIGS. 69a and 69b. A primary magnetic element (1240c) [which can be U shaped with enlarged ends] and the primary conductor (1241c) can form a primary electromagnetic interface (1242c) which can be shielded with a shielding (1249c). A secondary (repeating) magnetic element (1240cc) and a secondary (repeating) conductor (1241cc) can form a secondary (repeating) electromagnetic interface (1242cc) which can be shielded with a shielding (1249cc) and which can be couplable with a vehicle (not shown) [e.g. an electric vehicle or an offshore vessel, the embodiment can enable a bigger transversal coupling freedom than as shown in FIG. 69b]. [A distance between adjacent lobes of the respective magnetic elements (1240c, 1240cc) together with the provided shielding (1249c, 1249cc) can influence a shape of the provided electromagnetic field characterised by circular magnetic fluxes.]

FIG. 70a is a schematic plan view of another embodiment of the wireless electromagnetic energy transfer system. A primary magnetic element (1250) and primary conductors (1251a) (a bottom primary conductor not shown) can form a primary electromagnetic interface (1252) which can be shielded with a shielding (not shown) [e.g. in accordance with power transfer and safety requirements, etc.]. The primary conductor (1251a) can be coupled with a primary coupling inductor (1254) [which can form part of an impedance matching circuitry and which can be omitted] and an energy source (1255) [which can be an alternating current source with a defined frequency which can include electrocomponents (not shown)/e.g. an impedance matching circuitry/which can be shielded, etc.]. A secondary magnetic element, a pair of secondary conductors coupled with a load and a secondary coupling inductor (not shown) can be provided in a similar way. The pair of the primary conductors (only 1251a shown) and the pair of the secondary conductors (not shown) can provide condenser action.

FIG. 70b is a schematic sectional view of the embodiment of the wireless electromagnetic energy transfer system shown in FIG. 70a. The primary magnetic element (1250) and the primary conductors (1251a, 1151b) can form the primary electromagnetic interface (1252). The primary conductor (1251a) can be coupled with the primary coupling inductor (1254) and the energy source (1255).

FIG. 70c is a schematic sectional view perpendicular to the sectional view shown in FIG. 70b. The primary magnetic element (1250) [which can provide a path for primary circular magnetic fluxes (1253b) which can be associated with a primary electric field (1253e) and for primary circular magnetic fluxes (1253bb) provided by the coupling inductor (1254)] and the primary conductors (1251a, 1151b) can form the primary electromagnetic interface (1252).

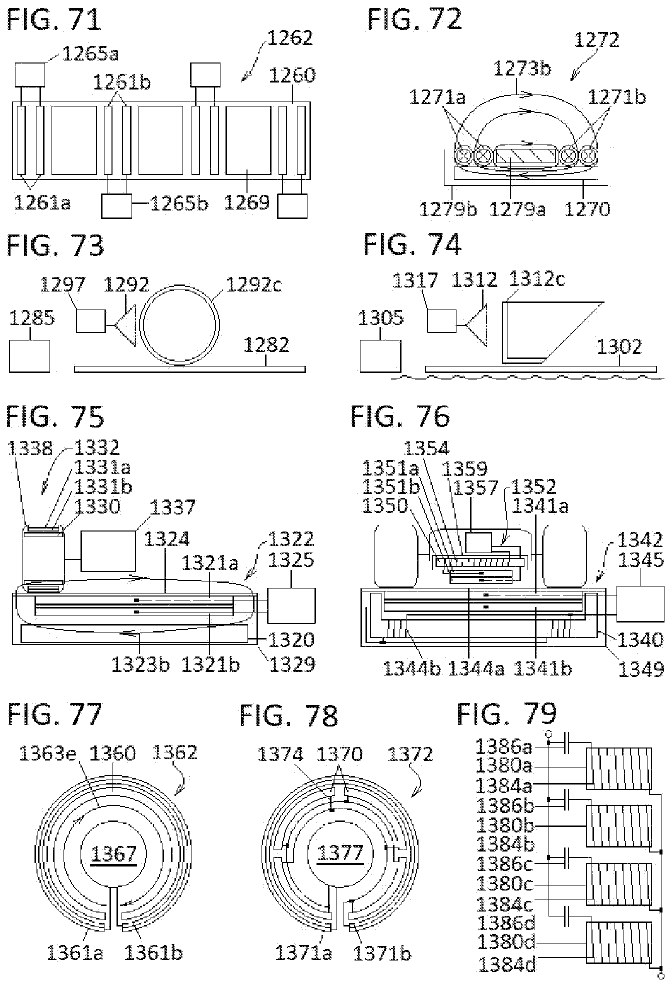

FIG. 71 is a schematic plan view of another embodiment of the wireless electromagnetic energy transfer system. A primary magnetic element (1260) [which can have a planar frontal coupling side] and primary conductors (1261a, 1261b) [which can have planar frontal coupling sides and which can form primary working pairs (groups)] can form a primary electromagnetic interface (1262) which can be coupled with an energy source (1265a, 1265b) [which can be composed of one or more power subsources which can be 180 degrees out of phase] and shielded with a shielding (1269). The primary electromagnetic interface (1262) can be insulated [e.g. can comprise an electric, waterproof, etc. insulation] and can be provided in an enclosure (not shown) [e.g. a charging pad, a charging installation provided in a road, etc.]. A secondary magnetic element, a pair of secondary conductors coupled with a load [e.g. a portable electronics, an electric vehicle, an electric ship, etc.] can be provided in a similar way and can be compatible with the primary elements. The pair of the primary conductors (1261a, 1261b) and the pair of the secondary conductors (not shown) can provide condenser action.

FIG. 72 is a schematic sectional view of another embodiment of the wireless electromagnetic energy transfer system (which can be similar as shown in FIG. 71). The primary magnetic element (1270) [which can provide a return path for a primary circular magnetic flux (1273b)] and the primary conductors (1271a, 1271b) [which can be independently switchable] can form the primary electromagnetic interface (1272) which can be coupled with an energy source (not shown) and shielded with shieldings (1279a, 1279b) [which can contain electronic components and circuits (not shown)]. The pair of the primary conductors (1271a, 1271b) can provide condenser action with a pair of secondary conductors (not shown).

FIG. 73 is a schematic side view of another embodiment of the wireless electromagnetic energy transfer system which can be provided in a static/dynamic power transfer system. A primary electromagnetic interface (1282) [which can be provided in a bipolar or monopolar system and which can be couplable with an engineering construction/e.g. an open ground lane//e.g. a road//, a naval construction//e.g. a board of a vessel providing wireless charging//] can be coupled with a defined power source (1285) [which can be an onshore wireless power transfer system which can include electrocomponents/e.g. switching banks and sensor circuits to switch particular primary electromagnetic interface power transfer sections to wirelessly transfer or receive power to or from an electric vehicle according to its position]. A repeating electromagnetic interface (1292c) [which can be provided at about wheels/e.g. tires/] which can repeat electromagnetic energy to a secondary electromagnetic interface (1292) [which can be couplable with an electric vehicle component/e.g. a body/chassis/, with an electrocomponent/e.g. a source management system, an electric motor, etc./] which can be coupled with a vehicle (1297) [e.g. an electric vehicle]. The system can be bidirectional and include bidirectional electrocomponents.

FIG. 74 is a schematic side view of another embodiment of the wireless electromagnetic energy transfer system which can be provided in an offshore static/dynamic power transfer system. A primary electromagnetic interface (1302) [which can be a buoyant offshore power transfer interface provided at about water level, etc., and which can be provided in a bipolar or monopolar system] can be coupled with a defined power source (1305) [which can be an onshore/offshore power source and which can include electrocomponents/e.g. switching banks and sensor circuits to switch particular primary electromagnetic interface power transfer sections to wirelessly transfer or receive power to or from an offshore vessel according to its position]. A repeating electromagnetic interface (1312c) [which can be a mobile buoyant interface/e.g. included in a drone which can be any type, e.g. a hovercraft type, etc./can repeat electromagnetic energy to a secondary electromagnetic interface (1312) [which can be a buoyant interface/e.g. couplable to a hull/] which can be coupled with a vehicle (1317) [e.g. an offshore vessel]. The system can be bidirectional and include bidirectional electrocomponents.

FIG. 75 is a schematic side view of another embodiment of the wireless electromagnetic energy transfer system which can be provided in a static/dynamic power transfer system. A primary magnetic element (1320) [which can provide a return path for a primary circular magnetic flux (1323b) which can be associated with a primary electric field (not shown, which can be perpendicular to the page)] and primary conductors (1321a, 1321b) can form a primary electromagnetic interface (1322) [which can be provided in a monopolar stacked four-plate structure and which can be couplable with a road, a board of an offshore vessel providing wireless charging, etc.] which can be shielded with a shielding (1329) and insulated with an insulation (1324) [which can be an electric, waterproof, load, vibrations insulation, etc.] and which can be coupled with a defined power source (1325) [which can be an onshore/offshore power source and which can include electrocomponents/e.g. a direct current or alternating current power source, switching banks and sensor circuits, a compensation circuitry, an inverter, a power factor correction/, etc.]. A secondary magnetic element (1330) [which can be elastic/e.g. can be provided from elastomers containing magnetic materials/] and secondary conductors (1331a, 1331b) [which can be elastic, e.g. can be comprised of a 3D fiber or mesh conductive path, etc.] can form a secondary electromagnetic interface (1332) [which can be (detachably or nondetachably) couplable with a tire (1338) and/or with a wheel and an in-wheel electric motor (not shown) or which can form a repeating electromagnetic interface (similarly as shown in FIG. 73)] which can be coupled with a vehicle (1337) [e.g. an electric vehicle]. The system can be bidirectional and can include bidirectional electrocomponents. The primary and secondary conductors (1321a and 1331a; 1321b and 1331b) can provide condenser action.

The proposed monopolar wireless power transfer system can offer relatively unlimited freedom of movement for a single track electric vehicle [e.g. an electric motorcycle, bicycle] or a two-track electric vehicle [e.g. an electric car/van/truck] on a road [which can be divided into transverse and/or longitudinal switchable power transfer sections which can have the width of a traffic lane or of more traffic lanes or of a portion of the width of the traffic lane/e.g. different for single track vehicles, two-track vehicles, four zones for four car wheels at charging parking lots, etc./to optimize the system, the power transfer sections can be formed of energy transfer points (subsections) following the vehicle's shape and movement].

FIG. 76 is a schematic side view of another embodiment of the wireless electromagnetic energy transfer system which can be provided in a static/dynamic power transfer system. A primary magnetic element (1340) [which can provide a return path for a primary circular magnetic flux (not shown, similarly as shown in FIG. 75) which can be associated with a primary electric field (not shown, which can be perpendicular to the page)] and primary conductors (1341a, 1341b) can form a primary electromagnetic interface (1342) which can be shielded with a shielding (1349) and insulated with an insulation (1344a). The primary conductor (1341b) can be coupled with a primary coupling inductor (1344b) [which can be of parallelly wound coils/which can be wound on a horizontal portion (as shown) and on a vertical portion (not shown) of the primary magnetic element (1340) or in any other pattern/and which can form part of a primary tuned circuit] and a defined power source (1345). A secondary magnetic element (1350) and secondary conductors (1351a, 1351b) can form a secondary electromagnetic interface (1352) which can be shielded with a shielding (1359). The secondary conductor (1351a) can be coupled with a secondary coupling inductor (1354) and an electrocomponent (1357) [which can be an electric vehicle source management system].

FIG. 77 is a schematic side view of another embodiment of the wireless electromagnetic energy transfer system. A secondary magnetic element (1360) [which can be provided in one piece or in plurality of portions and which can be elastic/e.g. can be provided from elastomers containing magnetic materials/and which can provide a path for a primary circular magnetic flux (not shown which can be perpendicular to the page) which can be associated with a secondary electric field (1363e)] and secondary conductors (1361a, 1361b) [which can be elastic, e.g. can be comprised of a 3D fiber or mesh conductive path, etc.] can form a secondary electromagnetic interface (1362) [which can be (detachably or nondetachably) couplable with a tire (not shown) and which can form a repeating electromagnetic interface (similarly as shown in FIG. 73)] which can be coupled with a vehicle (1367) [e.g. an electric vehicle including an electrocomponent/e.g an in wheel electric motor, a compensation, a source management system, etc./]. The system can be bidirectional and can include bidirectional electrocomponents. Primary conductors (not shown, similarly as shown in FIG. 75) and the secondary conductors (1361a, 1361b) can provide condenser action. In case of a repeating configuration, another secondary electromagnetic interface can be provided analogically [e.g. at an inner fender of the vehicle (1367)].

FIG. 78 is a schematic side view of another embodiment of the wireless electromagnetic energy transfer system. A secondary magnetic element (1370) [which can be provided in one piece or in a plurality of portions (as shown) and which can be elastic/e.g. can be provided from elastomers containing magnetic materials/] and secondary conductors (1371a, 1371b) [which can be elastic] can form a secondary electromagnetic interface (1372) [or a repeating electromagnetic interface]. The secondary conductor (1371b) can be coupled with a secondary coupling inductor (1374) [or a repeating coupling inductor] and with a vehicle (1377) [e.g. en electric vehicle]. The system can be bidirectional and can include bidirectional electrocomponents. Primary conductors (not shown) and the secondary conductors (1371a, 1371b) can provide condenser action.

FIG. 79 is a schematic expanded view of another embodiment of the wireless electromagnetic energy transfer system. A secondary magnetic element (1380a, 1380b, 1380c, 1380d) [which can be provided in one piece or in a plurality of portions (as shown) and which can be elastic] and secondary conductors (not shown) can form a secondary electromagnetic interface (not shown, similarly as shown in FIG. 78) [or a repeating electromagnetic interface which can be (detachably or nondetachably) couplable with a tire (not shown)]. The secondary conductor (not shown) can be couplable with secondary coupling inductors (1384a, 1384b, 1384c, 1384d) [or a repeating coupling inductor which can be of one or more coupling inductors which can be in a distributed arrangement connected in parallel or in series, or which can be separately switchable and coupled with an impedance matching circuitry, switching banks, capacitors (1386a, 1386b, 1386c, 1386d)/which can be tunable or omitted/] and with a vehicle (not shown).

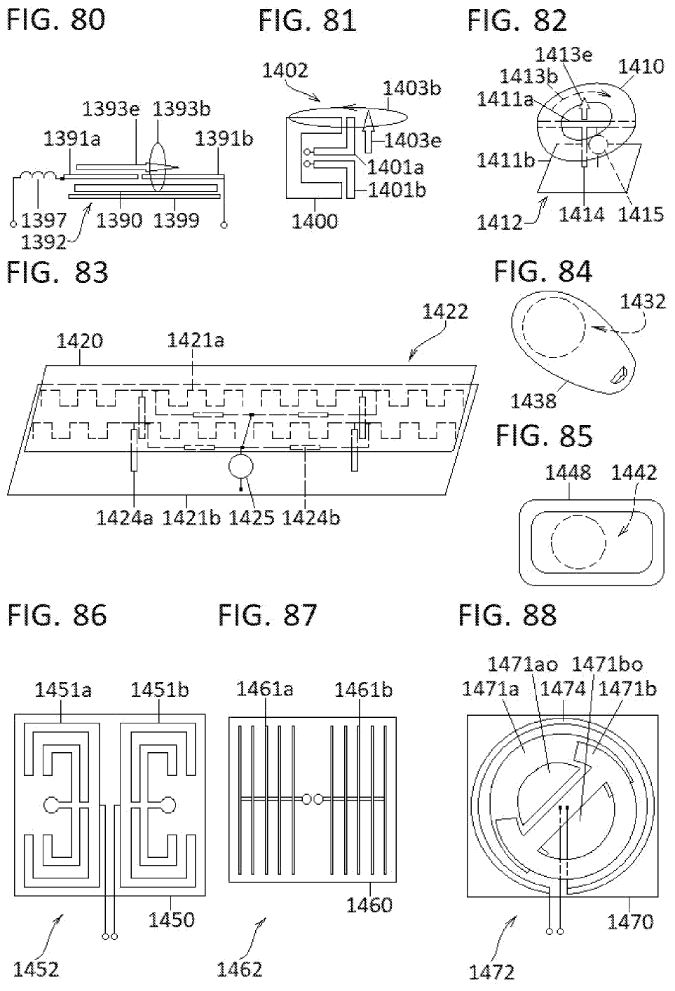

FIG. 80 is a schematic oblique side view of another embodiment of the wireless electromagnetic energy transfer system. A primary magnetic element (1390) [which can be from ferrites or another magnetic material] and primary conductors (1391a, 1391b) [which can have a form of bars, discs, plates, etc.] can form a primary electromagnetic interface (1392) which can be coupled with an electrocomponent [e.g. a compensation (1397) and an energy source (not shown)] and shielded with a shielding (1399) [which can be backing plates]. The primary magnetic element (1390) can provide a return path for a primary circular magnetic flux (1393b) which can be associated with a primary electric field (1393e). A secondary electromagnetic interface can be provided analogically. The primary conductors (1391a, 1391b) and secondary conductors (not shown) can provide mutual condenser action. The system can be provided in a static/dynamic power transfer system (e.g. similarly as shown in FIGS. 120, 121) and can provide a homogenous electromagnetic field and a freedom of movement of an electric vehicle on an engineering construction [e.g. a charging road, a parking lot, an offshore vessel charging board, etc.] on which the antenna (1392) can be orientable in any direction [e.g. longitudinally, transversely, etc.] and provided in various (switchable) patterns. Analogically a secondary (repeating) antenna coupled with an electric vehicle component can be orientable in respective direction. The primary electrodes (1391a and 1391b) [and respective secondary (repeating) electrodes] can have any form and shape with respect to the shown principle of the invention.

FIG. 81 is a schematic oblique view of another embodiment of the wireless electromagnetic energy transfer system. A primary magnetic element (1400) [which can be U shaped and which can provide a lower reluctance path for a primary circular magnetic flux (only 1403b shown) which can be associated with a primary electric field (only 1403e shown)] and primary conductors (1401a, 1401b) [which can be L shaped] can form a primary electromagnetic interface (1402) which can be couplable with an electrocomponent (not shown) [e.g. an oscillator]. A secondary magnetic element, a secondary conductor couplable with another electrocomponent (not shown) can be provided analogically. The system can be provided in a static/dynamic power transfer system.

FIG. 82 is a schematic oblique view of another embodiment of the wireless electromagnetic energy transfer system. A primary magnetic element (1410) [which can provide a path for circular magnetic fluxes (1413b) associated with an electric field (1413e)] and primary conductors (1411a) [which can have a T-shaped, L-shaped, meandering enlarging elements, etc. and which can have a feeding point] and (1411b) [which can be a ground, a base, etc.] can form a primary electromagnetic interface (1412) [which can have dimensions in relation with a wavelength, e.g. the horizontal upper T part can be a half of a wavelength, etc.]. The primary conductors (1411a, 1411b) can be coupled with an inductor (1414) [which can form part of an impedance matching circuitry] and with an energy source (1415) [which can be an alternating current source which can provide a modulated/unmodulated (power) signal]. A secondary (repeating) electromagnetic interface (not shown) can be provided analogically and can be spaced apart to be able to transfer electromagnetic energy.

FIG. 83 is a schematic oblique view of another embodiment of the wireless electromagnetic energy transfer system. A primary magnetic element (1420) [which can be a one-piece or a multipiece structure having a defined thickness and which can be from a magnetically permeable material/e.g. containing ferrites/etc.] and primary conductors (1421a) [which can have a/regular or irregular/T shaped and meandering enlarging element] and (1421b) [which can be an (earth) ground, a base, a conductive plate, a conductive path/e.g. a rail/, etc.] can form a primary electromagnetic interface array (1422) which can be coupled with an electrocomponent [e.g. an inductor (1424a)/which can be provided with insulation/, another inductor (or switch) (1424b)] and with another electrocomponent (1425) [which can be a transmitter, an energy source, a power source, a defined power source]. The distance between the primary conductors (1421a and 1421b) can be a small fraction of a wavelength. A secondary (repeating) electromagnetic interface (not shown) can be provided analogically, can be differently sized, and can be coupled with an electrocomponent [which can be a receiver], with an electric vehicle component, with a vehicle. The system can be provided in a static/dynamic power transfer system. The primary electromagnetic interface array (1422) can be coupled with an engineering construction [which can be an open ground lane/e.g. a charging road including magnetically permeable surface where the array can be oriented in any way/]. The array can be switchable [e.g. to follow movement of the vehicle]. The vehicle can have freedom of positioning or movement on the road while transferring power. The vehicle can be coupled with the primary conductor (1421b) by means of a parasitic element [e.g. parasitic capacitance between the body/chassis and the ground, by means of wheels/e.g. electric train wheels on a rail/, tires, etc.]. The system can thus provide an unipolar wireless electromagnetic energy transfer system. The system can provide radiative and non-radiative wireless energy transfer. The system can be shielded, insulated, provided in a cloud/fog/edge computing system, etc.

FIG. 84 is a schematic perspective view of another embodiment of the wireless electromagnetic energy transfer system. A secondary electromagnetic interface (1432) can be provided in an enclosure (1438) [which can be of plastic and which can include a transponder for Radio Frequency Identification (RFID) which can be (wirelessly rechargeable) power source powered/e.g. active tags/or not/e.g. passive tags/, etc.]. A primary electromagnetic interface (not shown) can be coupled with an RED reader (not shown).

FIG. 85 is a schematic plan view of another embodiment of the wireless electromagnetic energy transfer system. A primary electromagnetic interface (1442) can be provided in an enclosure (1448) [which can be a charging pad (bowl, basket, etc.) for portable electronics, or a charging board (in-road installation, etc.) for electric vehicles, etc.] which can be couplable with a power source (not shown). A secondary electromagnetic interface (not shown) can be coupled with a load [e.g. an electronic device, an electric vehicle], a rechargeable power source [e.g. a marine rechargeable power source], etc. (not shown).

FIG. 86 is a schematic plan view of another embodiment of the wireless electromagnetic energy transfer system. A primary magnetic element (1450) [which can be a backing plate of various shapes having a thickness] and primary conductors (1451a, 1451b) [which can have 2D modelled/e.g. branched/enlarging elements] can form a primary electromagnetic interface (1452) which can be couplable with an energy source (not shown) [which can be an AC power source of a defined frequency and which can include other electrocomponents/e.g. switching banks and sensor circuits, a compensation circuitry, an inverter, a power factor correction/, etc.]. A secondary electromagnetic interface (not shown) can be provided in a similar way.

FIG. 87 is a schematic plan view of another embodiment of the wireless electromagnetic energy transfer system. A primary magnetic element (1460) [which can be a backing plate of various shapes having a thickness] and primary conductors (1461a, 1461b) [which can have 2D modelled/e.g. branched/enlarging elements] can form a primary electromagnetic interface (1462) which can be couplable with an energy source (not shown). A secondary electromagnetic interface (not shown) can be provided in a similar way.

FIG. 88 is a schematic plan view of another embodiment of the wireless electromagnetic energy transfer system. A primary magnetic element (1470) and primary conductors (1471a, 1471b) [which can have D shape enlarging elements which can or cannot partially overlap and which can have functional openings (1471ao, 1471bo) which can provide antenna tunability and which can provide a path for magnetic fluxes of a primary coupling inductor (1474) and circular magnetic fluxes of the primary conductors (1471a, 1471b); wherein other shapes, forms, proportions, etc. are possible/e.g. a pair of quarter circles, etc./] can form a primary electromagnetic interface (1472). The primary conductor (1471b) can be coupled with the primary coupling inductor (1474) [which can form part of an impedance matching circuitry and which can have various shapes, dimensions, loop numbers, etc.]. The primary electromagnetic interface (1472) can be couplable with an energy source (not shown) and can be provided without the coupling inductor (1474). Condenser action between the primary conductors (1471a, 1471b) can increase self-capacitance. Condenser action can be considered between the primary magnetic element (1470) [which can be a passive component] and the primary conductors (1471a, 1471b) [or a backing shielding (not shown) can be provided] then a six-plate [eight-plate] coupling structure providing an increased self-capacitance and supplementary electric shielding resulting in electric field emission reduction can be obtained. A secondary electromagnetic interface (not shown) can be provided in a similar way.

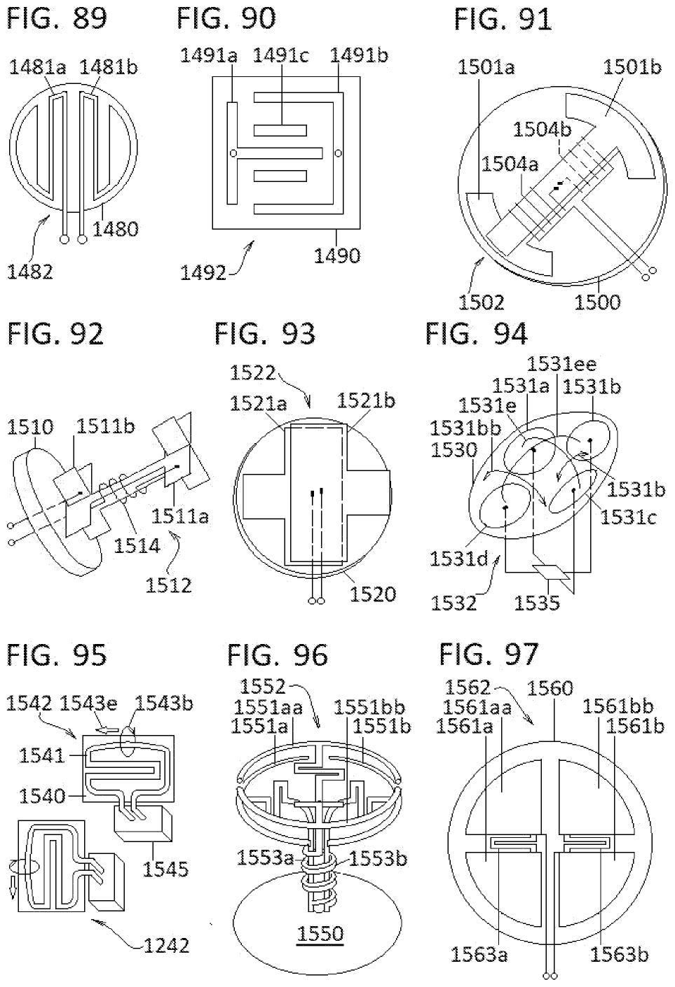

FIG. 89 is a schematic plan view of another embodiment of the wireless electromagnetic energy transfer system. A primary magnetic element (1480) and primary conductors (1481a, 1481b) [which can have meandering and final 2D/or others/enlarging elements and which can be provided with a dielectric layer, mutually insulated, etc.] can form a primary electromagnetic interface (1482) which can be couplable with a power source (not shown) [and with other electrocomponents]. A secondary electromagnetic interface (not shown) can be provided in a similar way. [The primary electromagnetic interface (1482) can be mounted on the top of a floater to form an offshore buoyant (charging) power transfer interface.]

FIG. 90 is a schematic plan view of another embodiment of the wireless electromagnetic energy transfer system. A primary magnetic element (1490) [which can be a magnetic layer, a magnetic substrate, a magnetic printed circuit board, etc.], primary conductors (1491a, 1491b) [which can form a dipole antenna with parasitic (antenna) elements (1491c) which can be located at a predetermined distance which can be much smaller than the wavelength of the center frequency of the excitation signals from the driven primary conductors (1491a, 1491b) to which it can be electromagnetically coupled and which can expand the bandwidth of the system; the lengths of the primary conductors (1491a, 1491b) can be about a quarter wavelength and the lengths of the parasitic (antenna) elements (1491c) can be slightly less] can form a primary electromagnetic interface (1492) which can be couplable with an excitation signal source (not shown) [which can be insulated or formed away from the primary conductors (1491a, 1491b) and the parasitic (antenna) elements (1491c)] at provided feeding points. A secondary (repeating) electromagnetic interface (not shown) can be provided in a similar way. [The primary/secondary/repeating electromagnetic interfaces can be fabricated using printed circuit board fabrication techniques/e.g. can be copper printed circuit elements etched onto a (flexible) printed circuit board, can form phased arrays, etc.]

FIG. 91 is a schematic oblique plan view of another embodiment of the wireless electromagnetic energy transfer system. A primary magnetic element (1500) and primary conductors (1501a, 1501b) [which can have T shaped enlarging elements or others] can form a primary electromagnetic interface (1502). The primary conductors (1501a, 1501b) can be coupled with primary coupling inductors (1504a, 1504b) [which can form part of an impedance matching circuitry, various winding patterns can be used, e.g. with a single primary coupling inductor]. A secondary electromagnetic interface (not shown) can be provided in a similar way.

FIG. 92 is a schematic perspective view of another embodiment of the wireless electromagnetic energy transfer system. A primary magnetic element (1510) [which can provide at least partially a lower reluctance path for primary circular magnetic fluxes (not shown) and which can be differently shaped and positioned] and primary conductors (1511a, 1511b) [which can be two crossed plates having H shaped enlarging elements] can form a primary electromagnetic interface (1512) which can be coupled with a coupling inductor (1514) and which can be couplable with a power source (not shown). A secondary electromagnetic interface (not shown) can be provided in a similar way.

FIG. 93 is a schematic oblique plan view of another embodiment of the wireless electromagnetic energy transfer system. A primary magnetic element (1520) [which can provide a return path for primary circular magnetic fluxes] and primary conductors (1521a, 1521b) [which can have T shaped enlarging elements] can form a primary electromagnetic interface (1522) [which can be couplable with a power source (not shown)]. A secondary electromagnetic interface (not shown) can be provided in a similar way.

FIG. 94 is a schematic perspective view of another embodiment of the wireless electromagnetic energy transfer system. A primary magnetic element (1530) [which can have a curved/e.g. cylindrical/surface] and primary conductors (1531a, 1531b, 1531c, 1531d) [which can be of conductive plates having correspondingly curved surfaces] can form a primary electromagnetic interface (1532). The primary conductors (1531a, 1531b, 1531c, 1531d) can be coupled with an energy source (1535) [which can include a processing unit with a storage medium and programmed to actuate the primary conductors (1531a, 1531b, 1531c, 1531d) in various patterns/e.g. to work in opposite pairs wherein electric fields (1531e, 1531ee) and corresponding circular magnetic fluxes (1531b, 1531bb) can be provided, etc./]. A secondary (repeating) electromagnetic interface (not shown) can be provided analogically or in a monopolar structure or can include only one secondary conductors working pair, etc. The shown embodiment can provide a high degree of rotational and translational (misalignment, offset) freedom between primary and secondary (repeating) electromagnetic interfaces for electromagnetic energy transfer.

FIG. 95 is a schematic oblique view of another embodiment of the wireless electromagnetic energy transfer system. A primary magnetic element (1540) [which can provide a return path for a primary circular magnetic flux (1543b) which can be associated with a primary electric field (1543e) travelling along a wire (1541)] and the primary conductor (1541) [which can have a meandering enlarging element and which can be formed on a magnetically permeable substrate or a film on a substrate which can form the primary magnetic element (1540)] can form a primary electromagnetic interface (1542) which can be coupled with an electrocomponent (1545) [e.g. a transmitter]. A secondary (repeating) electromagnetic interface can be provided in a similar way. [The primary/secondary (repeating) electromagnetic interface can comprise one or more antennas coupled with one or more electrocomponents (e.g. transmitters, receivers, transceivers). The primary/secondary (repeating) antennas can be mutually oriented in various ways/e.g. coplanar, located orthogonal to each other, offset in various degrees, etc./and can be spaced apart so that the respective magnetic elements can be able to transfer circular magnetic fluxes. A pair of primary or secondary electromagnetic antennas having the serpentine enlarging elements can be provided as a primary or secondary dipole antenna with two serpentine elements located orthogonal to each other].

FIG. 96 is a schematic perspective view of another embodiment of the wireless electromagnetic energy transfer system. A primary magnetic element (1550) [which can have different//e.g. cylindric//forms] and primary conductors (1551a, 1551aa, 1551b, 1551bb) [which can have T shaped and meandering enlarging elements and which can be shorter than a half-wavelength] can form a primary electromagnetic interface (1552) [which can be coupled with electrocomponents/e.g. a power source by means of a main feedline (not shown) and phasing lines (or phase shifters) (1553a, 1553b)//e.g. 90-Degree phasing lines which can be shielded//]. A secondary (repeating) electromagnetic interface (not shown) can be provided in a similar way. [Alternatively the embodiment can be composed only of one pair of primary conductors (e.g. 1551a, 1551b) with a phase difference 180° and a (coupling) inductor in place of phasing lines (not shown).].

FIG. 97 is a schematic plan view of another embodiment of the wireless electromagnetic energy transfer system. A primary magnetic element (1560) and primary conductors (1561a, 1561aa, 1561b, 1561bb) can form a primary electromagnetic interface (1562) [which can be coupled with electrocomponents/e.g. a power source (not shown) and phasing lines (or phase shifters) (1563a, 1563b)/]. A secondary (repeating) electromagnetic interface (not shown) can be provided in a similar way. [The embodiment can be planar (as shown) or 3D modelled/e.g. can have flared pyramidal or conical shape enlarging element with straight sidewalls or elliptical, exponential, hyperbolic, etc. sidewalls which can be corrugated/.]

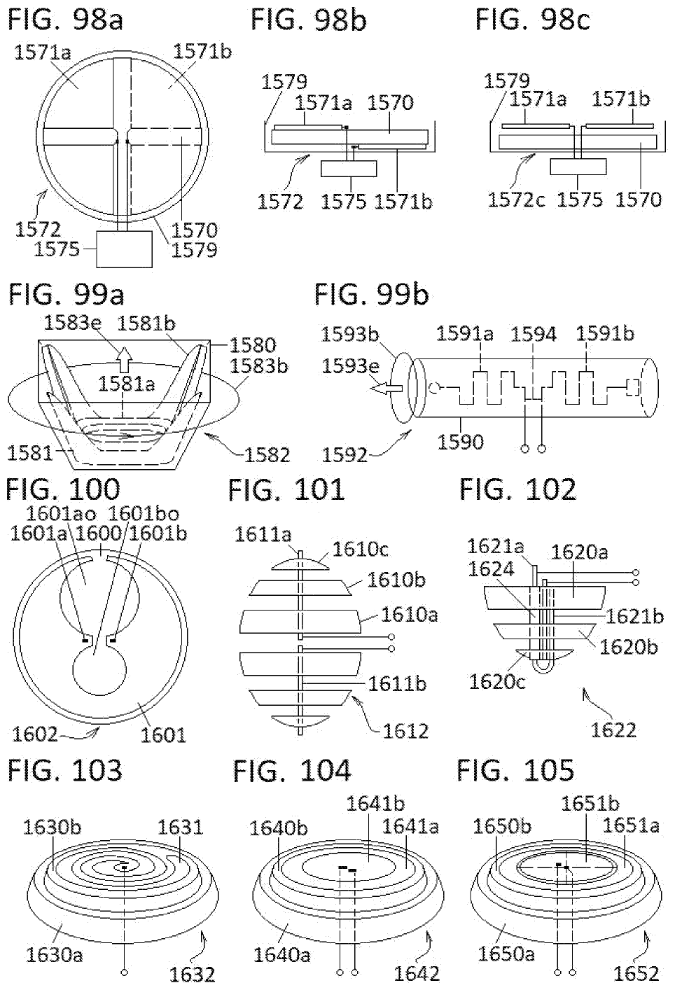

FIG. 98a is a schematic plan view of another embodiment of the wireless electromagnetic energy transfer system. A primary magnetic element (1570) and primary conductors (1571a, 1571b) can form a primary electromagnetic interface (1572) which can be shielded with a shielding (1579) and which can be coupled with a power source (1575) [which can be an alternating current source, etc.]. A secondary magnetic element, a pair of secondary conductors coupled with a load can be provided in a similar way.

FIG. 98b is a schematic side view with a partial cut-off of the embodiment of the wireless electromagnetic energy transfer system shown in FIG. 98a. The primary magnetic element (1570) and the primary conductors (1571a, 1571b) can form the primary electromagnetic interface (1572) which can be coupled with the power source (1575) and shielded with the shielding (1579). The pair of the primary conductors (1571a, 1571b) can provide condenser action [e.g. with a secondary electromagnetic interface (not shown) and with the shielding (1579)].

FIG. 98c is a schematic side view with a partial cut-off of a variant of the embodiment of the wireless electromagnetic energy transfer system shown in FIGS. 98a and 98b. The primary magnetic element (1570) and the primary conductors (1571a, 1571b) can form a primary electromagnetic interface (1572c) which can be coupled with the power source (1575) and shielded with the shielding (1579). The pair of the primary conductors (1571a, 1571b) can provide external condenser action.

FIG. 99a is a schematic perspective view of another embodiment of the wireless electromagnetic energy transfer system. A primary magnetic element (1580) [which can have flared pyramidal shape enlarging element with straight sidewalls or elliptical, exponential, hyperbolic, etc. sidewalls] and a primary conductor (1581) [which can have a base (1581a) and lobes (1581b) enlarging elements] can form a primary electromagnetic interface (1582) [which can provide a primary circular magnetic flux (1583b) which can be associated with a primary electric field (1583e)] and which can be couplable with a power source (not shown) [the primary conductor (1581) can have conveniently placed coupling nodes (not shown)]. A secondary electromagnetic interface can be provided in a similar way.

FIG. 99b is a schematic oblique view of another embodiment of the wireless electromagnetic energy transfer system. A primary magnetic element (1590) [which can have cylindrical, half cylindrical, conical, flat shapes, etc. and which can provide a path for a circular magnetic flux (1593b) associated with an electric field (1593e) (only left side shown)] and primary conductors (1591a, 1591b) [which can have meandering and 2D or 3D modelled enlarging elements and which can be a center-fed antenna or can have feeding points at a same side] can form a primary electromagnetic interface (1592). The primary conductors (1591a, 1591b) can be coupled with a shunt (1594) [which can provide a self-resonant antenna and a (tunable) inductance to match an impedance of an energy source (or a load, or a transmission line) (not shown)]. A secondary electromagnetic interface can be provided in a similar way.

FIG. 100 is a schematic plan view of another embodiment of the wireless electromagnetic energy transfer system. A primary magnetic element (1600) [which can have a flat disc shape and which can be from a magnetically permeable material/e.g. a flexible magnetically permeable polymer substrate containing magnetic materials/and which can at least partially provide a magnetically permeable return path for circular magnetic fluxes (not shown)] and a primary conductor (1601) [which can have two feeding points (1601a, 1601b) and three enlarging elements/e.g. at an upper part on the page crescent shaped protrusions, at a middle part feeding protrusions and at a lower part a coupled inductive shorting shunt; the elements can correspond to two circular functional openings (1601ao, 1601bo) which can provide antenna tunability by changing the dimensions and proportions] can form a primary electromagnetic interface (antenna) (1602) which can be couplable with an electrocomponent [e.g. a transmitter which can provide a modulated signal]. A secondary (repeating) electromagnetic interface couplable with a receiver can be provided analogically.

FIG. 101 is a schematic side view of another embodiment of the wireless electromagnetic energy transfer system. A primary magnetic element [which can be divided into a plurality of subsections (1610a, 1610b, 1610c) which can be coaxial round shaped (sectional) discs] and primary conductors (1611a, 1611 b) can form a primary electromagnetic interface (1612). The primary conductors (1601a, 1601b) [which can be coupled with an inductive shunt (not shown) can be couplable with an electrocomponent (not shown) [e.g. a power source, a compensation, etc.]. A secondary (repeating) electromagnetic interface (not shown) can be provided in a similar way.

FIG. 102 is a schematic side view of another embodiment of the wireless electromagnetic energy transfer system. A primary magnetic element [which can be divided into a plurality of subsections (1620a, 1620b, 1620c) which can be coaxial round shaped discs] and primary conductors (1621a) [which can be U shaped and partially provided with an electromagnetic insulation (shielding) (1624)] and (1621b) can form a primary electromagnetic interface (1622). The primary conductors (1621a, 1621b) can be couplable with an electrocomponent (not shown). A secondary electromagnetic interface (not shown) can be provided in a similar way.

FIG. 103 is a schematic perspective view of another embodiment of the wireless electromagnetic energy transfer system. A primary magnetic element [which can be divided into a plurality of subsections (1630a, 1630b)] and a primary conductor (1631) [which can have a spiral enlarging element or a full circle or two (partially superposed and mirror placed) spiral conductors with central feeding points, etc.] can form a primary electromagnetic interface (1632) which can be couplable with an electrocomponent (not shown). A secondary (or another primary) [e.g. in a working pair] electromagnetic interface (not shown) can be provided in a similar way.

FIG. 104 is a schematic perspective view of another embodiment of the wireless electromagnetic energy transfer system. A primary magnetic element [which can be divided into a plurality of subsections (1640a, 1640b)] and primary conductors (1641a, 1641b) [which can be partially superposed to increase self-capacitance] can form a primary electromagnetic interface (1642) which can be couplable with an energy source (not shown), etc. Since the primary conductors (1641a, 1641b) can be coaxial, concentric, center aligned, etc., the primary electromagnetic interface (1642) can be robust to angular misalignment and since the primary conductors (plates, electrodes, antennas, etc.) (1641a, 1641b) can have substantially circular shape, an angular rotation can have minor influence to provided external condenser action (mutual capacitances). A secondary (repeating) electromagnetic interface (not shown) can be provided in a similar way. [Proposed compact interface systems can be applied to compact power interface applications/e.g. electric vehicles, vessels charging, portable electronics charging, signal/power repeating systems, sensor circuits, etc.]

FIG. 105 is a schematic perspective view of another embodiment of the wireless electromagnetic energy transfer system. A primary magnetic element [which can be divided into a plurality of subsections (1650a, 1650b)] and primary conductors (1651a) [which can have a ring shaped enlarging element with connection lines] and (1651b) [which can have a concentric round shaped enlarging element] can form a primary electromagnetic interface (1652). A secondary (repeating) electromagnetic interface (not shown) can be provided in a similar way.

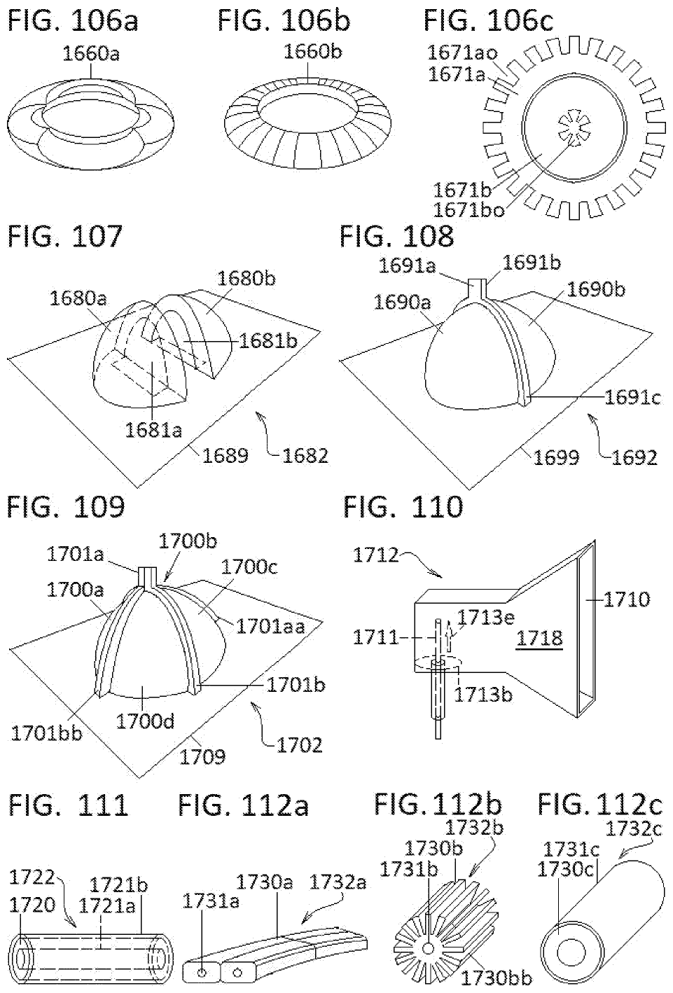

FIG. 106a is a schematic perspective view of an example of shaping a primary/secondary (repeating) magnetic element (1660a) [which can have 3D modelled enlarging elements].

FIG. 106b is a schematic perspective view of an example of shaping a primary/secondary (repeating) magnetic element (1660b) [which can be disc shaped and composed of a plurality of (mutually magnetically insulated) subsections].

FIG. 106c is a schematic plan view of an example of shaping primary/secondary (repeating) conductors (1671a, 1671b) [which can have star-shaped functional (tuning) openings (1671ao, 1671bo) corresponding with adjacent enlarging elements].

FIG. 107 is a schematic perspective view of another embodiment of the wireless electromagnetic energy transfer system. Primary magnetic elements (1680a, 1680b) [which can be of ferrites] and primary conductors (1681a, 1681b) [which can be of copper and which can be provided in different patterns/e.g. bars, bow, stripes, concentric patterns, symmetrical, asymmetrical layouts, meshes, etc.] can form a primary electromagnetic interface (1682) which can be shielded with a shielding (1689) [which can be of copper]. The primary conductors (1681a, 1681b) can be couplable with electrocomponents (not shown). Condenser action between the primary conductors (1681a, 1681b) can increase self-capacitance. A secondary (repeating) electromagnetic interface (not shown) can be provided in a similar way.

FIG. 108 is a schematic perspective view of another embodiment of the wireless electromagnetic energy transfer system. Primary magnetic elements (1690a, 1690b) and primary conductors (1691a, 1691b) [which can be provided with a dielectric layer (1691c)] can form a primary electromagnetic interface (1692) which can be shielded with a shielding (1699) [which can be of aluminium]. The primary conductors (1691a, 1691b) can be couplable with electrocomponents (not shown). Condenser action between the primary conductors (1691a, 1691b) can increase self-capacitance. A secondary (repeating) electromagnetic interface (not shown) can be provided in a similar way. [The embodiment can be used as a sensor.]

FIG. 109 is a schematic perspective view of another embodiment of the wireless electromagnetic energy transfer system. Primary magnetic elements (1700a, 1700b, 1700c, 1700d) and primary conductors (1701a, 1701aa, 1701b, 1701bb) can form a primary electromagnetic interface (1702) which can be shielded with a shielding (1709). The primary conductors (1701a, 1701aa, 1701b, 1701bb) can form a crossed dipole [or the primary conductors (1701a, 1701aa, 1701b, 1701bb) can be provided in one piece forming a monopole antenna or in two pieces forming a dipole antenna] couplable with an electrocomponent (not shown) [e.g. a phasing line, phase shifter, transmitter, etc.]. A secondary electromagnetic interface (not shown) can be provided in a similar way and coupled with convenient electrocomponents [e.g. a receiver, transceiver, etc.]

FIG. 110 is a schematic perspective view of another embodiment of the wireless electromagnetic energy transfer system. A primary magnetic element (1710) [which can have flared pyramidal (or conical) enlarging element with straight sidewalls or elliptical, exponential, hyperbolic, etc. sidewalls/or which can have parabolic, hemi-spheric, etc. enlarging element/and which can be from a (highly) magnetically permeable material/e.g. permalloy, supermalloy, sendust, mu-metal, ferrites, etc./which can have a depth at least 1 times the skin depth of (electric, magnetic) fields] which can be provided in a layered/laminated/structure on a support layer (1718) [which can have a lower magnetic permeability and which can be metallic/e.g. from steel, aluminium, copper, etc./or dielectric/e.g. polymers, plastic, fiberglass, etc./] and a primary conductor (1711) [which can be a feed rod/or a half-wave dipole, hom-type, circularly polarised feed for parabolic antennas with focal, Cassegrain, Gregorian, off axis feed systems, etc./and which can be coupled with a coaxial/or parallel/wire system] can form a primary electromagnetic antenna (1712) [which can be a sectoral/H-plane, E-plane/, conical, exponential, corrugated, dual-mode conical, diagonal, (quad) ridged, septum, aperture-limited, pyramidal, etc. (transmitting) hom antenna/which can be composed of a hom or of the horn with a hollow pipe (waveguide) and which can provide a primary circular magnetic flux (1713b) which can be associated with a primary electric field (1713e) and wherein an inner space can contain air, other gas or it can be evacuated] and which can be provided with an insulation (not shown) [e.g. an waterproof insulation at a mouth of the antenna (1712)] and which can be couplable with a signal source (not shown) [e.g. an ultra-high frequency signal source]. A secondary electromagnetic (receiving) hom antenna couplable with a receiver can be provided in a similar way. [The shown principle of the invention comprising primary/secondary/repeating magnetic elements (layers) providing a lower reluctance path for circular magnetic fluxes can be similarly provided in electromagnetic septum antennas, parabolic reflector antennas, electromagnetic waveguides, etc.]

FIG. 111 is a schematic perspective view of another embodiment of the wireless electromagnetic energy transfer system. A primary magnetic element (1720) and primary conductors (1721a, 1721b) can form a primary electromagnetic interface (1722). The primary conductors (1721a, 1721b) can be couplable with an electrocomponent (not shown). [The primary conductors (1721a, 1721b) can be electrically insulated and the primary electromagnetic interface (1722) can be flexible and transversely divisible. A second layer of a primary magnetic element can be provided on the primary conductor (1721b) (not shown).]

FIG. 112a is a schematic perspective view of another embodiment of the wireless electromagnetic energy transfer system. A primary magnetic element (1730a) [which can be flexible and which can be fabricated from polymers containing magnetic materials and which can provide electrical insulation] and primary conductors (1731a) [which can be flexible/e.g. fabricated from stranded wires, etc./] can form a primary electromagnetic interface (1732a) [which can be flexible and which can be provided with an insulation/e.g. thermal/and a shielding and which can be lengthwise and/or transversely divisible].

FIG. 112b is a schematic perspective view of another embodiment of the wireless electromagnetic energy transfer system. A primary magnetic element (1730b) [which can have fins enlarging elements (1730bb) or can be structured in another convenient way to provide a path for circular magnetic fluxes and which can be flexible] and a primary conductor (1731b) [which can be flexible] can form a primary electromagnetic interface (1732b) [which can be flexible and divisible].

FIG. 112c is a schematic perspective view of a variant of the embodiment shown in FIG. 112b. A primary magnetic element (1730c) [which can have enlarging elements (not shown) and which can be flexible] and a primary conductor (1731c) [which can have a cylindrical enlarging element and which can be flexible] can form a primary electromagnetic interface (1732c) [which can be flexible and divisible].

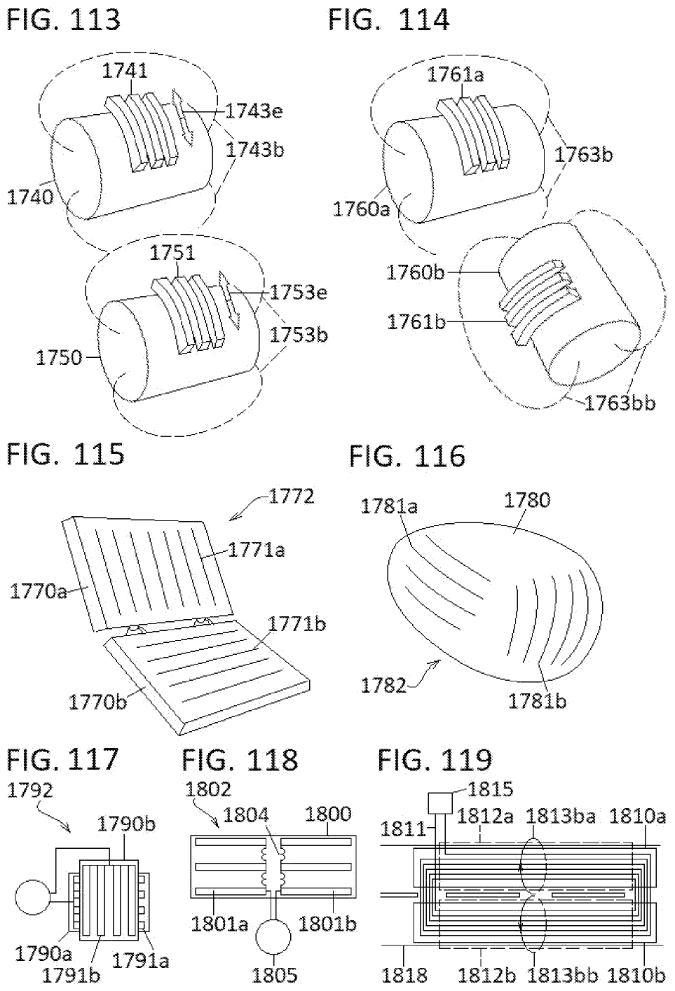

FIG. 113 is a schematic perspective view of another embodiment of the wireless electromagnetic energy transfer system. The system can comprise a primary magnetic element (1740) and a secondary magnetic element (1750) spaced apart from each other to transfer one or more circular magnetic fluxes (1743b, 1753b) which can be associated with electric fields (1743e, 1753e). Primary conductors (1741) can be partially disposed at the primary magnetic element (1740) to create the circular magnetic fluxes (1743b) which can create the circular magnetic fluxes (1753b) to wirelessly transfer electromagnetic energy from the primary conductors (1741) [which can be coupled with an energy source/e.g. an alternating current source/(not shown)] to secondary conductors (1751) [which can be coupled with a load/e.g. an electronic (power) device/, another electrocomponent/e.g. a circuit, a source management system, etc./(not shown)] at least partially disposed at the secondary magnetic element (1750) and/or vice versa [e.g. in case of bidirectional configuration, i.e. bidirectional electrocomponents, etc.]. The primary conductors (1741) can be alternately charged positive and negative from an alternating energy source (not shown) or can be charged in high amplitudes and discharged in low amplitudes [e.g. in case the electrocomponent can be a power amplifier, etc.] or the amplitude can be represented by variable-width pulses [e.g. the electrocomponent can be a pulse width modulation converter], etc.

FIG. 114 is a schematic perspective view of another embodiment of the wireless electromagnetic energy transfer system. The system can comprise primary magnetic elements (1760a, 1760b) and a secondary magnetic element (not shown) spaced apart from each other to transfer at least partially or at least substantially one or more primary circular magnetic fluxes (1763b, 1763bb). Primary conductors (1761a, 1761b) can be partially disposed at the respective primary magnetic elements (1760a, 1760b) to create the primary circular magnetic fluxes (1763b, 1763bb) which can create secondary circular magnetic fluxes (not shown) to wirelessly transfer electromagnetic energy from the primary conductors (1761a, 1761b) to secondary conductors (not shown). The primary conductors (1761a, 1761b) [which can be located orthogonal to each other] can be alternately charged positive and negative from an alternating energy source (not shown) or can be charged in high amplitudes and discharged in low amplitudes or the amplitude can be represented by variable-width pulses and can be coupled with an electrocomponent [e.g. a source of (first and second) excitation signals/which can be the same, 90°, 180° out of phase/, a phasing line, etc.]. A secondary (repeating) electromagnetic interface system can be provided analogically. The primary and secondary (repeating) electromagnetic interfaces can be provided in various positions, angles and distances to model a surrounding electromagnetic field providing circular magnetic fluxes and to be able to transfer energy.

FIG. 115 is a schematic perspective view of another embodiment of the wireless electromagnetic energy transfer system. The system can comprise primary magnetic elements (1770a, 1770b) with primary conductors (1771a, 1771b) which can be partially disposed at the respective primary magnetic elements (1770a, 1770b) [e.g. in a proximity on a coupling side and at least partially oriented orthogonal to each other] to form a primary electromagnetic interface (1772) [which can be couplable with an energy source, other electrocomponents (which can be provided inside an enclosure), etc.]. A secondary (repeating) electromagnetic interface system can be provided analogically. An angle between the primary magnetic elements (1770a, 1770b) can be variable to model surrounding circular electromagnetic fields.

FIG. 116 is a schematic perspective view of another embodiment of the wireless electromagnetic energy transfer system. The system can comprise primary magnetic element (1780) with primary conductors (1781a, 1781b) which can be partially disposed in (and/or at) the primary magnetic element (1780) to form a primary electromagnetic interface (1782) [which can be couplable with an energy source, other electrocomponents, etc. (not shown)]. A secondary (repeating) electromagnetic interface system can be provided analogically.

FIG. 117 is a schematic plan view of another embodiment of the wireless electromagnetic energy transfer system. The system can comprise primary magnetic elements (1790a, 1790b) [either of them can be differently shaped or omitted, etc.] with primary conductors (1791a, 1791b) which can form a primary electromagnetic interface (1792) which can be coupled with an electrocomponent (1795). A secondary (repeating) electromagnetic interface system can be provided analogically. The primary magnetic elements (1790a, 1790b) and respective secondary magnetic elements (not shown) can be disposed (inclined, rotated, etc.) in accordance with energy (or data transmission) transfer demands of a particular system.

FIG. 118 is a schematic plan view of another embodiment of the wireless electromagnetic energy transfer system. The system can comprise a primary magnetic element (1800) with primary conductors (1801a, 1801b) which can form a primary electromagnetic interface (1802) which can be coupled with an electrocomponent (1805) [e.g. an oscillator]. The primary conductors (1801a, 1801b) can be coupled with other electrocomponents (1804) [e.g. a compensation network/which can include distributed inductance/, distributed filter banks, etc.]. A secondary (repeating) electromagnetic interface system can be provided analogically.

FIG. 119 is a schematic oblique plan view of another embodiment of the wireless electromagnetic energy transfer system. The system can comprise primary magnetic elements (1810a, 1810b) [which can be provided in one-piece or multipiece structure/e.g. transversely or longitudinally parallel bars, plates, etc., and which can provide a return path for circular magnetic fluxes (1813ba, 1813bb)] with a primary conductor (1811) which can form primary electromagnetic interfaces (1812a, 1812b) which can be couplable with an engineering construction (1818) [e.g. a road including traffic lanes] and which can be coupled with a defined power source (1815) [e.g. an onshore static/dynamic charging station]. The primary conductor (1811) can be coupled with electrocomponents (not shown) [e.g. a compensation network, etc.]. A secondary (repeating) electromagnetic interface which can be coupled with an electric vehicle (not shown) can be provided analogically as shown in FIG. 118.

FIG. 120 is a schematic plan view of another embodiment of the wireless electromagnetic energy transfer system provided in an onshore static/dynamic power transfer system. Primary magnetic elements (1820a, 1820b) and primary conductors (1821a, 1821b) can form primary working pairs and can form a primary electromagnetic interface (1822) which can be couplable with an engineering construction (not shown) [e.g. a road or a portion of the road, a traffic lane, etc.] and which can be coupled with a defined power source (1825) [which can provide radio frequency energy]. A secondary magnetic element (1830) and secondary conductors (1831a, 1831b) can form secondary working pairs and can form a secondary electromagnetic interface (1832) which can be couplable with an electric vehicle component [e.g. a body/chassis] and with a vehicle (1837) [e.g. an electric vehicle]. Secondary magnetic elements (1840a, 1840b) and secondary conductors (1841a, 1841b) can form secondary working pairs and can form a secondary (repeating) electromagnetic interface (1842) which can be couplable with an electric vehicle component (not shown) [e.g. wheels or tires] and with a vehicle (1847) [e.g. another electric vehicle]. Secondary magnetic elements (1850a, 1850b) and secondary conductors (1851a, 1851b) can form secondary working pairs and can form a secondary (repeating) electromagnetic interface (1852) [which can be of elastic materials/e.g. elastic magnetic materials and elastic conductive paths/] which can be couplable with an electric vehicle component (not shown) [e.g. a pair of tires] and with a vehicle (1857) [e.g. an electric motorcycle]. [The primary and secondary elements can be shielded, insulated, provide bidirectional energy flow, wireless data transmissions, be provided in cloud/for/edge computing systems, etc.]

FIG. 121 is a schematic oblique side view of another embodiment of the wireless electromagnetic energy transfer system provided in an onshore/offshore static/dynamic power transfer system. Primary magnetic elements (1860a, 1860b) and primary conductors (1861a, 1861b) can form primary working pairs and can form a primary electromagnetic interface (1862) [which can be a level adjustable offshore power transfer interface provided at about water level and under water level, etc.] which can be couplable with a defined power source (1865) [e.g. an offshore/onshore power transfer system]. Secondary magnetic elements (1870a, 1870b) and secondary conductors (1871a, 1871b) can form secondary working pairs and can form a secondary electromagnetic interface (1872) [which can be provided at about water level] which can be couplable with an offshore vessel (1877) [which can be an electric boat]. Other secondary magnetic elements (1880a, 1880b) and secondary conductors (1881a, 1881b) can form secondary working pairs and can form another secondary electromagnetic interface (1882) [which can be provided (temporarily) under water level] which can be couplable with an offshore vessel (1887) [which can be an underwater drone]. Similarly as shown in FIG. 120, the system can be provided in an onshore static/dynamic power transfer system wherein primary elements can be coupled with an open ground lane [e.g. rails] where an electric vehicle [e.g. an electric train or tramway] can ride/be stationary/towed and secondary elements can be coupled with body/chassis (or wheels) of the electric train.

FIG. 122 is a schematic oblique frontal view of another embodiment of the wireless electromagnetic energy transfer system which can be provided in an onshore/offshore static/dynamic power transfer system (e.g. similar as shown in FIGS. 120, 121). A primary magnetic element (1890) [which can have grooves similarly as shown in FIG. 123 on a frontal coupling side] and primary conductors (1891a, 1891b) [which can have various shapes, forms, etc.] can form primary working pairs [groups, networks, etc.] and can form a primary electromagnetic interface (1892) [which can be prolongated in a direction of the primary conductors (1891a, 1891b) similarly as shown in FIGS. 120, 121 and/or which can form a switchable cell following movement of an electric vehicle or an offshore vessel]. The primary electromagnetic interface (1892) [which can provide a primary circular magnetic flux (1893b) which can be associated with a primary electric field (1893e)] can be shielded from a back non-coupling side with a shielding (1899) and can be couplable with a defined power source (not shown). Secondary magnetic elements and secondary conductors can analogically form secondary working pairs and a secondary electromagnetic interface (not shown) which can be couplable with a vehicle (not shown) [e.g. an electric vehicle, an offshore vessel, etc.].

FIG. 123 is a schematic sectional view of another embodiment of the wireless electromagnetic energy transfer system which can be provided in an onshore/offshore static/dynamic power transfer system (e.g. similarly as shown in FIG. 121). Primary magnetic elements (1900a, 1900b) and primary conductors (1901a, 1901b) [which can follow various patterns/e.g. direct parallel on a coupling side, meandering on a coupling side, substantially horizontal loops, etc./] can form primary working pairs and can form a primary electromagnetic interface (1902) which can be coupled with a defined power source (1905). A secondary magnetic element (1910) [which can be divided into insulated subsections (not shown)] and secondary conductors (1911a, 1911b) [which can be wound analogically] can form secondary working pairs and can form a secondary electromagnetic interface (1912) which can be couplable with a vehicle (1917) [e.g. an electric vehicle or an offshore vessel].

FIG. 124 is a schematic sectional view of another embodiment of the wireless electromagnetic energy transfer system which can be provided in an onshore/offshore static/dynamic power transfer system (e.g. similar as shown in FIG. 121). A primary electromagnetic interface (1922) [which can be coupled with an open/covered ground lane/e.g. a live rail of a railway system/or an offshore buoyant primary power transfer interface, etc.] can be couplable with a defined power source (not shown). Secondary magnetic elements and secondary conductors can form secondary working pairs and a secondary electromagnetic interface (1932) which can be couplable with a vehicle (not shown) [e.g. an electric train or an offshore electric vessel]. [A relative mutual movement of the primary and secondary electromagnetic interfaces (1922, 1932) in a dynamic power transfer can be into and out of the page.]

FIG. 125a is a schematic perspective view of another embodiment of the wireless electromagnetic energy transfer system. A primary magnetic element with primary conductors can form a primary electromagnetic interface (1942) [which can be provided similarly as shown in FIG. 116 and which can be couplable with an energy source, other electrocomponents, etc. (not shown)]. One (or more) secondary (repeating) electromagnetic interfaces (1952) [which can be of adequately sized elements including compatible electrocomponents and can be conveniently oriented with a relative high degree of orientation and misalignment freedom] can be coupled with a load (not shown) [e.g. consumers electronics, etc.] and can be spaced apart from the primary electromagnetic interface (1942) to be able to wirelessly transfer energy. [The wireless electromagnetic energy transfer can include light which can show where energy can be provided/e.g. the elements can provide an aperture or can be transparent and the system can include a light source/].

FIG. 125b is a schematic perspective view of another embodiment of the wireless electromagnetic energy transfer system. A primary magnetic element with primary conductors can form a primary electromagnetic interface (1962) (which can be provided similarly as shown in FIG. 116) and which can be couplable with an energy source (not shown) and which can be coupled with an electrocomponent (1965) [which can be an antenna]. Energy transfer can take place below a surface (1968) [which can be a water level, a ground surface, a water bottom, or another surface] and the wireless electromagnetic energy transfer system can be coupled with an interface (1965) [which can be a water-air/e.g. sea water-air, underground-water,//e.g. sea bed sea water//interface/provided by the antenna (1965)]. Secondary (repeating) electromagnetic interfaces (not shown) can be coupled with loads [e.g. onshore/offshore electronic/power applications which can include electrocomponents/e.g. antennas, receivers, transponders, etc.] and can be spaced apart from the primary electromagnetic interface (1962) to be able to wirelessly transfer energy [which can include wireless data transmission].

FIG. 126 is a schematic perspective view of another embodiment of the wireless electromagnetic energy transfer system. A primary magnetic element with primary conductors can form a primary electromagnetic interface (1972) which can be couplable with an energy source (not shown) [which can be an internal or external energy source] and the wireless electromagnetic energy transfer system can be coupled with an interface (1978) [which can be an air-solid-air interface] which can be provided by a glass table [e.g. a window glass]. A secondary (repeating) electromagnetic interface (1982) can be coupled with an electrocomponent (not shown) [e.g. a home alarm circuit which can include a power source, a buzzer, a speaker, optical, acoustical, vibration sensors, a controller, another antenna, etc.]. The primary and secondary electromagnetic interfaces (1972, 1982) can provide wireless electromagnetic energy transfer which can be sensed by a sensing circuit providing information to a controller activating a buzzer, sending (wiredly or wirelessly) a message, etc. in case when the energy transfer can be disrupted or can change parameters [e.g. in case of breaking, opening, shifting, etc. the glass table (1978)]. The primary and secondary electromagnetic interfaces (1972, 1982) can be provided in any form as shown in various embodiments including transparent interfaces, primary/secondary (repeating) conductors and primary/secondary (repeating) magnetic elements.

The elements can be in a form of layers wherein the sensing circuit can sense changements in parameters connected with the layers [e.g. a disruption, deformation, change of size of a layer resulting in a change in parameters of e.g. tuned circuits, etc., and the embodiments can be provided in a form of a foil wrapped around a merchandise in an anti-theft device which can include discrete electrocomponents/e.g. an ASIC/in a conveniently slim enclosure coupled with the foil, etc.]. The primary and secondary electromagnetic interfaces can be attached, coupled, joined, supported, etc. in various forms according to specific applications [e.g. coupled to a window frame, suspended in a free space, etc.].

Various contemplated embodiments coupled with an alarm can have various degrees of directivity. Embodiments as shown e.g. in FIG. 116 and analogical can provide omnidirectional radiation pattern of (dual orthogonal sense linear or circularly polarised) electromagnetic fields, while embodiments as shown in FIG. 33b and analogical can provide highly directive radiation pattern. The transparent embodiments provided in a form of layers can provide discreet embodiments of the invention. Primary and secondary electromagnetic interfaces can be coupled with one or more electrocomponents [e.g. circuits, energy sources, processors, etc.]

[The interface (1978) can represent an electric vehicle window and the system can be used for wireless (charging) energy transfer through the (rear bay) window.]

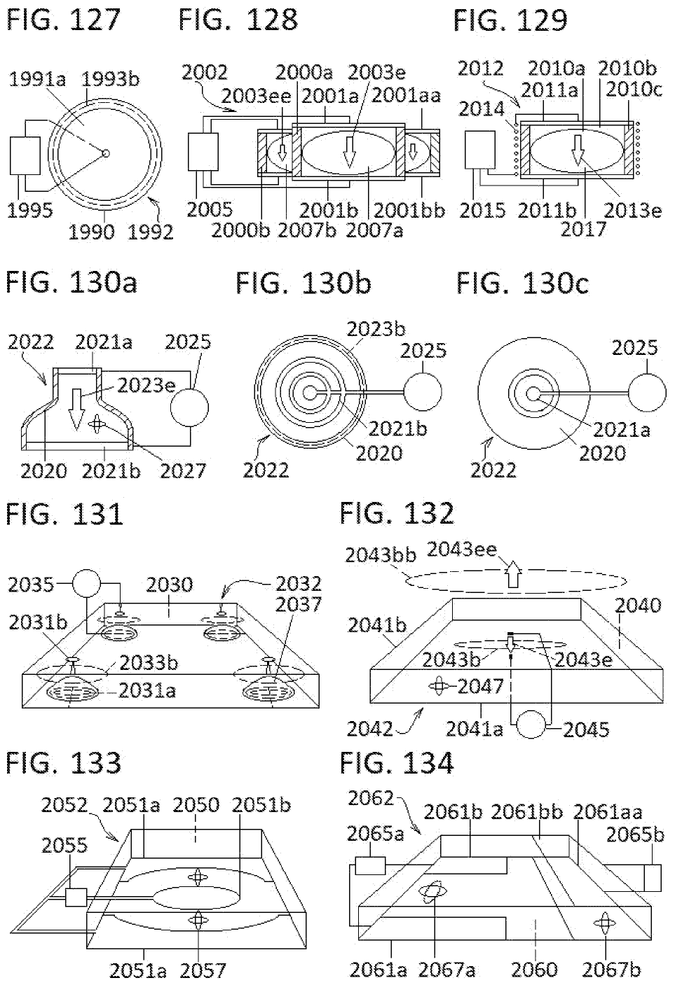

FIG. 127 is a schematic plan view of another embodiment of the wireless electromagnetic energy transfer system. A primary magnetic element (1990) [which can be circular, elliptical, or other shape and which can provide a path for a primary circular magnetic flux (1993b) which can be associated with a primary electric field (not shown) which can be perpendicular to the page and which can be fabricated/e.g. by directing pulsed laser radiation, drilling, photopolymerisable material radiation curing techniques, etc./of transparent magnetic layer and whose surface profiles can be a portion of a cylinder, a sphere, etc.] and primary conductors (1991a) (a bottom primary conductor not shown) [which can be of a transparent conducting layer/e.g. Indium Tin Oxide (ITO)] can form a primary electromagnetic interface (1992) [an inner space can be sealed and filled with polymer dispersed liquid crystals which can form (micro-) lenses (not shown) which can be tunable in the primary electric field (not shown)] which can be coupled with an energy source (1995) [which can provide a direct current (DC) voltage or an alternating current (AC) (signal) voltage, e.g. a small voltage up to 20V or higher]. The pair of the primary conductors (only 1991a shown) can generate internal and external electric fields and provide internal and external condenser actions.

FIG. 128 is a schematic sectional side view of another embodiment of the wireless electromagnetic energy transfer system. Primary magnetic elements (2000a, 2000b) [which can have various dimensions and which can provide paths for primary circular magnetic fluxes (not shown, similarly as in FIG. 127) which can be associated with primary electric fields (2003e, 2003ee)] and primary conductors (2001a, 2001aa, 2001b, 2001bb) [which can be of transparent conducting layers forming concentric conductive traces (not shown) of various patterns with parameters according to demands/e.g. on flatness at a lens center, on voltage distribution along the primary/secondary (repeating) conductor for obtaining linear or parabolic voltage profiles, etc./] can form a primary electromagnetic interface (2002) [inner spaces can be filled with polymer dispersed liquid crystals which can form (multifocal) lenses (2007a, 2007b) in the primary electric fields (2003e, 2003ee)] and which can be coupled with an energy source (2005) [which can provide a direct current (DC) voltage or an alternating current (AC) voltage; a force upon the lenses (2007a, 2007b) can be generated upward or downward depending on the polarity of the voltage].

FIG. 129 is a schematic sectional side view of another embodiment of the wireless electromagnetic energy transfer system. Primary magnetic elements (2010a) [which can be a magnetic liquid crystal (e.g. a liquid crystalline host)], (2010b) [which can be a magnetic polymer], (2010c) [which can be magnetic transparent/nontransparent boundary walls] which can provide paths for primary circular magnetic fluxes (not shown) which can be associated with a primary electric field (2013e)] and primary conductors (2011a, 2011b) [which can be of a transparent conducting layer, concentric conductive traces (not shown) of various patterns, etc.] can form a primary electromagnetic interface (2012) [an inner space can be filled with the polymer dispersed liquid crystals which can form lenses (2017) (and/or become oriented) in the primary electric field (2013c)]. The primary conductor (2011a) can be coupled with a primary coupling inductor (2014) [which can have one or more loops] which can be coupled with an energy source (2015) [which can provide an alternating current (AC) (signal) voltage of a defined frequency and which can include electrocomponents/e.g. an impedance matching circuitry wherein the coupling inductor (2014) can form a part of a compensation/]. The pair of the primary conductors (2011a, 2011b) can provide condenser action [e.g. in a form of self-capacitance and mutual capacitance].

FIG. 130a is a schematic sectional side view of another embodiment of the wireless electromagnetic energy transfer system. A primary magnetic element (2020) [which can provide a path for a primary circular magnetic flux (not shown) which can be associated with a primary electric field (2023e) and which can be fabricated of a transparent magnetic layer and whose surface profiles can be a portion of a sphere, a cylinder, an asphere, an irregular shape, etc.; and which can provide a pinhole effect] and primary conductors (2021a, 2021b) [which can be of a patterned transparent conducting layer on a transparent substrate] can form a primary electromagnetic interface (2022) [an inner space can be filled with polymer dispersed liquid crystals/e.g. having a positive dielectric constant anisotropy/which can have directors (2027) which can become oriented in the primary electric field (2023e) /or having a negative dielectric anisotropy which can become oriented perpendicularly to the primary electric field (2023e)] which can be coupled with an energy source (2025) [which can provide a direct current (DC) voltage or an alternating current (AC) voltage].

FIG. 130b is a schematic plan view of the embodiment shown in FIG. 130a. The primary magnetic element (2020) [which can provide a path for circular magnetic flux (2023b)] and the primary conductor (2021b) [which can form concentric electrodes of various patterns with connection lines] can form the primary electromagnetic interface (2022) which can be coupled with the energy source (2025).

FIG. 130c is another schematic plan view (shown from an opposite side of FIG. 130b) of the embodiment shown in FIG. 130a. The primary magnetic element (2020) and the primary conductor (2021a) [which can form a round shaped center electrode] can form the primary electromagnetic interface (2022) which can be coupled with the energy source (2025).

FIG. 131 is a schematic perspective view of another embodiment of the wireless electromagnetic energy transfer system. A primary magnetic element (2030) [which can be of a transparent magnetic material/e.g. polymer containing magnetic particles, transparent ferrites, mixtures, etc./] can provide a path for circular magnetic fluxes (2033b) which can be associated with an electric field between primary conductor layers (2031a, 2031b) [which can be provided with an insulating layer (not shown)/e.g. silicon nitride (SiNx), silicon oxide (SiOx), etc./and which can be of transparent conducting layers/e.g. Indium Tin Oxide (ITO), etc./forming concentric conductive traces of various patterns, which can be provided on a substrate/e.g. glass, polycarbonate, acrylic plastic, etc./] can form a primary electromagnetic interface array (2032) [which can be provided in a form of a (rigid or flexible) panel (which can provide an optical layer, a collimator layer, a diffuser layer, a screen, a holographic optical layer, etc.) and wherein an inner space can be filled with polymer dispersed liquid crystals which can form lenses (2037) in the provided circular electromagnetic field]. The primary conductor layers (2031a, 2031b) can be coupled with an electrocomponent (2035) (only one connection shown) [e.g. an alternating voltage or direct voltage source]. Light can be incident from one or more directions [e.g. from upper or lower side, lateral sides, etc.]. Light can be unpolarized, linearly-polarized, circular polarized. A force upon the lenses (2037) can be generated upward or downward depending on the polarity of the voltage. The lenses can be modelled by the electromagnetic field, the applied voltage, a primary and secondary conductor electrodes shape, a distance between the electrodes, used materials, liquid crystal types, etc. The lenses can have symmetrical, asymmetrical, polygonal, free modelled, ogival, convex, concave, aspheric, quadric. etc. surfaces. In one array the lenses can have the same or different shapes. Spacings between lenses can have varied, adjacent or abutting relationships, the lenses can overlap/uniformly or randomly/by predetermined amounts in various directions. The lenses can be made of a variety of transparent materials and set in various patterns/e.g. in rows, columns, shifted rows, shifted columns, hexagonal, pentagonal, square, etc./with various fill factors, the patterns can be randomized and the lenses can form matrices. Arrays can include replications of patterns. Lens height against lens radius of curvature can be varied. Above mentioned lens arrays properties with lenses size and lenses number per unit (e.g. pixel)/which can achieve oversampling/can influence various optical parameters [e.g. image quality, gain, viewing angle which can be controlled in a plurality of directions], unwanted image artifacts can be reduced or eliminated.

FIG. 132 is a schematic perspective view of another embodiment of the wireless electromagnetic energy transfer system. A primary magnetic element (2040) which can be of a transparent magnetic material/e.g. polymer/which can provide a path for internal circular magnetic fluxes (2043b) which can be associated with an internal electric field (2043e) between primary conductor layers (2041a, 2041b) [which can be provided in a form of a (patterned) plate electrode or its portions and which can be fabricated of (transparent) conducting layers/e.g. Indium Tin Oxide (ITO)/or Au, Ag, Al, Cu, Ti, alloys, p-doped silicon, graphene, or another conductive coating and which can be provided on a substrate/e.g. glass, polycarbonate, acrylic plastic, fused silica, silicon wafers, ceramics, polished metal surfaces//various metals can serve as primary/secondary electrodes//or any flat surface, etc./and which can be provided with an insulation/e.g. electric/, a shading and a shielding of a visible light and which can be provided in relation with a pixel. The primary electrodes can include slits, and be coupled with protrusions, banks, projections, cones, pyramids, ridges, etc. which can be of an electrically insulating material or magnetically permeable material, etc. Such slits and protrusions can shape magnetic field to orient liquid crystalline molecules in a desired direction when a voltage between primary electrodes can be applied.] The plate electrodes (2041a, 2041b) can provide external primary circular magnetic fluxes (2043bb) which can be associated with an external primary electric field (2043ee). The primary magnetic element (2040) and the primary conductor layers (2041a, 2041b) can form a primary electromagnetic interface (2042) which can be provided in a form of a (rigid or flexible) panel (optical layer, diffuser layer, etc.) and wherein an inner space can be filled with polymer dispersed liquid crystal molecules (2047) (only one shown) [which can become oriented in the electromagnetic field, the lateral walls can be provided of transparent (translucent) material to provide an optical path for light which can be incident from one or more directions/e.g. from any frontal side which can be transparent/and which can be linearly (or circularly) polarized and which can have transverse magnetic (TM) and transverse electric (TE) polarisations] and the shown embodiment can be used as a wave guide, a (polarized) light guide, a polarized light emitter, an illuminator. TE/TM mode converter, in optical measurement methods and devices, tunable lasers, optical filters, etc., which can have any form and shape, which can provide geometric/material birefringence (with the same or opposite sign), etc. and which can contain other layers, e.g. one or more alignment layers, core layers with defined refraction [e.g. of tantalum pentoxide material], other (controllable/noncontrollable) liquid crystal layers [e.g. of dielectric materials such as Silicon OxyNitride, Tantalum Pentoxide, Polymers, Pure Silicon, etc.], nonconductive [e.g. glass, crystal], conductive substrates [e.g. P-doped silicon substrate, metal substrate] or a nonconductive substrate with a conductive coating [e.g. ITO. Au, Ag, Al, Cu, etc.] wherein Si substrate can integrate circuitry and wherein the optical layers can have various indices thus providing various index contrasts.

The primary conductor layers (2041a, 2041b) can be coupled with an electrocomponent [e.g. a voltage source/e.g. an AC with a super-low frequency e.g. 240 Hz, 400 Hz or another/via extensions, tabs, conductors, traces, etc. (not shown), the signal can be modulated]. A secondary electromagnetic interface of a combined light-energy transfer system can be provided in a similar way and can be coupled with an electrocomponent [e.g. a rechargeable power source, a source management system, a sensing circuitry, a graphic processor, etc.].

FIG. 133 is a schematic perspective view of another embodiment of the wireless electromagnetic energy transfer system. A primary magnetic element (2050) [which can be of a transparent magnetic material] and primary conductors (2051a, 2051b) [which can be of transparent or non-transparent conducting layers, traces, stripes, shapes, etc. and which can have round shaped, (close) curve shaped, etc. enlarging elements and which can generate a lateral electric field which can be associated with a circular magnetic field, wherein the primary conductors can be provided (e.g. alternatively) as common and pixel electrodes in liquid crystal display panels] can form a primary electromagnetic interface (2052) [which can represent a subpixel and which can form an array including data lines, gate lines, thin film transistors, substrates, color filters, etc.] wherein an inner space can be filled with polymer dispersed liquid crystals (2057) [which can become oriented between the primary conductors (2051a, 2051b) when voltage applied, when no voltage applied the liquid crystal molecules (2057) can be positioned along a rubbing direction (not shown)]. The primary conductors (2051a, 2051b) can be coupled with an electrocomponent (2055) [e.g. a liquid crystal display driving unit]. An external electromagnetic field can be also contemplated and a secondary (repeating) electromagnetic interface system which can be coupled with secondary electrocomponents can be provided analogically.

FIG. 134 is a schematic perspective view of another embodiment of the wireless electromagnetic energy transfer system. A primary magnetic element (2060) [which can be of a transparent magnetic material] and primary conductors (2061a, 2061b, 2061aa, 2061bb) [which can be of transparent conducting layers forming conductive traces] can form a primary electromagnetic interface (2062) [which can be provided in a form of an optical layer, collimator layer, diffuser layer, active panel, active screen, holographic optical layer, etc.] and wherein an inner space can be filled with polymer dispersed liquid crystals (2067a. 2067b) [which can become oriented between the primary conductors (2061a and 2061b; 2061aa and 2061bb) when voltage applied]. The primary conductors (2061a, 2061b, 2061aa, 2061bb) can be coupled with electrocomponents (2065a, 2065b) [e.g. one or more liquid crystal panel driving units]. An external electromagnetic field can be also contemplated and a secondary (repeating) electromagnetic interface system which can be coupled with secondary electrocomponents can be provided analogically.

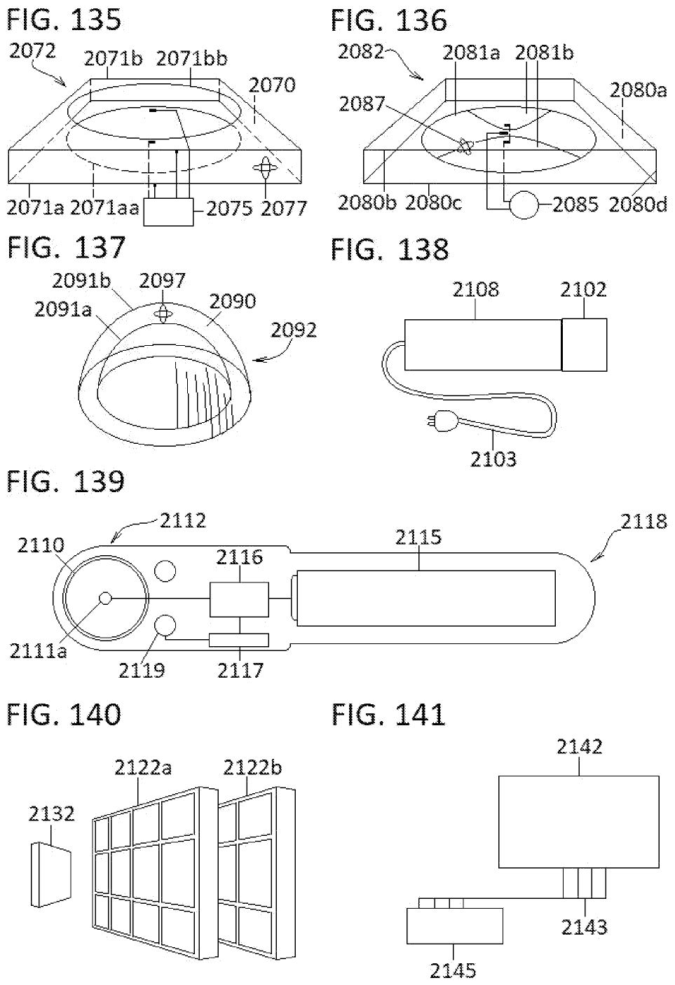

FIG. 135 is a schematic perspective view of another embodiment of the wireless electromagnetic energy transfer system. A primary magnetic element (2070) [which can be of a transparent magnetic material] and primary conductors (2071a, 2071b) [which can be of non-transparent conducting traces (e.g. from aluminium or chrome) which can have various patterns (not shown)] and (2071aa, 2071bb) [which can be of transparent conducting layers forming conductive traces] can form a primary electromagnetic interface (2072) wherein an inner space can be filled with polymer dispersed liquid crystals (2077). The primary conductors (2071a, 2071b. 2071aa, 2071bb) can be coupled with an electrocomponent (2075) [e.g. a liquid crystal panel driving unit which can provide different voltages between the primary conductors (2071a, 2071b, 2071aa, 2071bb) which can orient the liquid crystals (2077) which can form lenses, etc.]. An external electromagnetic field can be also contemplated and a secondary (repeating) electromagnetic interface system which can be coupled with secondary electrocomponents can be provided analogically.

FIG. 136 is a schematic perspective view of another embodiment of the wireless electromagnetic energy transfer system. Primary magnetic elements (2080a) [which can be of a transparent magnetic material filling an inner space], (2080b, 2080c, 2080d) [which can be of (transparent/translucid/opaque) frontal, back and lateral magnetic material layers] and primary conductors (2081a, 2081b) [which can be of transparent or non-transparent conducting layers or traces which can have various patterns] which can be coupled with an electrocomponent (2085) can form a primary electromagnetic interface (2082) [which can be provided in a form of an active light guide plate, etc.] wherein an inner space can be filled with polymer dispersed liquid crystals (2087). Light can be incident from one or more directions [e.g. from upper or lower side, lateral sides, etc.]. A secondary electromagnetic interface system can be provided analogically.

FIG. 137 is a schematic perspective view of another embodiment of the wireless electromagnetic energy transfer system. A primary magnetic element (2090) [which can be of a transparent magnetic material], primary conductor layers (2091a, 2091b) [which can be of 3D modelled transparent conducting layers which can include patterned conducting traces/e.g. in the partially indicated vertical direction on the page/] can form a primary electromagnetic interface (2092) [wherein an inner space can be filled with liquid crystalline molecules (2097) (only one is schematically shown)] which can be used in various non-display applications [e.g. as an optical filter]. The primary conductors (2091a, 2091b) can be coupled with an electrocomponent (not shown) and the system can include a light source [which can also be an ambient light source] providing light (not shown). A secondary electromagnetic interface of a combined light-energy transfer can be provided in a similar way [or as a panel as shown in FIGS. 131 to 136 or 140 and 141] and can be coupled with electrocomponents [e.g. a rechargeable power source, a source management system, a processor, a sensing circuit, a liquid crystal display, a liquid crystal panel, a driving unit, etc.].

FIG. 138 is a schematic side view of another embodiment of the wireless electromagnetic energy transfer system. A primary magnetic element and primary conductor layers can form a primary electromagnetic interface (2102) [which can include an insulation and shielding and which can be similar as shown in FIG. 137] which can be coupled with electrocomponents (not shown) [which can be provided within an enclosure (2108) a and which can include a light source, a driving unit, a graphic processor, an input section, a conductor (2103)/e.g. a power cable/, etc.]. A secondary electromagnetic interface can be configured to provide wireless electromagnetic energy transfer [e.g. in a form of an active panel as shown in FIGS. 131 to 136].

FIG. 139 is a schematic plan view of another embodiment of the wireless electromagnetic energy transfer system. A primary magnetic element (2110) [which can be cylindrically shaped and which can provide a path for a primary circular magnetic flux which can be associated with a primary electric field which can be perpendicular to the page] and primary conductors (2111a) (a bottom primary conductor not shown) [which can be of transparent (translucent) or opaque conductive paths posed on a transparent substrate] can form a primary electromagnetic interface (2112) [an inner space can be sealed and filled with polymer dispersed liquid crystals which can be oriented (not shown) in the primary electromagnetic field] which can be coupled with an energy source (2115) [which can provide a direct current (DC) voltage e.g. about 1.5V or more] which can be coupled with a driving unit (2116) [which can include a power regulator, an oscillator, a modulator, an amplifier, a rectifier, etc.] which can be controlled by a microcontroller (2117) which can be controllable by buttons (2119) [and/or any convenient wired or wireless communication interface]. The pair of the primary conductors (only 2111a shown) can generate internal and external electromagnetic fields and provide (internal/external) condenser action. The primary electromagnetic interface (2112) can be provided in a combined light-energy stylo (2118) [which can communicate and can be energized via the primary electromagnetic interface (2112) and/or the battery (2115) which can be omitted].

FIG. 140 is a schematic perspective view of another embodiment of the wireless electromagnetic energy transfer system. Primary magnetic elements and primary conductor layers can form primary electromagnetic interfaces (2122a) [which can be an energy transfer-optical device which can include a liquid crystal layer/e.g. directing light and enabling a 3D vision, etc./which can include an insulation, shielding, conductive and data traces which can be transparent or non-transparent] and (2122b) [which can be an energy transfer-optical device which can include a liquid crystal display/e.g. managing light, etc./which can include an insulation, a shielding, conductive and data traces/e.g. data bus lines/which can be transparent or non-transparent, and which can include polarizing layers, phase difference layers, substrate layers, thin film transistor layers, black matrix layers, light shielding layers, color filters layers, alignment layers, common electrodes, connection electrodes, gate electrodes, pixel electrodes, cell electrodes, storage capacitor electrodes, insulating films, etc.]. Either of the primary electromagnetic interfaces (2122a or 2122b) can be an optical device/e.g. a liquid crystal panel or the liquid crystal display/or the components can be provided in an energy transfer-optical device/e.g. an active liquid crystal display (LCD) device which can be provided within a smartphone, a television, an active screen, etc./. The device can include processors, graphic processors, input devices, output devices, communication interfaces, light sources, etc.

A secondary electromagnetic interface (2132) can be configured to provide wireless electromagnetic energy transfer [e.g. in a form of an active panel as shown in FIGS. 131 to 136 which can be provided within a smartphone, a scanner, an active screen, a light-pen, etc.]. The combined light-energy transfer system can provide data transmission and electro-optical communication [e.g. light-energy transfer can be modulated to include an information which can be transmitted from the primary electromagnetic interfaces (2122a, 2122b) to the secondary electromagnetic interface (2132) (or vice versa)/e.g. by means of a dedicated electrode which can be an active pixel electrode, etc/]. The signal containing information can be transferred by means of (dedicated) data lines to a primary or secondary (graphic) processor to process the information, the processor can be coupled with data storage elements, etc. The system can provide data storage (e.g. a holographic data storage, etc.). The light-energy modulation can include timing and signal intensity modulation. Light-energetical codes which can be similar to bar codes and quick response (QR) codes can be contemplated. Amount of energy and amount of light can be used and combined to send, transfer and receive an information. Light-energy codes can provide enhanced possibilities of information storage and transmission.

FIG. 141 is a schematic of another embodiment of the wireless electromagnetic energy transfer system. Primary magnetic element and primary conductor layers can form a primary electromagnetic interface (2142) [which can be an energy transfer-optical device/which can include a light source (not shown)/which can include a liquid crystal panel and/or a liquid crystal display and which can include an insulation, a shielding, conductive and data traces (2143) which can be coupled with an electrocomponent (2145) [e.g. a driving unit/which can drive a liquid crystal panel/, a processing unit including processors, graphic processors, input and output sections, communications interfaces, a memory, etc.].

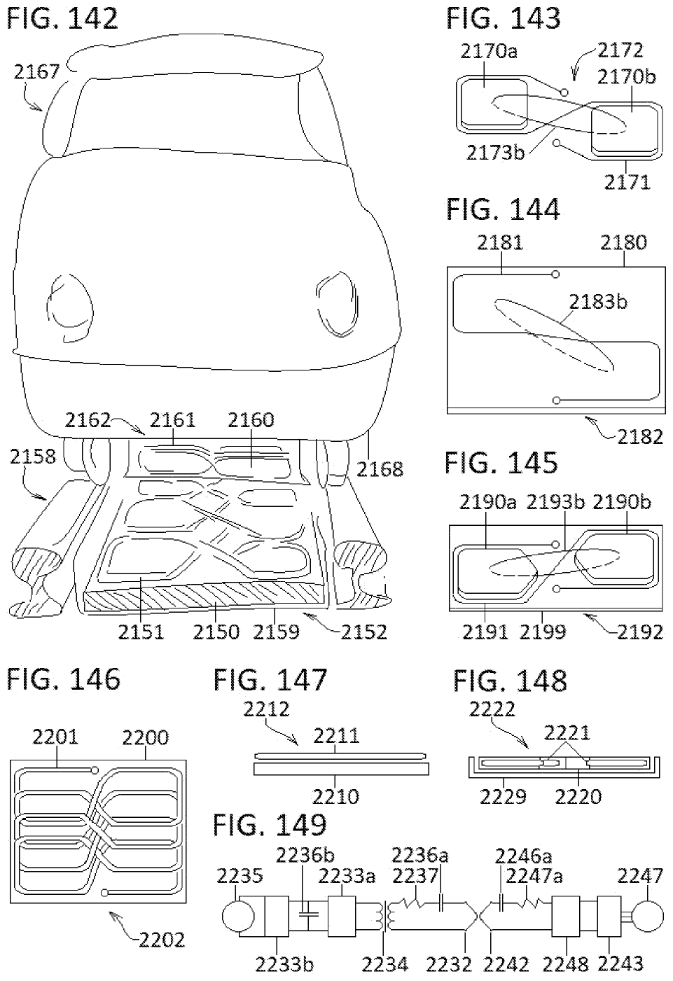

FIG. 142 is a schematic perspective view of another embodiment of the wireless electromagnetic energy transfer system provided in an onshore static/dynamic power transfer system. A primary magnetic element (2150) [which can be a high-frequency high-permeability ferrite slab and which can be composed of a plurality of subsections/e.g. in a form of bars, patches, etc./of different shapes (e.g. oval, round, squared, symmetrical, etc.)] and a primary conductor (2151) [which can be of one or more conductors/e.g. stranded mains cables, tressed wires, Litz wires, etc./of various shapes, patterns, elevations and cross sections/e.g. round, squared, etc./] can form a primary electromagnetic interface (2152) which can be coupled with an engineering construction (2158) [e.g. a railway, or road (not shown), etc.], which can be shielded with a shielding (2159) [which can be provided from a bottom part (as shown) and from an upper/e.g. central/part (not shown)] and which can be coupled with a defined power source (not shown) [which can be an onshore wireless power transfer system which can have a defined frequency/e.g. 10-100 kHz or another/]. The primary conductor (2151) can form working pairs [which can have functional openings/e.g. loops/and which can be transversally and/or longitudinally oriented] which can provide a shifted electromagnetic field which can be offset in a longitudinal and/or a transversal direction.

A secondary magnetic element (or elements) (2160) and a secondary conductor (or conductors) (2161) can form a secondary electromagnetic interface (or more interfaces) (2162) which can be provided analogically [e.g. with compatible parameters, size, pattern, etc. to be able to wirelessly transfer power], which can similarly form working pairs and which can be coupled with an electric vehicle component [e.g. a lower part of a body/chassis (2168)]. The secondary conductor (2161) can be coupled with an electrocomponent (not shown) [which can be a source management system, a rechargeable power source, a DC-DC converter, an inverter, an electric traction motor, a motor generator, etc.] coupled with an electric vehicle (2167) [e.g. an electric engine, etc.]. [The system components can be optimised to obtain an efficient and effective energy transfer. The system can alternatively use multi-phase/e.g. two or three/primary and secondary (pick-ups) layouts. Multiphase systems can provide travelling field in transversal and/or longitudinal direction. The phase conductors can be arranged such that there can be balanced mutual coupling and no energy transfer between phases/e.g. with current flowing in the same direction when the primary/secondary (repeating) conductors can be energised./]FIG. 143 is a schematic oblique plan view of another embodiment of the wireless electromagnetic energy transfer system provided in an onshore static/dynamic power transfer system. Primary magnetic elements (2170a, 2170b) [which can have different shapes] and a primary conductor (2171) [which can be of one or more conductors and have various cross sections] can form a primary electromagnetic interface (2172) which can be couplable with a power source (not shown) to provide electric current flowing through the primary conductor (2171) and creating one or more circular magnetic fluxes (2173b) [whose height can be controlled by a pole pitch and with a shielding which can be provided on a coupling side at a central part of a the interface (2172) between the primary magnetic elements (2170a, 2170b)] to generate electric current in a secondary conductor forming with a secondary magnetic element [which can be spaced apart from the primary magnetic elements (2170a, 2170b) to be able to transfer the circular magnetic fluxes (2173b)] a secondary electromagnetic interface which can be provided analogically and which can be coupled with an vehicle (not shown) [e.g. an electric vehicle]. The primary conductor (2171) can provide condenser action [e.g. in a form of a self capacitance/which can be calculated into a tuning circuitry (not shown)/and a mutual capacitance with the secondary conductor.].

FIG. 144 is a schematic oblique plan view of another embodiment of the wireless electromagnetic energy transfer system provided in an onshore static/dynamic power transfer system. A primary magnetic element (2180) [which can have different shapes and which can be divided into mutually insulated subsections (not shown) and which can have a defined thickness] and a primary conductor (2181) can form a primary electromagnetic interface (2182) which can be couplable with a power source (not shown) to provide electric current flowing through the primary conductor (2181) and creating one or more circular magnetic fluxes (2183b). A secondary electromagnetic interface can be provided analogically and can be couplable with a vehicle (not shown) [e.g. an electric vehicle]. [Preferably a pole pitch (oriented vertically and horizontally on the page) can be less than one wavelength.]

FIG. 145 is a schematic oblique plan view of another embodiment of the wireless electromagnetic energy transfer system provided in an onshore static/dynamic power transfer system. Primary magnetic elements (2190a, 2190b) [which can have different shapes, thickness, parameters, be of various magnetic materials, etc.] and a primary conductor (2191) can form a primary electromagnetic interface (2192) which can be shielded with a shielding (2199) which can be couplable with a power source (not shown) to provide electric current flowing through the primary conductor (2191) and creating one or more circular magnetic fluxes (2193b). A secondary electromagnetic interface can be provided analogically and can be couplable with a vehicle (not shown) [e.g. an electric vehicle].

FIG. 146 is a schematic plan view of another embodiment of the wireless electromagnetic energy transfer system provided in an onshore static/dynamic power transfer system. A primary magnetic element (2200) and a primary conductor (2201) [which can have various overlapping patterns with regard to intended functionality and electromagnetic field shifting] can form a primary electromagnetic interface (2202) which can be couplable with a defined power source (not shown) [which can be one or multiphase power sources with various primary conductors (overlapping) patterns] to provide electric current flowing through the primary conductor (2201) and creating one or more circular magnetic fluxes (not shown). A secondary electromagnetic interface can be provided analogically and can be couplable with a vehicle (not shown) [e.g. an electric vehicle].

FIG. 147 is a schematic elevation view of another embodiment of the wireless electromagnetic energy transfer system provided in an onshore static/dynamic power transfer system. A primary magnetic element (2210) [which can have different shapes, thicknesses, parameters, be of various magnetic materials, etc.] and a primary conductor (2211) [which can be situated above the primary magnetic element (2210)] can form a primary electromagnetic interface (2212).

FIG. 148 is a schematic elevation view of another embodiment of the wireless electromagnetic energy transfer system provided in an onshore static/dynamic power transfer system. A primary magnetic element (2220) [which can have different shapes, thicknesses, parameters, be of various magnetic materials, be divided into subsections, etc.] and a primary conductor (2221) [which can be situated at about a same level as the primary magnetic element (2220)] can form a primary electromagnetic interface (2222) [which can correspond to the embodiment shown in FIG. 145 wherein any intermediate position or more offset position can be contemplated] which can be shielded with a shielding (2229) [which can provide condenser action with the primary conductor (2221)].

FIG. 149 is a block diagram of the wireless electromagnetic energy transfer system provided in an onshore/offshore static/dynamic power transfer system with primary and secondary conductors coupled with electrocomponents. A primary electromagnetic interface (2232) can be coupled with a compensation circuitry [which can include an inductance, a capacitance (2236a)/which can be coupled in parallel/in various topologies/e.g. LCL, etc./and a resistance (2237)] which can be coupled with a transformer (2234) which can be coupled with an inverter (2233a) which can be coupled with a capacitor (2236b) which can be coupled with a converter (2233b) which can be coupled with a defined power source (2235). A secondary electromagnetic interface (2242) can be coupled with a compensation circuitry [which can include an inductance, a capacitance (2246a)/which can be coupled in parallel/in various topologies/e.g. LCL, etc./and a resistance (2247a)] which can be coupled with electrocomponents (2248) [e.g. a rectifier, a capacitance, a voltage regulator, a converter, a rechargeable power source], a power inverter (2243), an electric motor (2247) [which can function as a motor generator for regenerative braking, or a plurality of electric motors/generators can be provided, etc.] which can be coupled with a vehicle [e.g. an electric vehicle, an offshore vessel] (not shown).

Common Features of FIGS. 1 to 149

Energy can be transferred through electrical field coupling and/or magnetic field coupling. Electrical current flowing through a primary conductor can create magnetic fields in a primary magnetic element which can be denoted by circular magnetic fluxes according to the present invention. The primary magnetic fields in the primary magnetic element can create secondary magnetic fields in a secondary magnetic element. The secondary magnetic fields in the secondary magnetic element can generate electrical current in a secondary conductor. Primary/secondary magnetic elements can provide a return path for circular magnetic fluxes which can propagate (in air, in a liquid) outside the primary/secondary magnetic elements. A primary electric field in the primary conductor providing condenser action according to the present invention can create a secondary electric field in the secondary conductor. Electrical current flowing through a primary conductor coupled with a primary coupling inductor according to the present invention can create a primary electromagnetic field which can create a secondary electromagnetic field around a secondary coupling inductor which can generate a secondary current in a coupled secondary conductor. The created secondary magnetic fields can oppose the creating primary magnetic fields and the created secondary electric fields can oppose the creating primary magnetic fields to preserve energy. The fields can be resonant according to the present invention.

The invention proposes a repeating electromagnetic interface which in fact can be considered as a specific primary/secondary interface in a system which can perform receiving and transmitting function (eventually other functions of primary/secondary electromagnetic interface/e.g. with different parameters, etc.).

Similarly onshore/offshore inductive/capacitive/magnetodynamic (magnetomechanic) static/dynamic power transfer systems (eventually resonant) can use respective repeating (i.e. intermediary) interfaces which in fact can be considered as specific primary/secondary (eventually bidirectional) inductive/capacitive/magnetodynamic (magnetomechanic) (resonant) wireless power transfer interfaces systems.

The primary and the secondary magnetic elements can have a strong (proximity) coupling [e.g. with a coupling factor k>0.1] or a loose (vicinity) coupling [e.g. with a coupling factor k<0.1] when spaced apart from each other to be able to transfer circular magnetic fluxes created around the primary and the secondary conductors in a predominantly non-radiative direct field (resonant) coupling or energy transfer can use predominantly radiative coupling. The lay-out, pattern, dimensions, shapes, numbers. etc. of the primary/secondary conductors disposed in or at about the primary/secondary magnetic elements and the lay-out, pattern, dimensions, shapes, numbers, etc., of the primary/secondary magnetic elements together with lay-out, pattern, dimensions, etc., of the shielding can shape circular magnetic fluxes and magnetic field confined within the primary/secondary magnetic elements and surrounding primary/secondary electromagnetic interfaces and electric field confined within the primary/secondary conductors and surrounding the primary/secondary electromagnetic interfaces. The shielding can function as a reflector [especially at higher frequencies between 100 MHz and 300 GHz], e.g. in a parabolic, a 3D modelled form/e.g. conical, pyramidal, diagonal, cavity-backed, etc. wherein sidewalls may be straight, shaped, curved, etc./, custom shaped or it can be a planar reflector, etc. The system can provide dual orthogonal sense linear polarization configurations by adding a replica of a respective (dipole) antenna system and rotating that system 90° wherein components in both directions can have different dimensions.

Overall design and material choice of the primary/secondary electromagnetic interfaces [e.g. reducing sharp edges and corners, preferably chamfering, radiusing the edges/corners of the primary/secondary magnetic elements, evenly disposing primary/secondary conductors in selected patterns, choosing a convenient thermal management system, etc.] and of the whole system can provide uniform electromagnetic field distribution and reduce or eliminate magnetic field hot spots.

Energy transfer can be perturbed in the presence of an extraneous object which can influence coupling and result in energy losses. Optimalisations of the system can avoid or alleviate perturbations.

The system can use energy transfer repeaters, energy relays, etc. (e.g. as shown in FIGS. 35, 73, 74). Secondary/repeating electromagnetic interfaces can provide energy to devices/e.g. to a portable or home electronics, to a repeating device of a vehicle, etc./and can simultaneously pass a portion of received energy onto other device in the system]. The repeaters can receive an electromagnetic energy through a first electromagnetic field with a first plurality of parameters and can generate a second electromagnetic field with a second plurality of parameters. The repeaters can be multiplied to extend the distance range of the system. The repeated circular electromagnetic fields can have different frequencies from the first electromagnetic fields.

Various applications of the system can have various useful energy exchange and energy transfer efficiency demands [e.g. at least 80% in electric vehicles/offshore vessels (charging) power transfer applications, greater than 10% in consumer electronics, 1% in sensor layers, etc.]. The system can use a passive compensation method and adjustable elements [e.g. in active tuning, autotuning, controlling tuning circuits, etc.] to provide acceptable (economical, tolerable/within environment limits, size limits, cost restrictions/, etc.) energy transfer efficiency. The system can use detuning, frequency hopping, time multiplexing techniques to decouple [e.g. to reduce voltage, current, power transfer, to protect devices with lower power demand from overheating, to defend the system from unauthorised power transfer, to enable authentication of energy sources and coupled loads in the system, etc.].

The system can use inductors, capacitors, distributed inductance, distributed capacitance, distributed filter banks, or combinations [e.g. capacitively loaded (coupling) inductors, etc.]. The components can be fixed or variable, can vary impedance matching, a resonant frequency, etc. The components can be connected in series (resonant circuits) or in parallel (resonant circuits). The embodiments of the electromagnetic interfaces can provide (distributed) inductance. (distributed) capacitance and (distributed) inductance-capacitance in according to the present invention.

The elements of the invention on a primary side and on a secondary side can be differently sized, oriented [e.g. parallel, substantially parallel, offset, rotated, etc.], structured, coupled, etc.

Geometric parameters and distance among primary and secondary electromagnetic interfaces may considerably influence coupling factor. A radiation energy transfer can be reduced if the size of the system components [primary/secondary magnetic elements, primary/secondary conductors, primary/secondary coupling inductors, etc.] can be much less than the wavelength of system operation. Shaping, shielding, sizing, orienting the primary/secondary electromagnetic interfaces [which can be sub-wavelength objects] together with tuning, frequency range and other system parameters setting can help to design electromagnetic fields, to alleviate losses [e.g. primary/secondary conductor absorptive losses, radiation losses, absorption losses/e.g. in extraneous objects/, etc.] and to optimalize the system efficiency which can be learned by practicing the invention. The primary/secondary electromagnetic interfaces and their elements can be separated by a thickness of an insulation, a dielectric layer, etc. and can be spaced apart by any distance in which the system can be able to transfer at least partially the circular magnetic fluxes.

An electric field of a primary/secondary conductor which can be a good conductor can be completely perpendicular and a magnetic field can be tangential and composed of one or more circular magnetic fluxes. Electric field of the primary/secondary conductor providing condenser action can be provided between parallel portions of the primary/secondary conductor [e.g. within a dielectric layer] and can be perpendicular to the circular magnetic fluxes in the primary/secondary magnetic elements. An electron flow between the parallel portions (electrodes) and/or an electric current in the primary/secondary conductor can create circular magnetic fluxes in the primary/secondary magnetic element and vice versa.

A primary/secondary [and tertiary, etc. in case of a repeater] magnetic field created by respective primary/secondary circular magnetic fluxes [and tertiary fluxes, etc.] can advantageously provide homogenous and (highly) directive electric and magnetic fields or can provide omnidirectional patterns. Directivity can be a significant advantage in applications where the power is only required to be directed over a small area and can prevent it, for example causing interference to other users. Devices coupled with a secondary [and tertiary, etc.] magnetic field can have a certain orientation freedom in a 3D space in relation to a position of a primary electromagnetic interface. The orientation freedom can be biggest around an axis (substantially) parallel to the axis of rotation of the primary circular magnetic fluxes and in directions (substantially) perpendicular to the axis which corresponds to a biggest orientation freedom concerning electric fields.

Primary/secondary conductors can be (substantially) parallel oriented at about and/or in primary/secondary magnetic elements and/or can be orthogonally, convergently, divergently, focus, random oriented, etc., or combinations. A coupling side of a primary/secondary magnetic element and/or of the primary/secondary conductors [e.g. which can provide internal and/or external condenser action] can be conveniently [e.g. convexly, concavely, cylindrically, etc.] shaped. The primary/secondary electromagnetic field can be in this way correspondingly shaped, the primary/secondary circular magnetic fluxes in the primary/secondary magnetic fields can have a definable plurality of rotation axes. In this way can be formed the relative orientation freedom between energy sources [e.g. charging pads, etc.] and loads [e.g. autonomous electronic devices, etc.] coupled with primary and secondary electromagnetic interfaces, respective.

The primary/secondary conductors [or groups of primary/secondary conductors] can have constant phase, a constant phase 90, 180, etc. degrees out of phase, a variable phase, etc.

The system can be used in wired-wireless (an unipolar, two-interface, single-wire) energy transfer systems comprising a primary electromagnetic interface coupled with a secondary electromagnetic interface and providing a forward path from an energy source to a load and further comprising a conductive returning path [which can be a rail for a train, an earth ground for an electric vehicle, a fresh/sea water for an offshore vessel, etc.]. A bipolar structure (four-plate structure) can include primary and secondary electromagnetic interfaces working pairs (groups) which can be provided in a four-plate structure or in any other orientation and pattern. The four-plate structure can be provided in a stacked configuration. In unipolar, bipolar (or other) structures the primary electromagnetic interfaces can have different size, orientation, insulation, shielding, circuitry, etc. than the secondary electromagnetic interfaces. The primary and the secondary conductors can provide condenser action when spaced apart from each other to be able to transfer an electric field energy and/or can provide condenser action within primary and secondary magnetic elements (interfaces). The desired condenser action can influence primary/secondary conductors' shaping, dimensions, etc., used dielectric layers, etc. The condenser action provided between electrodes within a same interface can increase the self-capacitance and voltage stress (a reliable electrical insulation can be a good option or necessity).

The primary and the secondary electromagnetic interfaces can be relatively planar to be integrable into planar electronic devices such as mobile phone, laptop. PDA. MP3 player, headset, and the like. Applications of the system can imply heat [e.g. hysteresis loss, energy transfer induced heat, or ambient heat/e.g. when used in tires, etc./. The elements/e.g. binders, polymers, wires, etc./can be fabricated of appropriate heat resistant materials and/or provided with appropriate thermal insulation, etc. The primary and the secondary magnetic elements together with the primary and the secondary conductors and shielding can be designed to be flexible, scrollable, foldable [e.g. can be embedded, integrated, etc. into flexible enclosures/e.g. clothes, cushions, etc./]. The primary/secondary magnetic elements can be comprised of elastomers containing magnetic particles, and the like, and the primary/secondary conductors can be fabricated of tressed wires, and the like.

The primary/secondary conductors can be disposed at about and/or in the respective magnetic elements in different shapes, numbers, patterns, layouts. The primary/secondary conductors can be switchable, or can be in a switchable groups. Some of the primary/secondary conductors can be dedicated for a power transfer and others for a signal (data) transfer and provide communication.

The primary/secondary conductors can be coupled with conductors (or circuits), conductive paths, electrocomponents, etc. at a non-coupling side end or at a coupling side end or at both sides (e.g. as shown in FIG. 47). The primary/secondary conductors can be provided in various shapes [e.g. cylindrical as shown in FIGS. 33a-c], forms [e.g. rectangular as shown in FIG. 31, elongated as shown in FIG. 39, etc.], structures, etc. [e.g. monoblocs, spongeous, fibrous, sheet structures, layered structures].

The primary/secondary magnetic elements and/or the primary secondary conductors and/or the shielding can be shaped to match various installations [e.g. engineering constructions, furniture, street furniture, etc.], devices [e.g. autonomous electronics, sensors, home appliances, tools, magnetic cards, RFID tags, game controllers, wireless computer peripherals, micromechanical systems, applications [e.g. power transfer, communications/e.g. the Global System for Mobile Communications (GSM), the Universal Mobile Telecommunications System (UMTS), the Long Term Evolution (LTE), the Global Positioning System (GPS), the Global Navigation Satellite System (GLONASS), WiFi, Bluetooth, etc./]. They can curve to follow the contours of the device, they can fill a dedicated space within the device, etc. They can have various geometries, shapes, enhancements, ridges, indentations, notches, etc. The primary/secondary electromagnetic interfaces provided in a dynamic power transfer system can be shaped and spaced (e.g. as shown in FIGS. 39, 83, 119, etc.) to create circular magnetic fluxes corresponding to a predominant motion of electric vehicles/vessels [e.g. on a road, fairway, etc.]. The primary/secondary electromagnetic interfaces can be shaped to provide a multidirectional energy transfer in a multidirectional area.

Magnetic materials that have ferromagnetic or ferrimagnetic properties can magnify magnetic flux density and can add additional magnetic flux to the already existing flux. Ferrite materials typically show a hysteresis effect between the applied magnetic field and the resulting field. The flux magnification effect of a ferrite rod depends on both the relative permeability of the ferrite material used, and on the form factor, for example the diameter to length ratio. The gyromagnetic effects of certain materials such as ferrite can also be used to increase the circular magnetic flux. The system components can convert electric energy to magnetic energy and back to electric energy. The provided electromagnetic field characterised by the circular magnetic fluxes can be resonant and the system can have a preset coupling coefficient for various applications. Resonance can be achieved within the primary/secondary/repeating electromagnetic interfaces (antennas) and/or with coupled (compensation) electrocomponents.

The system can include an oscillator to convert DC energy into radio frequency energy [e.g. in the frequency range from around 20 kHz to around 300 GHz] and can function at defined frequencies [e.g. about 135 kHz, 200 kHz, 600 kHz, 1 MHz, 6.78 MHz. 10 MHz, 13.56 MHz, 21 MHz, 27.12 MHz, 40.68 MHz, 10 GHz, etc.]. The frequencies for power transfer can be unmodulated.

The electromagnetic energy transfer systems can be enclosed in magnetically permeable packaging, in low-lossy (non-lossy) materials (e.g. certain plastic, carbon fiber, composites, plastic composites, Teflon, Rexolite, ABS (Acrylonitrile butadiene styrene), PVC (Polyvinyl chloride), nylon, rubber, acrylic, polystyrene, ceramics, stone, etc.). The packaging can comprise air, gas, sand, insulation, etc. The plurality of primary and/or secondary magnetic elements and/or primary and/or secondary conductors can be integrated into one device and similarly on a primary side can be one device transferring power to a number of devices on a secondary side or vice versa.

The wireless electromagnetic energy transfer system can be used in device-to-grid applications and/or secondary devices can provide return of energy to primary devices in a bidirectional power flow [i.e. in a negative power flow wherein the secondary devices with secondary electromagnetic interfaces become power sources and the primary devices with primary electromagnetic interfaces become power sinks/e.g. loads/and similarly for repeating devices and repeating electromagnetic interfaces].

The system can provide wireless data transmission which can provide communication through some form of modulation of the signal [e.g. analog/amplitude, frequency, phase/, digital/amplitude, frequency phase shift keying/, etc.]. Communication can utilize various wireless short range or long range carriers and protocols. Wireless communication can use primary and secondary (eventually repeating) electromagnetic interfaces, a Near Field Communication (NFC), a Radio Frequency Identification (RFID), a Wireless Personal Area Network (WPAN) [e.g. Bluetooth, ZigBee), a Wireless Local Area Network (WLAN) [e.g. Wi-Fi], a Worldwide Interoperability for Microwave Access (WiMax), wireless telephone technologies [e.g. 4G, 5G, etc.], a satellite connection. Communication can further be optical, [e.g. laser, infrared, etc.], acoustic [e.g. underwater acoustic communication, etc.]. Communication can use a separate channel from the circular electromagnetic field or can be combined with the circular electromagnetic field.

The system can be provided in cloud/fog/edge architectures wherein communication/control systems can be at least partially in relation with energy transfer. The architectures can be provided e.g. within the Internet, the Internet of Things and the Industrial Internet of Things.

The cloud computing system can include a cloud (a core of the network) which can provide big data processing, business logic, data storage, etc., and which can provide cloud services and communicate with fog nodes, edge nodes, systems operators. The cloud can be applied for mobile networks which can include data centers, configurable networks, radio access networks and mobile clouds which can include remote, local and hybrid clouds (which can include cloudlets). The cloud can communicate with fog/edge nodes wiredly (e.g. using wired network connections) [e.g. digital lines, fiber optics, etc.] and/or wirelessly (e.g. through satellite communication, telephone techniques, etc.).

The fog computing system can include fog nodes which can include (powerful) server devices, gateways, processing, storage and communication devices which can be provided at various electrocomponents [e.g. the hydrogen power units providing fuel cells, etc.] at power sources [e.g. onshore/offshore charging stations, etc.]. The fog node can process/store data sent from edge nodes (which can be connected wiredly through local networks and/or wirelessly through radio access networks, etc.), can process diary data, ambient conditions, etc. and can capture other sensors data. The fog node can manage edge devices (e.g. manage charging/discharging power provided to the charging stations/which can comprise a fog of chargers/, the rechargeable power sources, etc.). The fog node can function as an aggregator controller which can allocate power resources, manage power flows and which can be responsible for safety.

The edge computing system can include edge nodes (which can be end-devices) which can include sensors (sensor layer), controllers, local bus, edge computing platforms, data storage, interfaces, etc. The edge nodes can be provided at the electric vehicles, the offshore vessels, the rechargeable power sources, the chargers, the power sources, etc. Edge computing platforms can communicate with the cloud/fog nodes via a core network. Edge computing platforms can perform function of local aggregators managing energy transfer processes.

Cloud/fog/edge nodes can have local and global access. The system can enable processing, control and power management on a local (edge, fog) level and information generation, servicing and control on a global level (cloud). The system can enable power aggregation and interaction between power resources (e.g. electric energy generators, onshore/offshore power sources, etc.), the rechargeable power sources, the charging stations, etc. Cloud services can monitor data from fog nodes/edge nodes, human-machine interfaces (e.g. client smartphones), internet enabled devices, etc. The cloud services can make general decisions, store and process data and provide statistical analysis. The cloud/fog node/edge node system can set a real-time price for the energy transfer based on received information from fog nodes/edge nodes (e.g. provided from different electric vehicles, offshore vessels), on power supply and demand from the loads [e.g. electric vehicles/offshore vessels], on power supply and demand from power generators, etc. according to power market evaluation, energy price trend and development.

The system can make offers for a future price according to evaluation tests and model algorithms analysing data, implementing specific patterns to develop optimal energy transfer parameters.

The system can provide renewable energy management, power to grid management, booking management, pricing management, etc. The system can provide a multilevel architecture (e.g. two-level wherein edge nodes can communicate directly with clouds; a three-level architecture including edge nodes, fog nodes and clouds, or combinations). Each layer and the whole system can have various functionality patterns and architectures, can combine mobile and stationary nodes.

Thermal management systems managing wireless energy transfer can be air tempering systems, liquid tempering systems, liquid tempering systems using offshore water as a thermal medium, tempering systems using phase change materials, tempering systems using heat pipes, or combinations. The systems can thermally manage the primary/secondary magnetic elements, the primary/secondary conductors and/or any other element of the system which can be an electrocomponent (e.g. a rechargeable power source, a charger, etc.). The thermal management systems can include complex technologies. The systems can include ventilators, thermal exchangers, radiators, compressors, chillers, condensers, heaters, sensors, pumps, programmable controllers, thermal medium chambers and conducts, valves, heat pipes, vapor chambers, heat sinks, fillers, etc. The systems can use thermal exchange with offshore water.

The systems can be integrated into devices which can comprise communication interfaces to show various parameters concerning functioning of the system. The systems can be coupled to other circuitry providing additional functions such as sensors, amplifiers, resonators, rectifiers, inverters, converters, controllers, processors, and can be coupled with inductors, capacitors, resistors, diodes, varactors, transistors, switches, etc. These electrocomponents can represent circuits or networks and can adjust frequency, input, output, can provide energy conversion, bidirectional energy flow, can control the energy and/or data transfer, can provide a feedback mechanism, optimize system performance to obtain desired energy/data transfer. These electrocomponents can be external and can lie outside the system components, units, etc.

Arrays of solar cells can be solar panels, solar modules, solar towers, solar concentrators (e.g. inclusive of fresnel lens), etc.

Hydrogen power units providing fuel cells can include hydrogen production units and hydrogen storage units. Hydrogen production units can be electrolysis systems, hydrocarbons reforming systems, alcohols reforming systems, sugars reforming systems, chemical processing systems, biological processing systems, biomass processing systems, thermal processing systems, photo processing systems, metal and water systems. Hydrogen storage units can be compressed gas systems, liquified gas systems, chemical systems, electrochemical systems, physi-sorption systems, nanomaterial systems, intercalation in metals systems, intercalation in hydrides systems, inorganic gaseous systems, inorganic liquids systems, inorganic solids systems, organic gaseous systems, organic liquids systems, organic solids systems.

Wind energy to electric energy converters can be wind turbines (e.g. horizontal axis, vertical axis). Wave energy to electric energy converters can be energy harvesting devices provided in contact with waves (e.g. inclusive of linear generators, hydro turbines, air turbines, oscillating generators, oscillation columns, pressure differential converters, floating in-air converters, etc). Tidal energy to electric energy converters can be devices provided in contact with tidal changes (e.g. inclusive of hydro turbines, energy harvesting devices, etc.). Water currents energy to electric energy converters can be devices provided in contact with ambient water currents (e.g. inclusive of hydro turbines). Thermal energy to electric energy converters can be devices in contact with ambient water temperature difference, with geothermal heat sources (e.g. inclusive of hydrothermal vents energy harvesters, turbines).

Motor generators can be any type of a generator which can be an engine coupled directly or indirectly with a power generator. The engine can run on any type of fuel, preferably not exclusively on hydrogen gas, hydrogen liquid, compressed natural gases, liquefied natural gases, biofuels, low sulphur fuel oils, emulsified fuels, methanol, mixtures, hydrocarbon fuels, etc.

The primary/secondary conductors can be coupled with various electrocomponents to optimalize functionality of the system. Various compensation circuitry can be used in the wireless power transfer embodiments [e.g. non-resonant which can use a pulse width modulation converter/e.g. buck, boost, cuk, sepic, zeta/; resonant which can use power amplifiers/e.g. class D, E, EF, φ/, full-bridge inverters/e.g. connected with L, LC, LCL, LCLC, CLLC, etc. topologies/, the primary and secondary sides can be tuned to approximately the same or the same resonant frequency/even if the frequencies cannot be matched, energy may be transferred, e.g. at lower efficiency; requirements on tuning of transmitting tank circuits can be higher than requirements on tuning of receiving circuits/, multiple resonances can be in compensation circuits, various tuning methods can be used; serial-serial, serial-parallel, parallel-serial, parallel-parallel compensations, or combinations can be used; fixed and variable components/e.g. capacitors, inductors, etc./can be combined in various topologies (serial, parallel) to achieve fine tuning, etc.] depending on power and efficiency requirements, system volume, required inductance and/or capacitance size, energy transfer distance, electromagnetic interfaces size, passive components size, switching frequency, etc. Additionally to what is shown in FIGS. 40 to 53 different combinations of interface components, interface configurations, electrocomponents, topologies, compensations, etc. can be used.

The embodiments of the invention can be provided in one (primary/secondary) or more (primary and secondary, tertiary, repeating, etc.) circuits. For example as shown in FIGS. 11a to 14c the sensors can be provided in one sensing circuit [with primary/secondary elements] or in primary and secondary (repeating) sensing circuits [with primary and secondary (repeating) elements].

As shown in FIG. 12 the system can perform a function of sensors which can sense position, velocity, directional movement (e.g. head-on, sideways, push-pull, push-push sensing movements), etc. The sensors can sense magnets, magnetic materials, magnetic fields (e.g. generated by passing currents), can be used as detectors. Sensors can be insulated (e.g. sealed against dust, water, etc.).

As shown especially in FIGS. 18 to 24 and 74 the primary/secondary/repeating electromagnetic interfaces provided in an offshore static/dynamic power transfer system and providing an electromagnetic power transfer in a direct contact with fresh water or seawater can be watertight/waterproof insulated because of water's high permittivity and electrical conductivity wherein attenuation of electromagnetic signals can be much lower in fresh water than in seawater. Since there can be a little effect on the magnetic field component, loss can be mainly due to the electric field attenuation. There can be a different effect of a permanent (under) water contact and a temporary (splash) water contact on the electromagnetic energy transfer effectiveness. Various types of insulation can be applied to the shown systems [e.g. mechanical/seals/, chemical/water repellants/, active/drying air streams, heat drying systems, wiping systems/, design parameters/delimited, circumscribed, narrow working spaces for electromagnetic power transfer isolated from the surrounding liquid, primary electromagnetic interfaces positioned on the top of floaters and protected against a direct splash, etc./].

As shown e.g. in FIGS. 47 to 50 the system can use various resonant circuit combinations in input and output circuits [e.g. parallel-in/parallel-out, series-in/series-out, parallel-in/series-out, series-in/parallel-out, wherein the (electro) components may be fixed or variable, coupled with other resonant topologies, other electrocomponents/e.g. tuning varactors, tuning transformers, etc./, distributed capacitance or inductance can be taken into account, etc.] for various applications for power transfer, energy transfer providing communication, applications providing various voltage step-up/step-down ratios [e.g. in relation with coupling coefficients, coupling distances, primary/secondary inductances/capacitances ratios, etc.].

As shown e.g. in FIGS. 86 to 91, 93, 97 to 98c, 100, etc., the invention can provide low profile antennas wherein respective distances between primary/secondary/repeating conductors and magnetic elements (and/or a shielding) can be e.g. 0, 0.125%, 0.25%, <0.5%, etc Such low profile antennas (arrays) can be used in radiative systems [e.g. RF tag systems, mobile communication systems, satellite systems, etc.] and in nonradiative systems [e.g. proximity, vicinity energy transfer systems/e.g. charging pads, etc./].

As shown in FIGS. 111 to 112c flexible and divisible primary/secondary (repeating) electromagnetic interfaces can be divided into parts in according to various applications (e.g. sensors, power tapes, antennas, “magnetic cables”, etc.).

As shown e.g. in FIGS. 15, 16a, 16b, 20 to 24, 38, 39, 57, 59 to 62, 65, 66, 69a to 69c, 71 to 83, 118 to 124, 142 to 149 the system providing circular electromagnetic field can be used in static/dynamic onshore/offshore power transfer systems wherein it can provide a high degree of freedom for vehicles [e.g. electric vehicles and in certain extend offshore vessels].

As shown in FIG. 125a [wherein any other presented antenna type/e.g. the electromagnetic horn antenna, parabolic antenna, etc./can be used] the combined light-energy system can be used in signalisation systems [e.g. marine/aviation/terrestrial signalisation] and in autonomous driving systems. The vessels, aircrafts, vehicles, drones, etc. can be equipped with secondary electromagnetic light-energy systems and the fairways, runways, smart roads, etc. can be equipped with primary electromagnetic light-energy systems. The combined light-energy system can provide visual control over the electromagnetic energy transfer (which can provide communication) and electromagnetic control over the visual signalisation/e.g. in reduced visibility conditions/. The primary/secondary electromagnetic light-energy systems can be provided by vessels, aircrafts, vehicles in autonomous (self) driving systems.

As shown in FIGS. 125b and 126 the embodiments at an interface of two elements can provide possibilities of energy transfer which can be used in sensing applications [which can include alarms], data transmission systems [e.g. harvest data from submerged applications to surface systems/e.g. vessels/, communications, maritime beacons, real-time control of unmanned underwater vessels, underwater/maritime navigation, sensing, shallow water applications/e.g. in harbours, rivers, estuarine waters/, wireless underground sensor networks/which can consider carrier frequency of a system, burial depth of sensors, horizontal inter sensors distances, underground volumetric water content/, etc.], power transmission systems [e.g. electric vehicles charging through a window], etc.

As shown in FIGS. 127 to 141 the wireless electromagnetic energy transfer system embodiments providing light-energy transfer can provide an internal electric field associated with internal circular magnetic fluxes and can provide an external electric field associated with external circular magnetic fluxes or can provide the internal and external electric fields associated with the internal and external circular magnetic fluxes. In the first case the components of the embodiments can be described as primary/secondary [e.g. conductors, magnetic elements]. In the second and third cases the components of the embodiments can be primary conductors/magnetic elements and secondary (repeating) conductors/magnetic elements. [In other words the first case can be represented by a liquid crystal panel, screen, device, etc. which can comprise primary/secondary magnetic elements providing a path for internal circular magnetic fluxes associated with an internal electric field produced by primary/secondary conductors. The second and third cases can be represented by a primary liquid crystal panel, screen, device and a secondary (repeating) liquid crystal panel, screen, device spaced apart from each other to be able to transfer at least partially the external circular magnetic fluxes [e.g. in a form of a combined light-energy stylo and combined light-energy panel, two combined light-energy panels/e.g. a smartphone and a personal computer/, etc.].

The present invention can be applicable to LCDs or non-display applications which can include liquid crystals sandwiched between a pair of substrates on which electrodes can be respectively formed to orient the liquid crystals in a plurality of azimuths, shapes, directions, etc. by applying voltage between the electrodes. The liquid crystals can form (micro-) lenses which can be spherical, elliptical, asphere, etc. For transmitting-type LCDs (or non-display applications) the transparent ITO layers can be continuous ITO electrodes or a patterned electrodes (a photolithographic, an etching process can be used, etc.), e.g. including concentric conductive traces of various patterns, apertures (e.g. X-shaped, zigzag shaped), etc. The first and second electrodes can be of non-transparent conductive traces, layers [e.g. from aluminium, chrome, etc.]. The display/non-display applications in according to the invention can use electrodes to orient liquid crystals and electrodes to provide energy transfer, e.g. to provide external condenser action between primary and secondary electromagnetic interfaces.

The embodiments can include light managing portions [which can include liquid crystals between the primary or secondary electrodes] and energy managing portions [which can include primary or secondary electrodes configured to transfer energy accordingly to the present invention]. The both portions can be integrated into one system. The first and second electrodes can form electrode groups in various patterns wherein independent voltages can be applied to form liquid crystal lenses in various shapes and patterns [various additional structures and lines/e.g. black matrix, cover patterns, data lines, storage lines, gate lines, gate circles, etc./can be provided (not shown)]. The transparent electrodes can be further fabricated from aluminum zinc oxide (AZO), gallium zinc oxide (GZO), indium zinc oxide (IZO), etc., or for reflection-type LCDs (or other non-display applications) can be opaque [e.g. of aluminium]. The electrodes can be insulated with inorganic materials such as silicon nitride (SiNx), silicon oxide (SiOx), titanium oxide (TiO₂), alumina (Al₂O₃, zirconia (ZrO₂), etc. or organic materials such as poly siloxane, phenyl siloxane, polyimide, silsesquioxane, silane, etc. An optimization of the electrode shape and applied voltage can bring the possibility to optimalize lenses which can be aberration-free; a positive-negative phase shift can be controlled. The concentric primary/secondary conductors (electrodes) can homogenously distribute the voltage across the active area. Space between the primary/secondary electrodes can be a critical parameter in order to avoid steep variations of the applied voltage. The space can depend on required optical power.

The primary/secondary magnetic element can surround an LC cell [e.g. in a form of a transparent or non-transparent magnetic material; the transparent material can bring-in incident optical radiation (light)] and/or the primary/secondary magnetic element can be provided inside the LC cell [e.g. in a liquid crystalline polymers which can be expected to have anisotropic magnetic susceptibilities and tendency to become aligned when placed in electromagnetic fields, the liquid crystalline polymers can further contain other (transparent or non-transparent) magnetic materials (e.g. transparent ferrites or transparent magnetic nanorods) which can support orientation changes in liquid crystals under electric field composition of the electromagnetic field according to the present invention]. The surrounding and/or contained magnetic material can contribute to a linear voltage distribution from one electrode to the other and can shorten a response time of the LC cell or an LC (display/non-display) application according to the invention. In the proposed system the LC lenses can have both positive and negative focal lengths, high optical power and large apertures, can form telecentric lenses.

Various pretilt angles can be used. The primary/secondary electrodes can be provided with alignment layers (e.g. a polyimide (PI) layer) which can be rubbed or otherwise prepared (e.g. having a concavo-convex pattern, etc.). Orientation direction of liquid crystalline molecules can be tilted towards the direction in which they can be irradiated by an e.g. ultraviolet light from an included light source.

The primary and secondary electrodes can be supported by substrates (e.g. rigid glass, flexible cholesteric, etc.).

The liquid crystals utilized in the microlens arrays can be any nematic liquid crystal with either a positive dielectric constant or a negative dielectric constant or a mixture of each, polymer dispersed liquid crystal material, Smectic A, C liquid crystal material, discotic liquid crystal material, cholesteric liquid crystal material such as ferroelectrics and surface stabilized ferroelectrics, or dual-frequency liquid crystal material, high viscosity materials, liquid crystals containing magnetic particles (e.g. the nanorods which can be iron oxide nanorods or other transparent magnetic nanorods), etc. Embodiments of the invention using transparent elements (e.g. primary/secondary magnetic elements, primary/secondary conductors) and liquid crystals can be used in display applications (e.g. liquid crystal displays (LCDs) which can be used in consumer, medical, control, research, etc. devices including touch screens, pads, buttons) and in non-display applications, wireless visually supported energy transfer applications, etc. Liquid crystals with positive or negative dielectric constant anisotropy due to their optical birefringent and electrical properties as used in the present invention can visualise an energy transfer between the primary or secondary interfaces. The liquid crystal displays or optical devices using liquid crystals [e.g. lenses arrays, etc.] in the present invention can preferably not exclusively function in an twisted nematic (TN) mode, an in-plane switching (IPS) mode, and in an vertical alignment (VA) mode.

The primary/secondary electromagnetic interfaces can have boundary walls transparent to bring in light [e.g. by means of a prism coupler, lenses, fiber optic cable, etc.] A light source may be a point light source such as a light emitting diode (LED) or a laser diode (LD), or a line light source such as a cold cathode fluorescent lamp (CCFL), a bulb, etc.

As shown in FIGS. 142 to 149 the wireless electromagnetic energy transfer system in a static/dynamic power transfer system can be provided onshore and/or offshore and can comprise repeating elements (e.g. as shown in FIGS. 73 and 74) which can be compatible with respective primary and secondary elements. The primary/secondary/repeating conductors can provide shifted electromagnetic fields which can be shifted (offset) in plan view in a longitudinal and/or transversal direction and in a vertical direction as well. The primary/secondary/repeating elements [i.e. conductors, magnetic elements, electromagnetic interfaces, electrocomponents/e.g. power sources, rechargeable power sources, etc./] can be provided in pluralities [e.g. an electric engine can include more secondary electromagnetic interfaces, electric motors, etc., a track providing the static/dynamic power transfer can include more power transfer units (in a file and in a row) which can be individually switchable, etc./].

No limitations are intended others than as described in the claims. The present invention is not limited to the described exemplary embodiments. It should be noted that various modifications of the ETS can be made without departing from the scope of the invention as defined by the claims.

Elements, integers or components having known equivalents thereof are herein incorporated as if individually set forth.

The circuitry components, devices, production and communication techniques, materials, chemical substances and compounds, etc., described in this specification reflect the state of knowledge at the time of the filling of this application and may be developed in the future.

### INDUSTRIAL APPLICABILITY

The present invention can be used for a large number of applications to transfer energy wirelessly. It can be used in improved electromagnets. It can be used in radiative and nonradiative applications. It can provide low profile antennas. It can be used in microwave applications and satellite communication (e.g. improved waveguides, (feed) horn antennas, parabolic antennas, etc.). It can be used in electric and/or electronic devices, onshore and/or offshore transport, medical applications, etc. It can be used in static and dynamic charging of rechargeable power sources and in bidirectional applications. It can be used in electronic communications. It can be used in cloud/fog/edge computing systems. It can be used without a perfect alignment of the primary and secondary electromagnetic interfaces to obtain a high quality energy, power and/or communication transfer.

The embodiments of the invention providing electromagnetic energy storage elements can be used in a number of applications ranging from electric vehicles, consumer electronics, to power storage devices (e.g. hybrid devices including rechargeable batteries, capacitors and/or the proposed electromagnetic storage elements).

The embodiments of the invention providing combined electromagnetic thermal therapy can be used in burns, inflammation treatment, bone, muscle, joint and blood disorders, including but not limited to polio, arthritis and diabetes.

The embodiments of the invention including alarm can provide possibilities in various security systems using the proposed electromagnetic energy transfer system which can include transparent and multi-layer type discreet embodiments.

The embodiments of the invention coupled with a defined interface (e.g. water-air, underground-air, etc.) can provide possibilities of energy (e.g. power and data) transfer at the interface of two elements (e.g. subsea sensing circuits and air communication, underground sensor networks, electric vehicles wireless electromagnetic charging through an insulation layer, etc.).

The embodiments of the present invention combining energy transfer with light management systems using liquid crystals can be used in energy transfer application where a user can have a visual control of energy transfer process. The combined light-energy transfer system can be used in light-energy stylos cooperating with LCD displays, light-energetical codes applications, in non-display applications, in light-energy communication systems, etc.

The ETS can be provided in a modular system. The modularity and scalability can concern all elements and components of the ETS and can bring functional and financial benefits to the parties. Modular designs can use various degrees of modularity [e.g. component slottability, platform systems, holistic approach, etc.]. Modules can be catalogued.

1. A wireless electromagnetic energy transfer system, comprising: one or more primary magnetic elements and one or more secondary magnetic elements spaced apart from each other to be able to transfer one or more circular magnetic fluxes; one or more primary conductors and one or more secondary conductors, wherein at least one of said primary or secondary conductors are disposed at least partially in parallel or at least partially perpendicularly with a coupling side of said primary or secondary magnetic elements, respective, and wherein electric current flowing through one of said primary or secondary conductors creates said one or more circular magnetic fluxes to generate electric current in the other of said primary or secondary conductors, said wireless electromagnetic energy transfer system characterised in that neither of said one or more primary conductors or of said one or more secondary conductors does not substantially form one or more loops.

2. The wireless electromagnetic energy transfer system according to claim 1, wherein said wireless electromagnetic energy transfer system further comprises: one or more repeating magnetic elements; one or more repeating conductors disposed at least partially at about and/or in said one or more repeating magnetic elements and forming a repeating electromagnetic interface, and wherein electric current flowing through one of said primary or secondary conductors creates said one or more circular magnetic fluxes to generate electric current in said repeating conductors.

3. The wireless electromagnetic energy transfer system according to claim 1, wherein said wireless electromagnetic energy transfer system provides bidirectional energy flow.

4. The wireless electromagnetic energy transfer system according to claim 1, wherein said wireless electromagnetic energy transfer system provides wireless data transmission.

5. The wireless electromagnetic energy transfer system according to claim 1, wherein at least one of said primary magnetic elements and/or said secondary magnetic elements are at least partially or at least substantially comprised of a magnetic material, wherein at least one said magnetic material is selected from the group consisting of ferrites, magnetic metals, magnetically permeable materials, magnetic elastomers, elastic magnetic materials, translucent magnetic materials, transparent magnetic materials, magnetic binders, magnetic polymers, magnetic rubbers, magnetic gels, magnetic metamaterials, magnetic crystalline materials, magnetic liquid crystalline materials, magnetic phase change materials, photomagnetic materials, magnetic powders, magnetic particles, magnetic nanoparticles, magnetic shapes, magnetic coatings, magnetic layers, magnetic printed circuit boards, or combinations thereof, and/or wherein at least one of said primary conductors and/or said secondary conductors are at least partially or at least substantially comprised of a conductive path, wherein at least one said conductive path is selected from the group consisting of elastic conductive paths, wires, tressed wires, stranded wires, fibers, sheets, plates, bands, tubes, air cores conductors, hollow profiles, shapes, shaped profiles, rods, strips, microstrips, striplines, lines, ribbons, gels, inks, paints, traces, printed circuit board traces, nanostructures, metamaterials, crystalline materials powders, particles, coatings layers, translucent layers, transparent layers, photoconductive materials, semiconductors, semiconductor layers, or combinations thereof.

6. The wireless electromagnetic energy transfer system according to claim 1, wherein said wireless electromagnetic energy transfer system further comprises: a shielding to shield at least partially at least one element of said wireless electromagnetic energy transfer system.

7. The wireless electromagnetic energy transfer system according to claim 1, wherein said wireless electromagnetic energy transfer system further comprises: a parasitic element coupled with said primary conductor and/or said secondary conductor.

8. The wireless electromagnetic energy transfer system according to claim 1, wherein said wireless electromagnetic energy transfer system further comprises: an insulation to insulate at least partially at least one element of said wireless electromagnetic energy transfer system.

9. The wireless electromagnetic energy transfer system according to claim 1, wherein said wireless electromagnetic energy transfer system further comprises: a thermal management system to thermally manage said energy transfer.

10. The wireless electromagnetic energy transfer system according to claim 1, wherein at least one element of said wireless electromagnetic energy transfer system is at least partially flexible.

11. The wireless electromagnetic energy transfer system according to claim 1, wherein at least one element of said wireless electromagnetic energy transfer system is configured to be a module.

12. The wireless electromagnetic energy transfer system according to claim 1, further providing condenser action.

13. The wireless electromagnetic energy transfer system according to claim 1, wherein at least one element of said wireless electromagnetic energy transfer system is provided with a dielectric layer.

14. The wireless electromagnetic energy transfer system according to claim 1, wherein said wireless electromagnetic energy transfer system provide a shifted electromagnetic field.

15. The wireless electromagnetic energy transfer system according to claim 1 forming one or more arrays.

16. The wireless electromagnetic energy transfer system according to claim 1 providing a travelling electromagnetic field.

17. The wireless electromagnetic energy transfer system according to claim 1, wherein said wireless electromagnetic energy transfer system is coupled with an interface.

18. The wireless electromagnetic energy transfer system according to claim 1 forming working pairs.

19. The wireless electromagnetic energy transfer system according to claim 1 enabling relative mutual movement.

20. The wireless electromagnetic energy transfer system according to claim 1, wherein said wireless electromagnetic energy transfer system is coupled with a vehicle or with an offshore vessel.
